(19) United States
(12) Patent Application Publication
(10) Pub. No.: US 2009/0204468 A1
(43) Pub. Date: Aug. 13, 2009

(54) METHOD AND SYSTEM FOR PROCESSING WEB-BASED INVITATIONAL MESSAGES

(76) Inventor: Stephen B. WALLER, Milwaukee, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 12/268,547

(22) Filed: Nov. 11, 2008

Related U.S. Application Data
(60) Provisional application No. 60/987,253, filed on Nov. 12, 2007.

(51) Int. Cl. G06Q 10/00; G06F 3/00

(52) U.S. Cl. 705/9; 715/760

(57) ABSTRACT

A computerized, web-based system and method allows users, or “members,” to create a system invitation, send a system invitation, update a system invitation, delete a system invitation, and to “pre-set” a system invitation for expiration. Further, the system and method allows members to receive a system invitation, and accept or respond to a system invitation. The system and method also automatically processes system invitations, sorts received system invitations, and deletes system invitations in accordance with the pre-set expiration parameters selected by the member who sends a system invitation.

This application claims the benefit and priority of U.S. Provisional Patent Application No. 60/987,253 filed Nov. 12, 2007.

### FIELD OF THE INVENTION

This invention relates generally to web-based (i.e. utilized by means of the virtual community that exists within the “worldwide web,” or “www”) methods and systems for acquiring, storing, processing, retrieving and displaying information and data. More specifically, it relates to a web-based method and system that allows individuals to extend (by the “inviter”) and to receive (by the “invitee”) invitations for social events by means of web-based invitational messages. It also relates to such a method and system whereby the inviter can retrieve or delete the message under certain circumstances and can direct the message to only certain individual users of the system, or to certain groups of users. It also relates to such a method and system whereby the messages are presented in a “user-friendly” format.

### BACKGROUND OF THE INVENTION

In this age of electronic mail, personal digital assistants (PDAs), and cellular telephones, it is easier than ever to contact one's friends and colleagues to schedule social events. Despite these technologies, however, there are still a number of social barriers that prevent people from coordinating with one another as efficiently as they might wish. Consider the following situations:

Scenario 1: You work in an office building in a large city. It is 11:00 in the morning, and you have just learned that you will probably be free for lunch—but you won't know for certain until noon. You have a number of friends who work in buildings nearby, and you would enjoy the company of any of them if they are also free. However, you might decide not to contact them because (1) your own ultimate availability is uncertain; (2) you don't want to send out an e-mail message that might prove to be inaccurate; and (3) you don't want to call out of the blue and put your friends on the spot—and, indeed, you probably don't have time to call around to see who's free. As a result, you end up not meeting any of your friends for lunch.

Scenario 2: It is now 10:00 pm, and you feel the urge to visit the late-night coffee shop for some coffee and conversation. If any of your friends were free and also interested in this trip, you would enjoy their company. However, (1) you feel that it's too late in the evening to telephone your friends; and (2) you don't feel like sending a mass e-mail message that would most likely end up being read only the next morning after the opportunity has passed. Even if it's technically possible to send a text-message to your friends' cell phones, you still might feel reluctant to broadcast your availability in this manner.

Scenario 3: Suppose that you have just seen an advertisement for an upcoming concert (one week from now) by one of your favorite artists. You would be interested in buying a ticket, but (1) you don't feel like going alone; (2) you have no idea if any of your friends would be free; (3) you don't know if any of your friends are also interested in this artist, and (4) you don't want to be “pressuring” someone to attend a show that they might not enjoy. Meanwhile, the days pass by, you haven't told your friends about the show, and they end up not going.

Scenario 4: It is a Tuesday evening. Your plan is to go home and watch a rented movie on DVD. You're not planning a “party” or any formal gathering, but you would welcome the company of any friend who also wants to see that movie. Trouble is, you think that it would be awkward to send a broadcast e-mail to your friends regarding these “ordinary” plans, and for previously-stated reasons you don't want to make telephone calls. As a result, you end up watching the movie alone.

Scenario 5. It is Saturday evening at 6:00 pm. You have absolutely no plans for the evening. For social reasons, you feel that it would be inappropriate for you to send an e-mail message to your friends, or telephone them, to find out what's going on. However, if there were some less-intrusive way to “let people know that you're free,” you would be interested in doing so.

Consider also that, in each of the scenarios above, an additional reason for one's reluctance to send e-mail message or make telephone calls is the fact that, sometimes, you simply don't want to be drawn into correspondence or conversation—especially if your own plans are uncertain.

When it comes to planning events in the near- or medium-term future, you wish that there was a convenient way to send your friends a message in the general form of an invitation and in a manner such that:
You could “retrieve” or delete the message if (1) the passage of time makes your message moot, or (2) your own plans have changed, and you no longer wish for others to see your message;
Your message would be viewed only by those friends of yours who have free time and/or wish to receive such messages;
Such messages would be presented in a user-friendly format—especially so that if people receive a number of such messages, these messages will be organized in a logical manner to facilitate easier planning.

The method and system of the present invention is designed to meet these needs and to make it easier for people to plan events. A number of other “online invitation” websites already exist, but they have substantially different purposes and functionalities in the view of this inventor. For example, the popular EVITE® website (“EVITE” is a registered mark of EVITE LLC) is intended and used for planning parties—and such parties are events with fixed dates and times, which require advance planning and the tracking of replies from the invitees, colloquially referred to as “RSVPs.” Sending someone a message via the EVITE® program results in the invitee receiving an e-mail message from the EVITE® system—and also “requires” an RSVP from each invitee. Once an e-mail message is sent by the EVITE® program, it cannot be recalled—and once an event has been planned using the EVITE® system, it is difficult to cancel that event. That is, although an EVITE® system “event” can be cancelled by the would-be host, the e-mail messages already sent by the EVITE® system to the invited guests cannot be recalled.

In the view of this inventor, there is a need to provide a method and system that facilitates individual communications between persons about events that are “nearer-term” and/or “more tentative,” while also reducing the social burden on both the inviter and the invitee. The required method and system would be for “spur-of-the-moment” events or “not-yet-definite” happenings. Rather than be limited to inviting people to parties or other more organized and calendared social events, a person could use such a method and system to tell their friends: “Here's something that I'm thinking of doing; you're invited to join me if you wish.” And as soon as the inviter has found a companion (or companions), or plans have changed, the specific invitation can be edited or deleted so that it is not read by any others.

### SUMMARY OF THE INVENTION

In accordance with the objectives stated above, the method and system of the present invention is designed for “low-yield” invitations. If you're planning a party for two weeks from now, you hope that “everyone” invited will attend. But if you're looking for a same-day lunch or dinner companion, you're really just looking for “anyone” you know who is also free and interested. The method and system of the present invention has accomplished this.

It should also be mentioned here that the mark JOINVITE® is a registered mark of JoinVite LLC and that the mark is used throughout this specification in conjunction with the method and system of the present invention. For example, the JOINVITE® mark may be used to variably identify the “JOINVITE® system,” the “JOINVITE® website,” and “JOINVITE® system users,” throughout this application. No waiver of the rights in this mark is intended by this or any other usage of the JOINVITE® mark in this application.

Most of the pages on the JOINVITE® website that use the method and system of the present invention are generally similar to pages found on other websites. These “ordinary” pages and features, which will not be discussed in detail, include:
A new-member registration page;
A “What is the JOINVITE® Website?” page containing information about how the website works;
Pages presenting the site's “Privacy Policy” and its “Terms and Conditions;”
A “Contact Us” page for providing feedback to the site managers;
A “FAQs” page containing frequently-asked questions; and
Other information pages (such as “About Us” or “Ideas” pages containing additional information for users, which pages do not themselves contain detailed programming features).

Additionally, certain pages on the JOINVITE® website, including pages not listed above, may contain advertising materials, which are not part of the underlying programming of the website, and such is not a limitation of the present invention.

The JOINVITE® website resides on a computer network server and is a collection of web pages, algorithmic-driven processors and digital assets that is hosted on one or more web servers. The JOINVITE® website requires users to be registered as members, but the member-registration process is also “typical” of modern websites. As currently designed, the website requires each new member to provide (1) a working e-mail address (called the “primary” e-mail address), (2) the user's first and last name (as the user wishes to enter them; this name-information is not verified against other sources), (3) the user's choice of password, and (4) the user's check-box confirmation that the “Terms and Conditions” have been reviewed and understood. It is possible that additional information (such as ZIP codes) will be required of new users for site-tracking purposes.

A new member's registration-process is not completed, and his or her membership is not activated, until (1) all of the required information has been provided; (2) the JOINVITE® system automatically sends a confirmation e-mail message (containing a coded hyperlink) to the new member's “primary” e-mail address, (3) the new member clicks on the link and is taken automatically to a particular location in the JOINVITE® system, and (4) the user properly enters his or her password, which must match the password previously chosen. The purpose of this security feature is to ensure (as best as is commercially reasonable) that each “primary” e-mail address corresponds to the correct member, and to prevent people from successfully registering e-mail addresses that they do not personally control.

Because individuals often have multiple e-mail addresses, the method and system of the present invention is also designed to allow users to add their own “secondary” e-mail addresses to their accounts. For example, suppose that you register with the JOINVITE® system under your “primary” address of jsmith@aol.com, but you also use the e-mail addresses jsmith@hotmail.com and jsmith@yahoo.com. You can add the Hotmail® and Yahoo!® accounts as “secondary” e-mail addresses (“HOTMAIL” is a registered mark of Microsoft Corporation and “YAHOO!” is a registered mark of Yahoo! Inc.). As described below, all of the invitations that a JOINVITE® system user sends will be sent “from” the primary e-mail address, but he or she will be able to receive all of the invitations that other system members send to any of the above-mentioned subscriber's three available primary and secondary e-mail addresses. It is to be understood, however, that there is no limit to the number of e-mail accounts that a JOINVITE® system user may have.

Once a member has completed the registration-and-verification process, he or she will be ready to use the JOINVITE® system and method. Specifically, the JOINVITE® system user will, among other things, be able to (a) create a JOINVITE® system invitation, (b) send a JOINVITE® system invitation, (c) update a JOINVITE® system invitation, (d) delete a JOINVITE® system invitation, (e) “pre-set” a JOINVITE® system invitation for expiration, (f) receive a JOINVITE® system invitation, and (g) accept or respond to a JOINVITE® system invitation. The JOINVITE® system itself will, among other things, (a) automatically process JOINVITE® system invitations, (b) sort the invitee's display of received JOINVITE® system invitations, and (c) automatically delete JOINVITE® system invitations in accordance with the pre-set expiration parameters selected by the inviter.

The foregoing and other features of the method and system of the present invention will become apparent from the detailed description that follows.

### BRIEF DESCRIPTION OF THE DRAWINGS

FIGS. 1 through 31B are exemplary and annotated data displays, or “screen shots,” of the type that may be utilized in one embodiment of the method and system of the present invention.

### DETAILED DESCRIPTION

The method and system of the present invention assumes usage of a specific computer program that is used with certain system building block “components.” Those components are data structures, data processors and interfaces, and each component is a functional element. The data structures are places to organize and store data. The data processors are used to manipulate data by performing processes or applying algorithms to the data. The interfaces connect the data structures and the data processors to the outside world, or to other data structures and data processors, including the virtual community that exists within the “world wide web” or “www.” The program includes source code which is a list of instructions, written in a selected computer language, and then converted into computer machine language, which the computer uses to build the software “machine” described by the instructions. The software machine is made up of the components referred to above. The source code is simply a detailed “blueprint” telling the computer how to assemble those components into the software machine. Further, the source code is organized into separate files, files are organized into separate modules, and modules are organized into separate functions or routines to accomplish the necessary steps in accordance with the method and system of the present invention. It is to be understood that the way the source code has been organized into files, modules and functions is a matter of programmer design choice and is not a limitation of the present invention.

As alluded to earlier in the “Summary of Invention,” most of the pages on the website that use the method and system of the present invention can be said to be somewhat similar to pages found on other websites. These “ordinary” pages and features may include:
A new-member registration page;
A “What is the JOINVITE® Website?” page containing information about how the website works;
Pages presenting the site's “Privacy Policy” and its applicable “Terms and Conditions” for users;
A “Contact Us” page for providing feedback to the site managers;
A “FAQs” page containing frequently-asked questions; and
Other information pages (such as “About Us” or “Ideas” pages containing additional information for users, which pages do not themselves contain detailed programming features).

These types of pages and their associated screen displays are well known in the programming arts and can be formatted accordingly. Additionally, certain pages on the JOINVITE® website, including pages not listed above, may contain advertising materials, which are not part of the underlying programming of the website.

The JOINVITE® website requires users to be registered as members, but the member-registration process is also “typical” of modern websites. As currently designed, the website requires each new member to provide (1) a working e-mail address (called the “primary” e-mail address), (2) the user's first and last name (as the user wishes to enter them; this name-information is not verified against other sources), (3) the user's choice of password, and (4) the user's check-box confirmation that the “Terms and Conditions” have been reviewed and understood. It is possible that additional information (such as ZIP codes) will be required of new users for site-tracking purposes.

A new member's registration-process is not completed, and his/her membership is not activated, until (1) all of the required information has been provided; (2) the JOINVITE® system automatically sends a confirmation e-mail message (containing a coded hyperlink) to the new member's “primary” e-mail address, (3) the new member clicks on the link and is taken automatically to a particular location in the JOINVITE® system, and (4) the user properly enters his/her password, which must match the password previously chosen. The purpose of this security feature is to ensure (as best as is commercially reasonable) that each “primary” e-mail address corresponds to the correct member, and to prevent people from successfully registering e-mail addresses that they do not personally control.

Once a member has completed the registration-and-verification process, he or she will be able to send and receive invitations via the JOINVITE® system and method. Additionally, and because individuals often have multiple e-mail addresses, the method and system of the present invention is designed to allow users to add their own “secondary” e-mail addresses to their accounts. For example, suppose that you register with the JOINVITE® system under your “primary” address of jsmith@aol.com, but you also use the e-mail addresses jsmith@hotmail.com and jsmith@yahoo.com. You can add the Hotmail® and Yahoo!® accounts at “secondary” e-mail addresses. As described below, all of the invitations that a JOINVITE® subscriber sends will be sent “from” the primary e-mail address, but he or she will be able to receive all of the invitations that other system members send to any of the above-mentioned subscriber's three e-mail addresses.

The following are details of the key functionality of the method and system of the present invention.

### Creating and Sending a JOINVITE® System Invitation.

A JOINVITE® system invitation is an online posting that contains the following information:
Information automatically entered by the JOINVITE® system (and which cannot be deleted by the creator of the invitation):
   The sender's “primary” e-mail address (which was used for account-registration)
   The sender's first and last names, as the sender previously entered them during the registration process (or as they have been updated by the member on the Settings page)
Information added by the sender:
   A short title of the event
   The date, “start time”, and time-zone of the event
   A longer text-description of the event
   The names of the Friends or Groups (discussed below) who will receive the invitation.
   The “expiration time” of the invitation. As currently designed, the system allows the user to select one of the following “expiration times”:
      (1) The previously-entered “start time”, or
      (2) An alternative date and/or time entered by the user.

It should also be mentioned here that there is no verification of the names of JOINVITE® system members. However, the automatic attachment of the sender's “primary” e-mail address to each new JOINVITE® system invitation provides the recipient with another means of verifying the identity of the sender.

Additionally, it should be mentioned that, for most users and uses, the “time zone” should be their home time-zone. However, because the “expiration time” feature involves an automatic calculation of time, it is necessary to account for the user's geographic location (so that a message set to expire at 8:00 pm in California does not expire at the same instant as a message set to expire at 8:00 pm in New York.) Of note, the JOINVITE® system can be used by travelers as well; a person traveling to California can create events in “California time”, even while other events remain subject to other time zones.

Friends. In order to send a JOINVITE® system invitation to particular recipients, the invitation-creating member must list those recipients as “Friends” in the member's own account. This is accomplished by selecting the “Add Friend” function and entering (1) the user's choice of first and last name for that Friend, and (2) a working e-mail address for that Friend. These name-fields for “Friends” are also not verified. However, because each member's “primary” e-mail address is used as the key identifier for his or her JOINVITE® system account, the name-fields for Friends are used only for list-sorting purposes. As long as you list a functioning e-mail address for each Friend that you list, the “names” that you assign are up to you and will not be viewed by anyone else or used by the system to match-up accounts.

Additionally, and because the JOINVITE® system is not intended to be a tool for “finding” new friends, the JOINVITE® system does not provide a method for users to “search” for individuals. However, as currently designed, the system will indicate the “status” of a particular e-mail address that is entered as a new “Friend.” For example, if a member tries to add jsmith@aol.com as a new Friend, and that e-mail corresponds to a primary or secondary e-mail account of a registered JOINVITE® system member, then the status of this e-mail address will be shown as a “Member.” If not, the status will be shown as “Non-Member.”

It should also be noted here that, even though a particular e-mail address (e.g., rwilliams@aol.com) may not yet be a registered member of the JOINVITE® website, it will still be possible for JOINVITE® system members to add this e-mail address as a Friend. As a result, if rwilliams@aol.com later becomes a member, that new member will immediately be able to receive and view any then-active invitations intended for him or her.

Groups. To facilitate sending repeated invitations to particular groups of people (e.g., “Weekday Lunch Friends”), the JOINVITE® system allows members to create “Groups”, which consist of selected Friends. A particular Friend may belong to any number of different Groups. If a member sends a JOINVITE® system invitation to both a particular Friend and a Group that contains that same Friend, the system will automatically “de-duplicate” the data so that only one copy of the invitation is received.

### Updating a JOINVITE^{SM} System Invitation.

At any time after a member creates and “sends” a JOINVITE® system invitation, the same member can re-open that invitation and take any or all of the following actions:
Time:
   Change the “start time” (date and/or time)
   The “expiration time” (date and/or time)
Text-Descriptions:
   Change the short title
   Change the longer description/details
Recipients:
   Add additional Friends or Groups to the recipient-list
   Delete particular Friends or Groups from the recipient-list
Deletion:
   Or, the member may Delete the invitation in full, so that no one else can see it from that point forward.

The system is currently designed to save such deleted JOINVITE® system invitations in a “recycle bin” of sorts, so that the creating member may at some point “recycle” and re-post a particular invitation for a new date/time in the future. For example, a member with a regular invitation (containing lots of details) may wish to recycle the previously-deleted invitation, as an alternative to re-typing all of the information.

### Expiration of JOINVITE® System Invitations.

Once a JOINVITE® system invitation reaches its pre-set “expiration time,” or when the member who created it decides to delete it, then none of the previously-intended recipients will be able to view this invitation. Similarly, if a particular Friend was originally listed as a recipient, but was later removed from the recipient-list, then that Friend will no longer be able to view the invitation. (And, as designed, that now-removed Friend will have no indication that the event was posted in the past or remains posted for other members.) The same logic applies to the deletion of Group recipients.

### Receiving a JOINVITE® System Invitation.

A JOINVITE® system member who receives a JOINVITE® system invitation from another member will (after selecting that particular invitation from the sorted list, as described below) see the following information, which was entered either by the Sender or by the system itself:
The short-title of the event;
The “name” of the Sender (automatically retrieved from the name-field information entered by the Sender);
The “primary” e-mail address of the Sender (automatically retrieved from the Sender's account-information);
The particular e-mail address at which the Recipient “received” this posting;
The “start time” of the event; and
The text-description and details regarding the event.

By way of example, if the Recipient has three different e-mail accounts registered with the JOINVITE® system (one primary account, and two secondary accounts), the display of this “To:” information will let the user know which address was used by the Sender. This may aid the Recipients in determining whether or not a particular Sender is legitimate (as if, for example, a JOINVITE® system invitation was addressed to a publicly-posted e-mail address as opposed to a private address known only to trusted friends).

### Automatic Processing of JOINVITE® System Invitations.

In the background, the system automatically processes all of the JOINVITE® system invitations that have been created and properly matches them with their intended recipients. In brief, the system asks the following questions:
Has the invitation been created and “sent”, and not manually deleted by the creator?
   If so, it will be distributed to the current list of intended recipients (which may have been updated by the sender).
Has the invitation reached its pre-selected “expiration time”?
   If so, the invitation will not be visible to any recipients.
   If not, the invitation will be visible to the current recipients.
After reviewing the invitation's list of individual Friends and list of Groups, who are all of the “unique individuals” who are intended to receive this invitation?
   The system will make this invitation viewable by all of these members, and no others (except for the creator).

### Sorted Display of Received Invitations.

One of the purposes of the “start time” data-field is to provide a logical means for sorting invitations by their date and time. For each member who logs in, the system will compile and display the following:
A summary list of the active (non-expired, and non-deleted) invitations received by the logged-in Member.
   This summary will list the following items for each invitation:
      The event's short-title;
      The first and last name of the sender;
      The date of the event (either a date-description, or “Today” or “Tomorrow”, as appropriate); and
      The start-time of the event.
These items will be automatically sorted by date and start-time, so that the events happening nearest in the future will be listed at the top. The recipient will therefore have an organized “menu” of invitations to choose from.

At the very top of the same screen, there will also appear a separate, date-sorted list of still-active invitations that were sent by the same member. (This is to keep members aware of the invitations that they still have “out there,” and to help them recognize any schedule-conflicts between the invitations they sent and any received-invitations that they may wish to accept.)

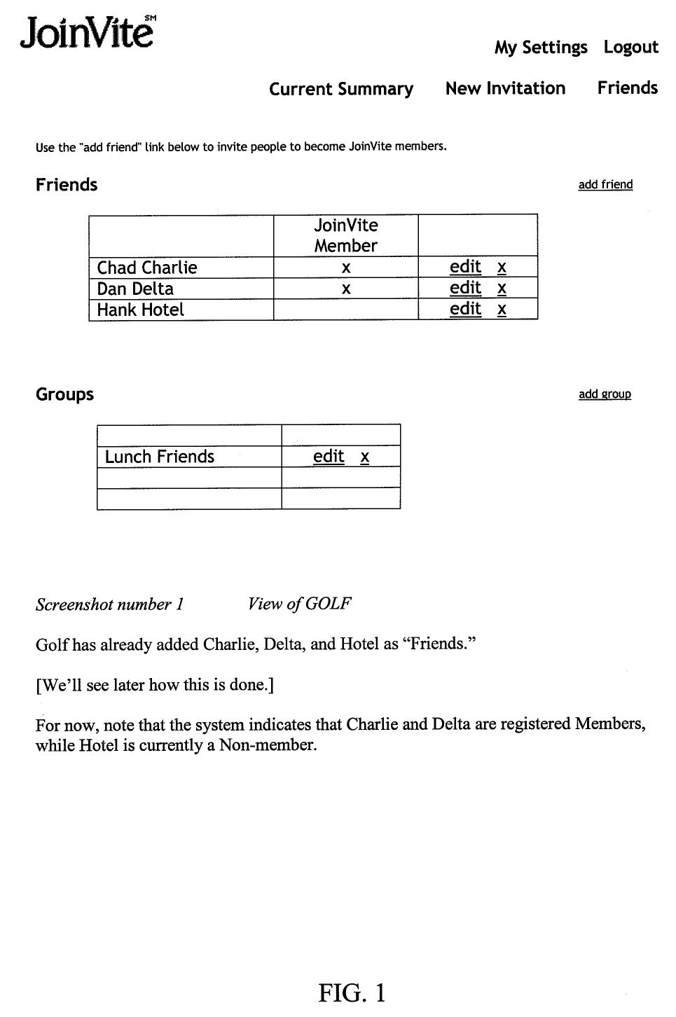

In application, reference will now be made to FIGS. 1 through 31B, each of which is a data display, or screen shot, which has been annotated and which illustrates one embodiment of the method and system of the present invention. In reviewing these displays, it is to be understood that a number of users of the JOINVITE® system will be viewing each display as will be explained and that the displays used describe the experience of each user, but not the particular programming code that is creating this functionality. It is also to be understood that the method and system of the present invention is not limited to the embodiment as illustrated and that the “look and feel” of the displays may be varied within the scope of the invention.

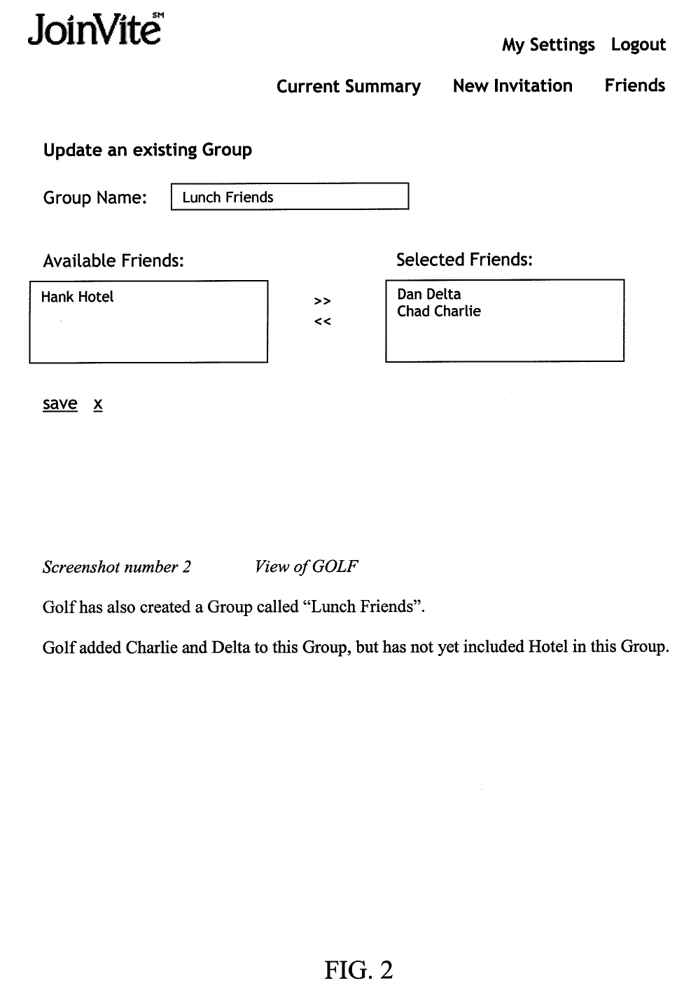

Referring now to FIG. 1, this is a display viewed by the user “Golf” and illustrating Golf's “friends” who are Charlie, Delta and Hotel. This display also indicates that Charlie and Delta are registered users of the JOINVITE® system, and that Hotel is not. In the JOINVITE® system, Golf can create groups of Friends. In FIG. 2, it will be seen that Golf has created a group called “Lunch Friends,” which includes Charlie and Delta.

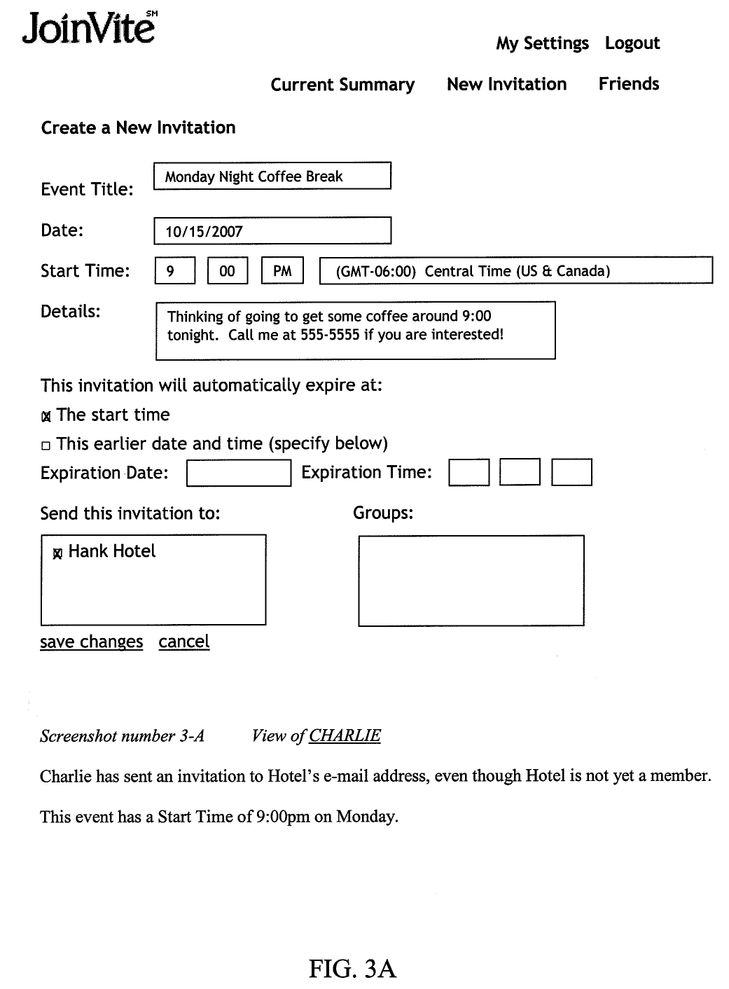

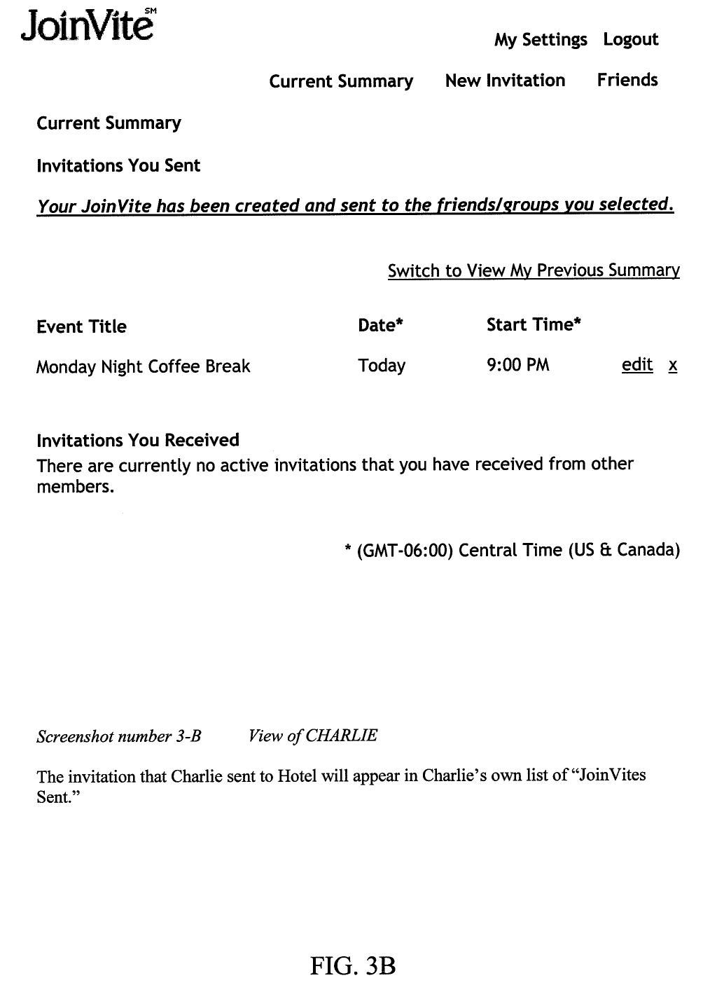

Charlie has decided that he would like to create a JOINVITE® system message. In FIG. 3A, it is seen that Charlie has populated the fields of “Event Title,” “Date” and “Start Time,” and “Message” to create and send such a message. In this case, the message is sent to Hotel. In FIG. 3B, it will be seen that Charlie can review a “Current Summary” of his sent messages.

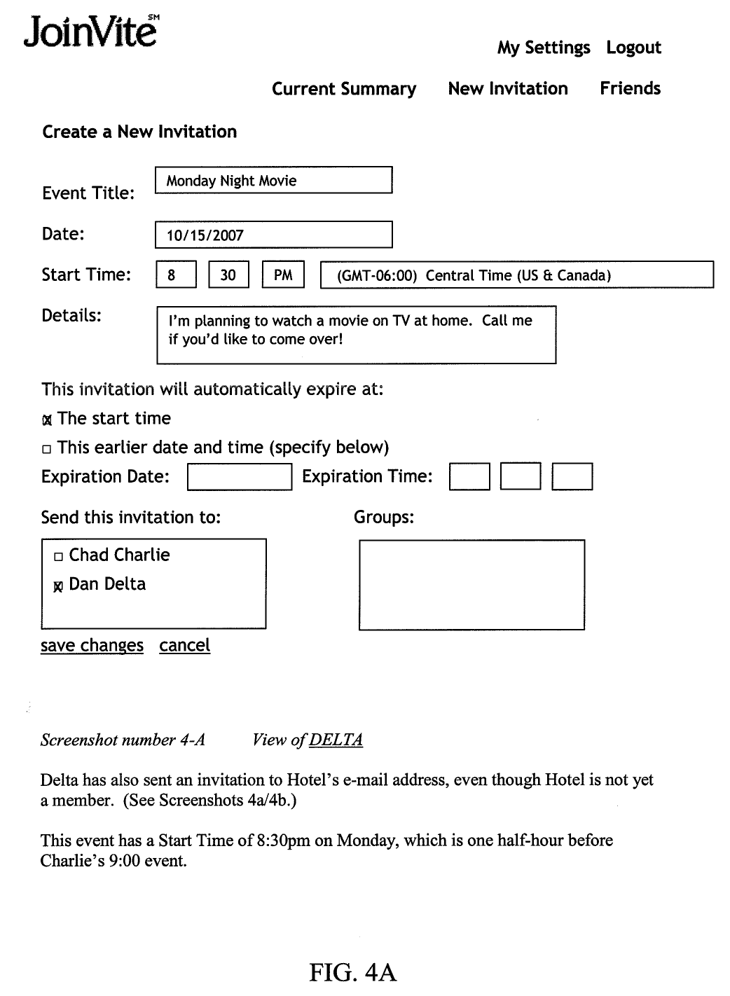

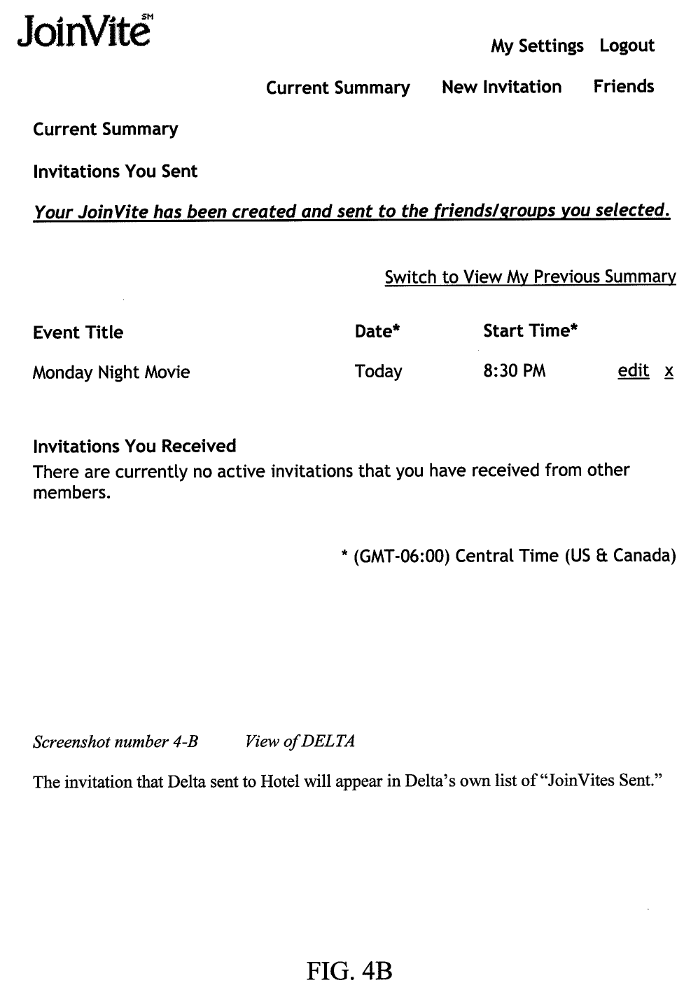

In FIG. 4A, it is seen that Delta has sent a message to Hotel as well. Delta can also view his sent messages. See FIG. 4B.

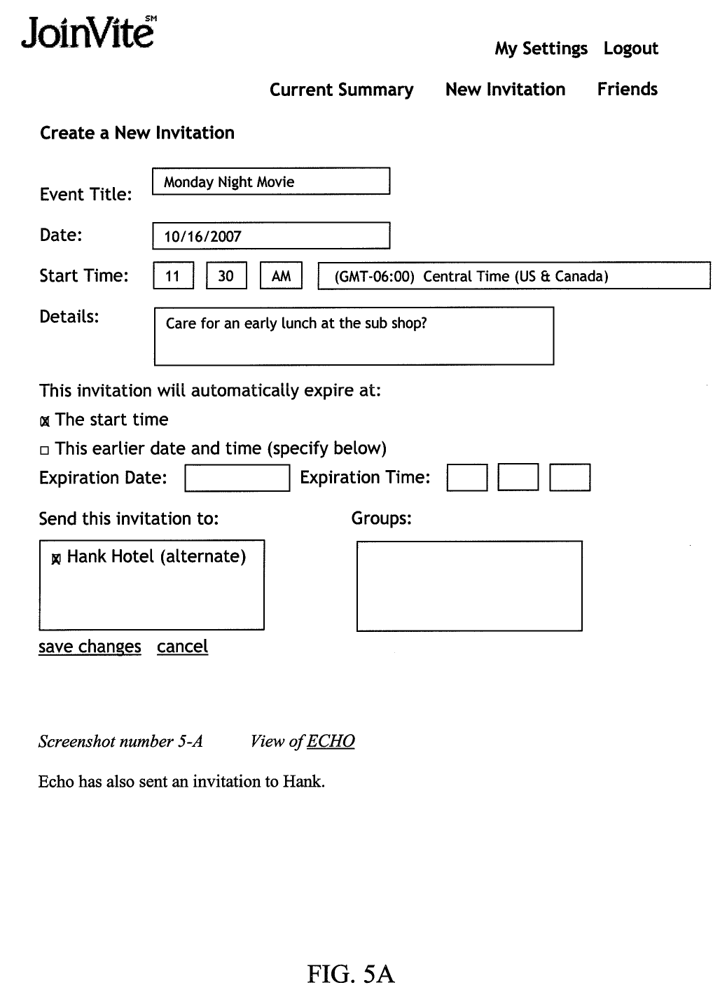

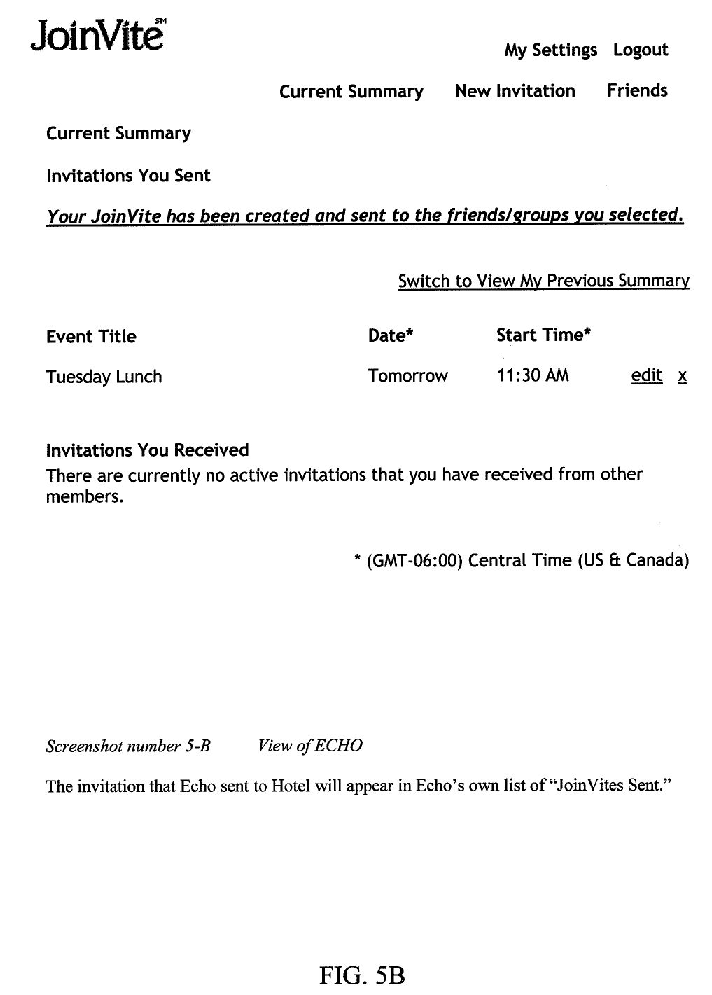

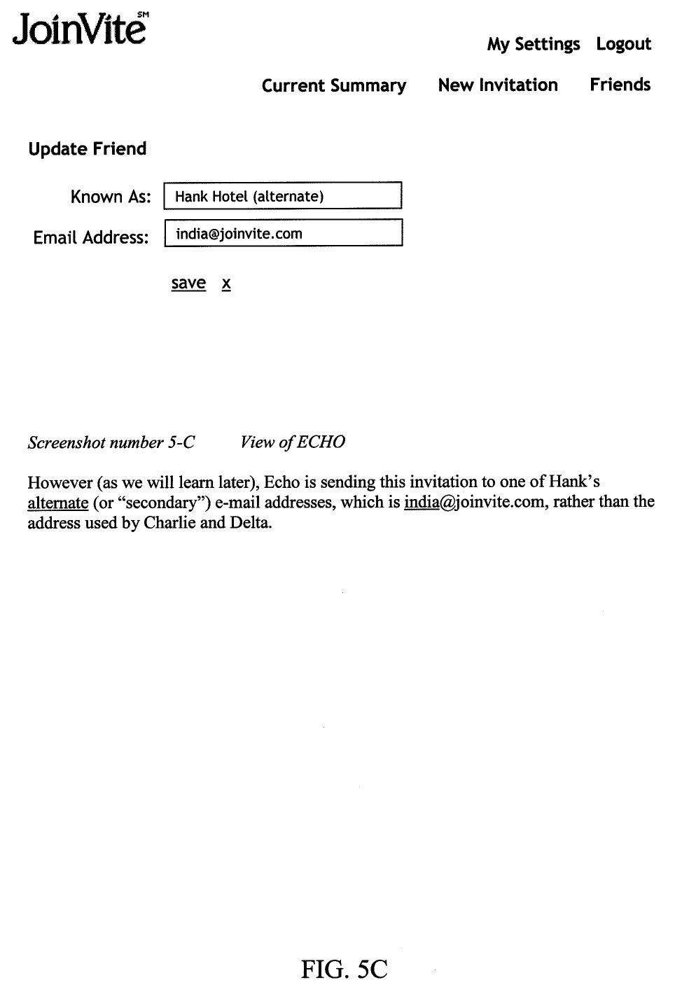

In FIGS. 5A and 5B, it is similarly seen that Echo has sent an invitational message to Hotel and that Echo can view his sent messages. In FIG. 5C, however, we see that Echo is sending his message to one of Hotel's secondary e-mail addresses, rather than the address used by Charlie and Delta.

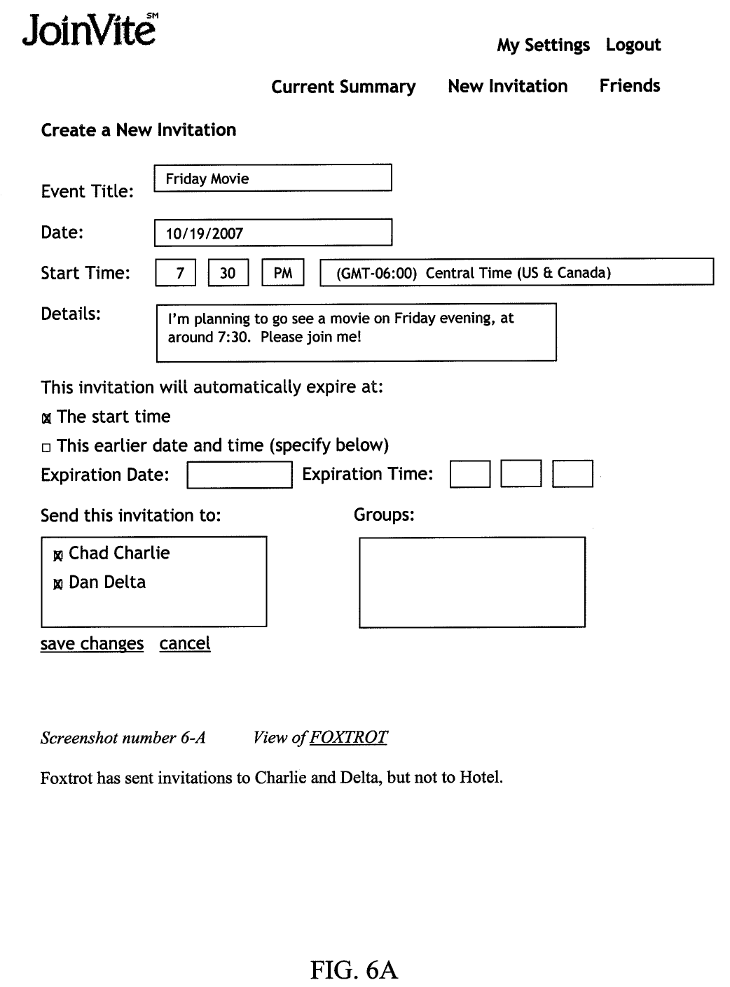

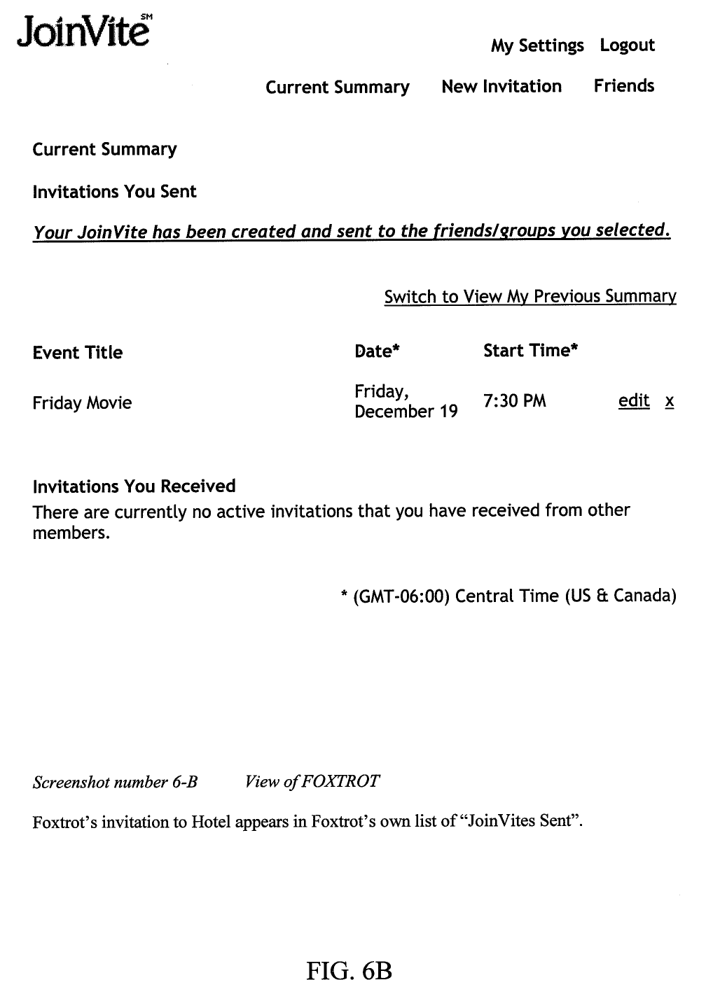

In FIG. 6A, it is shown that another JOINVITE® system member, Foxtrot, has similarly sent messages to Charlie and Delta, but not to Hotel. As with the other members, Foxtrot can view his sent messages. See FIG. 6B.

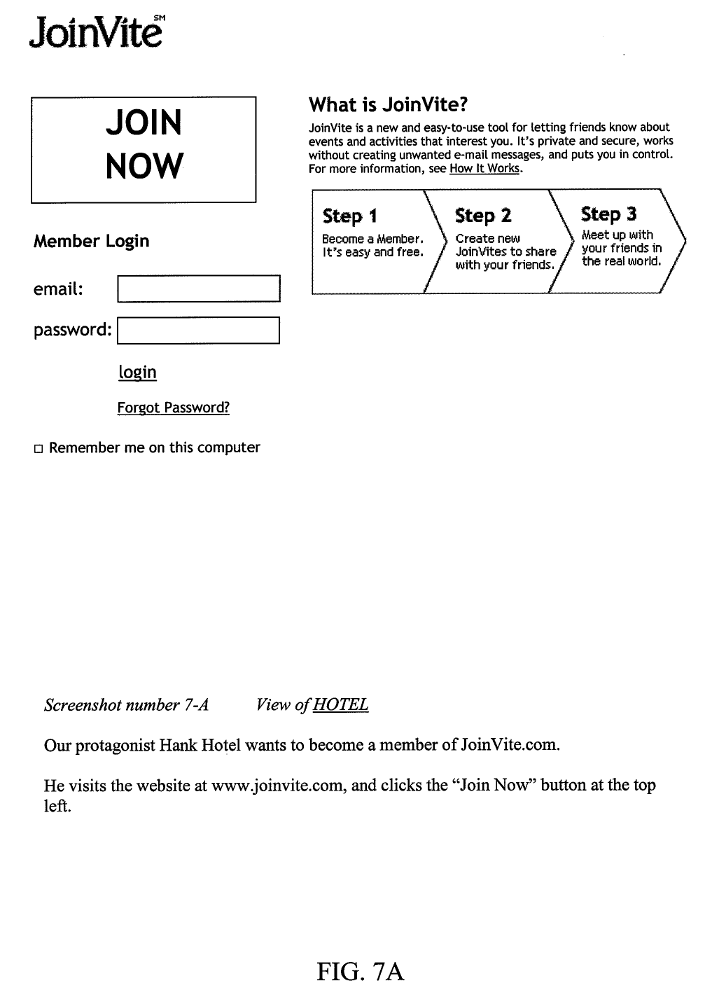

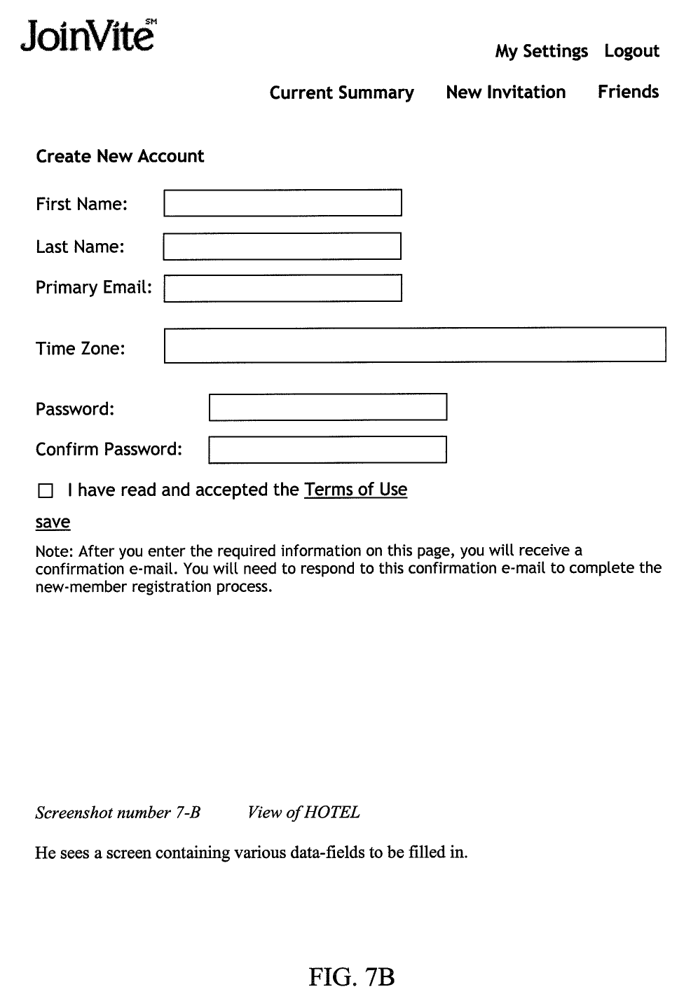

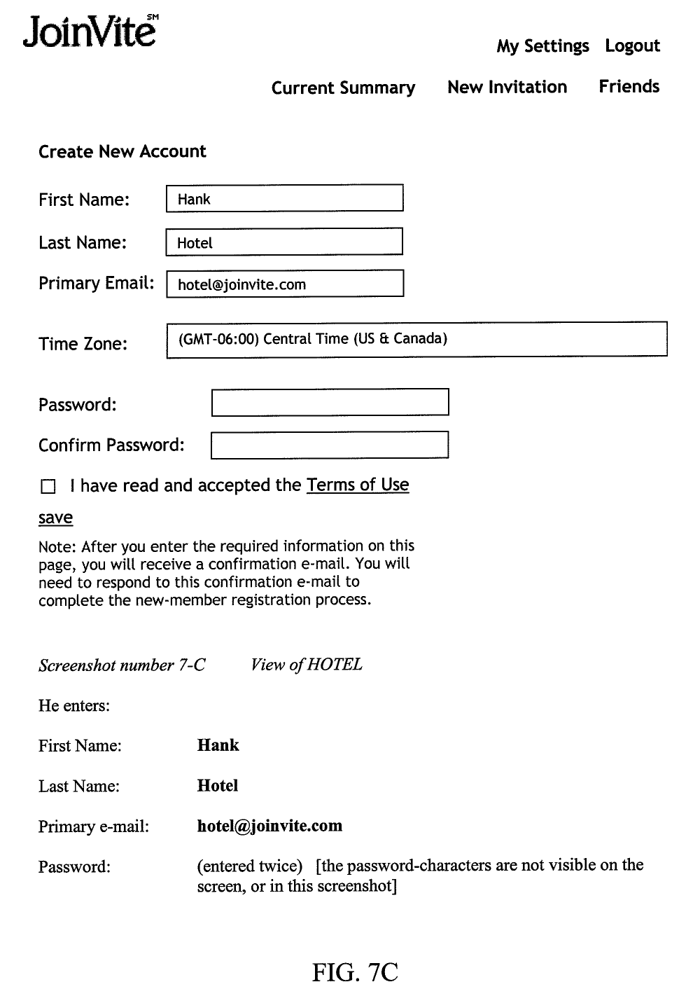

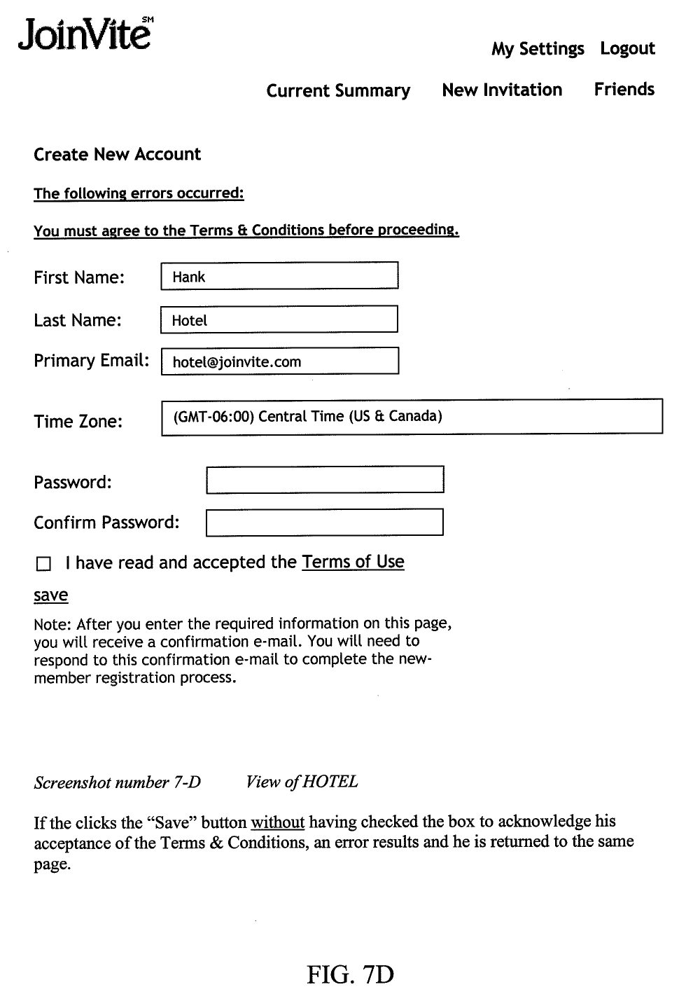

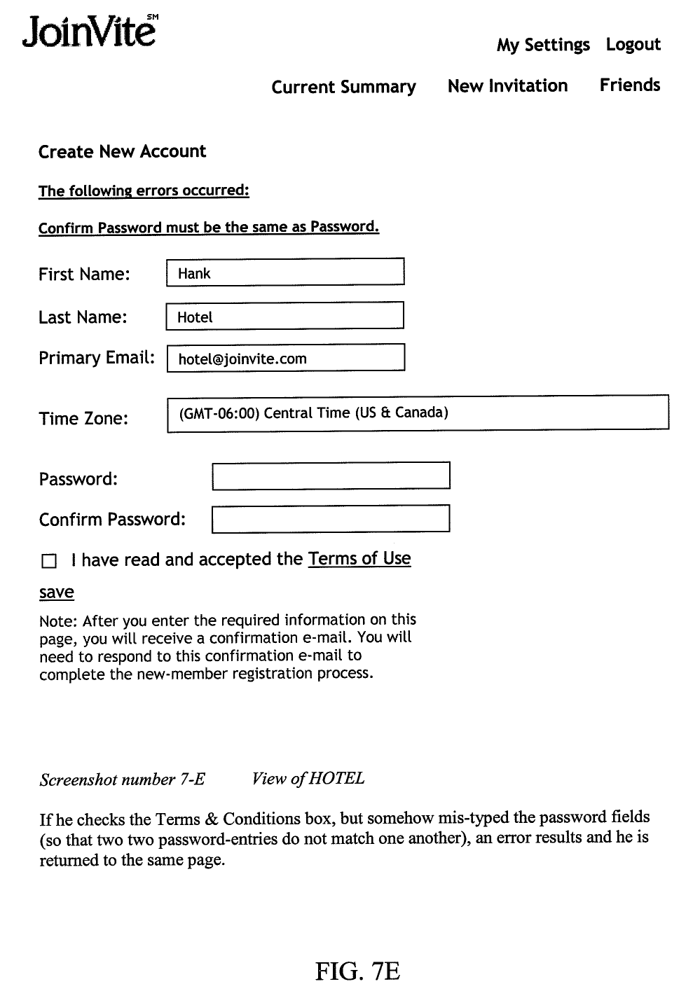

In FIGS. 7A-7E, it is shown for the first time how a JOINVITE® system user, in this case Hotel, actually becomes a member. In FIG. 7A, Hotel is invited to join and become an active user by following three simple steps. FIGS. 7B-7E illustrate the display that Hotel will use to populate different fields relative to his user information, including his first and last names, his primary e-mail address and his password. This display also asks Hotel to confirm his password and to acknowledge his acceptance of in the JOINVITE® system “Terms & Conditions.”

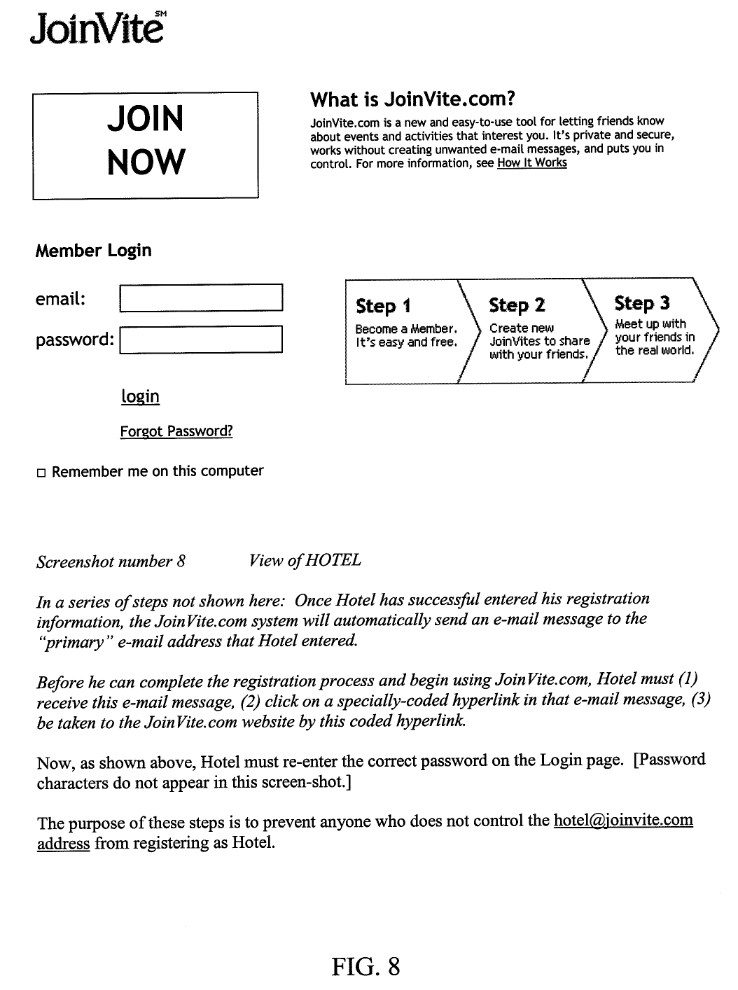

FIG. 8 illustrates a screen display that will be viewed by Hotel upon his successful completion of registration with the JOINVITE® system. Additional steps are added, as shown in the annotations to FIG. 8, for security reasons.

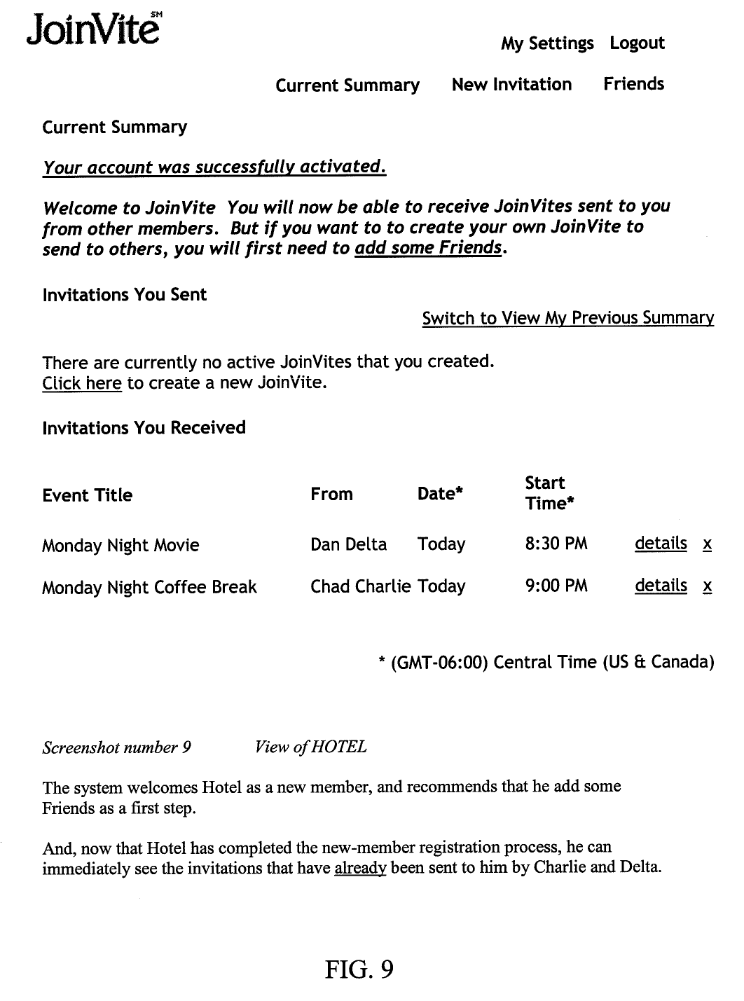

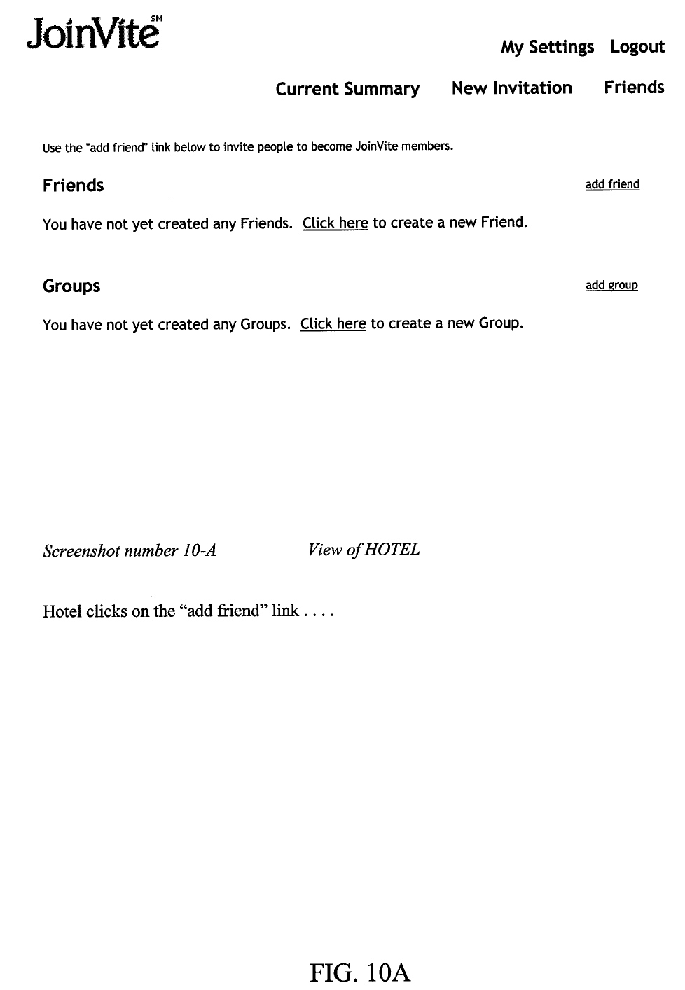

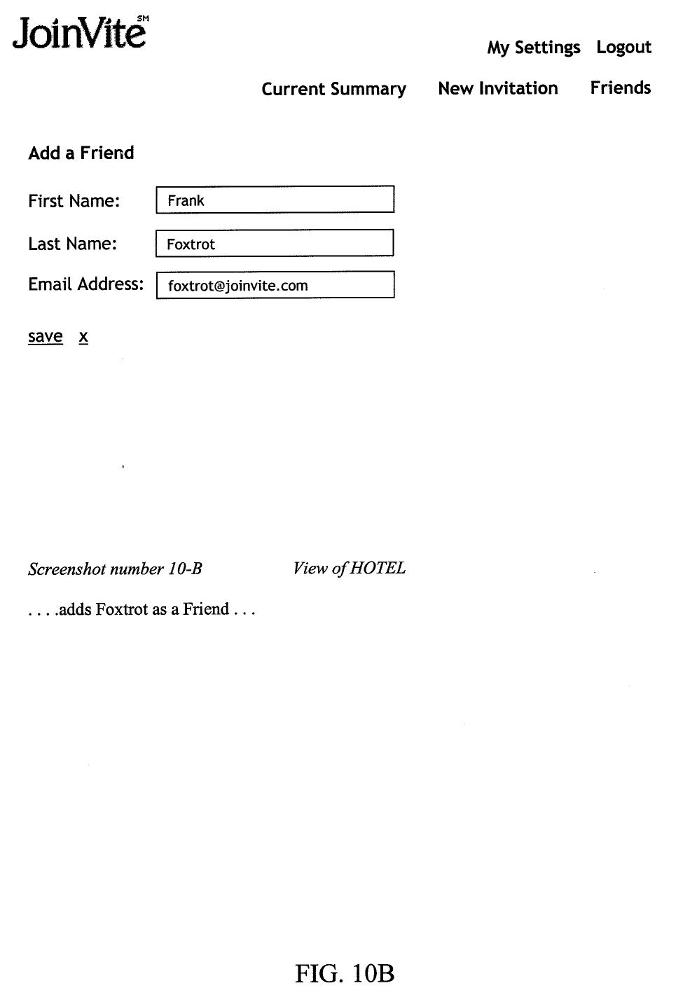

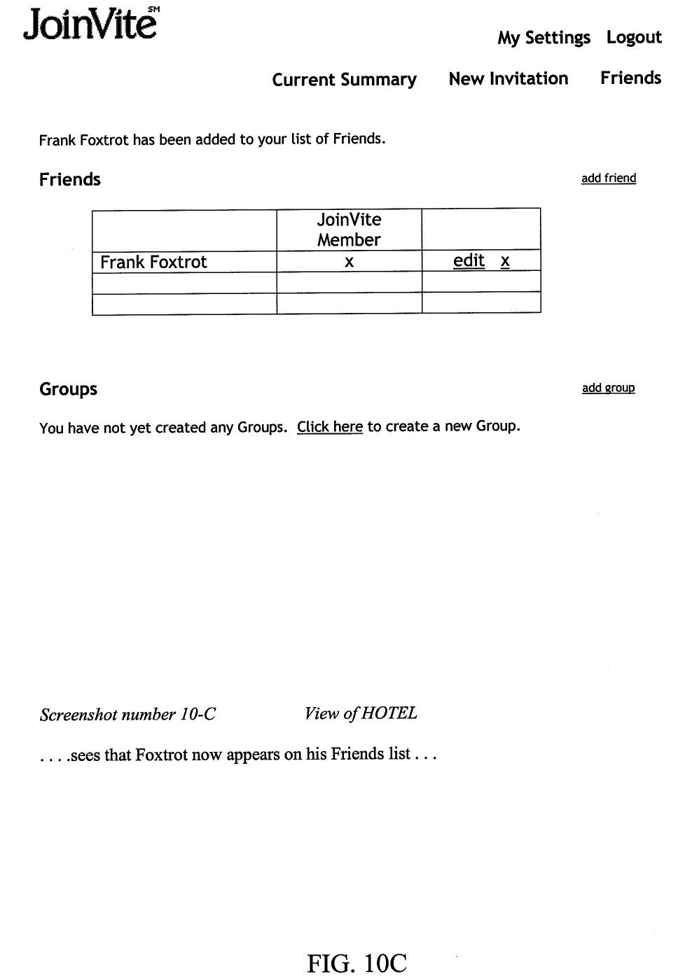

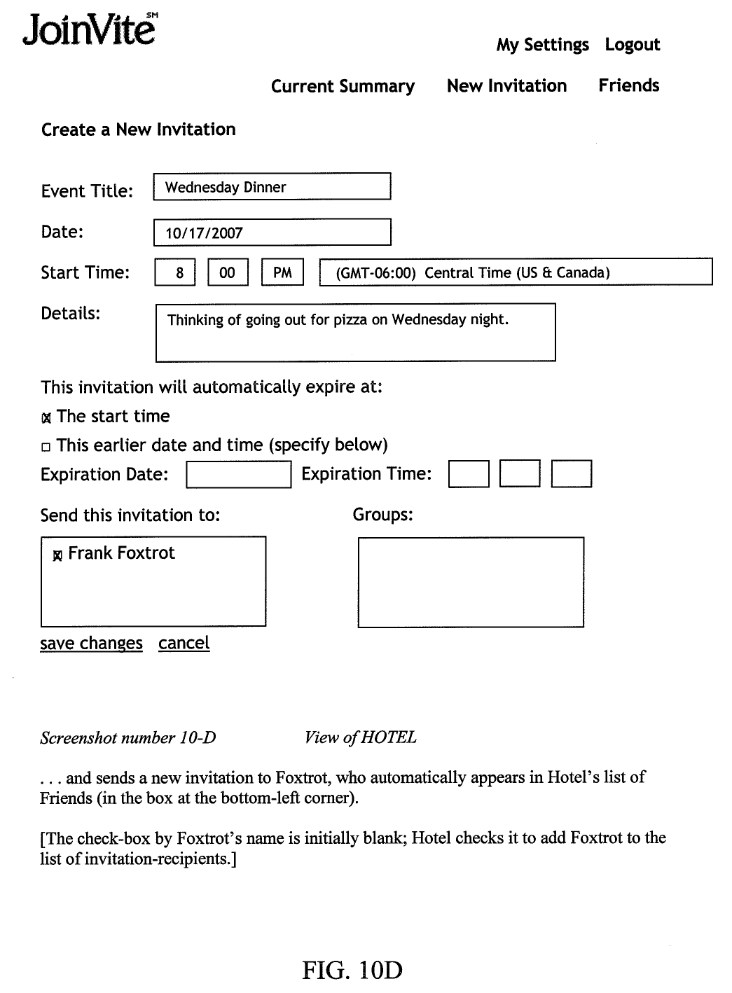

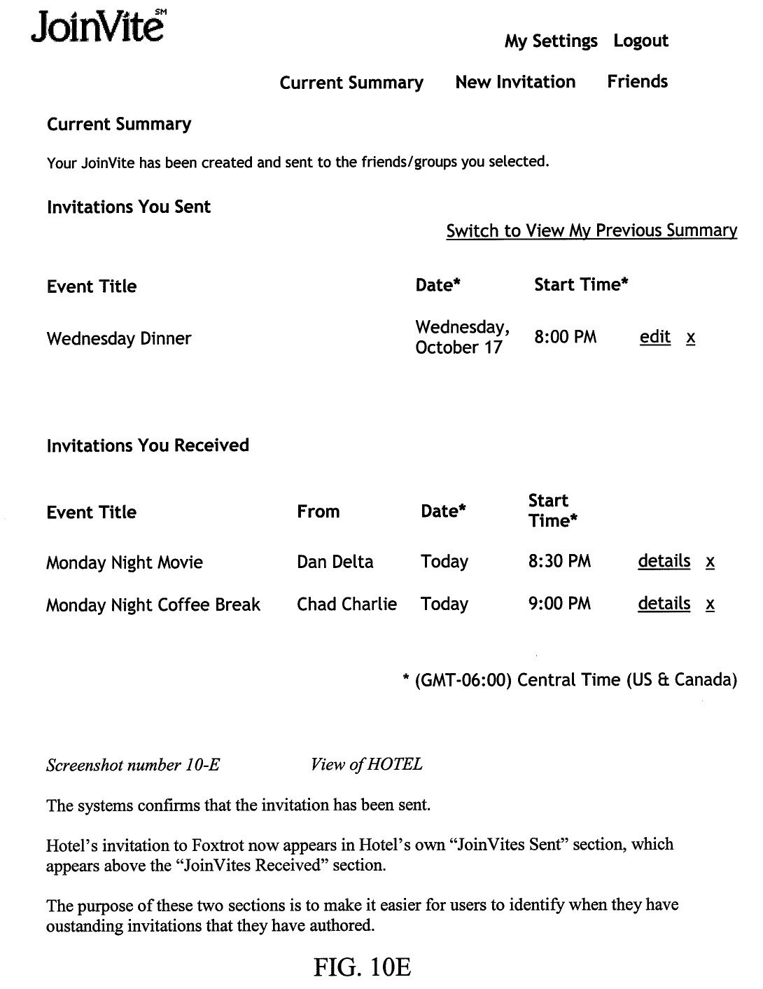

Since Hotel is now an “official” registered user of the JOINVITE® system, he will now be able to see that his account has been successfully activated and that he has several invitational messages awaiting him. See FIG. 9. Because Hotel has not populated his membership with any “Friends,” he is prompted, as shown in FIG. 10A, to create friends and groups. Hotel adds Foxtrot as a “Friend” as is shown in FIG. 10B and Hotel sees, in FIG. 10C, that Foxtrot now appears in Hotel's “Friends” list. Hotel now creates a new invitational message for Foxtrot and confirms that the message has been sent. See FIGS. 10D and 10E, respectively.

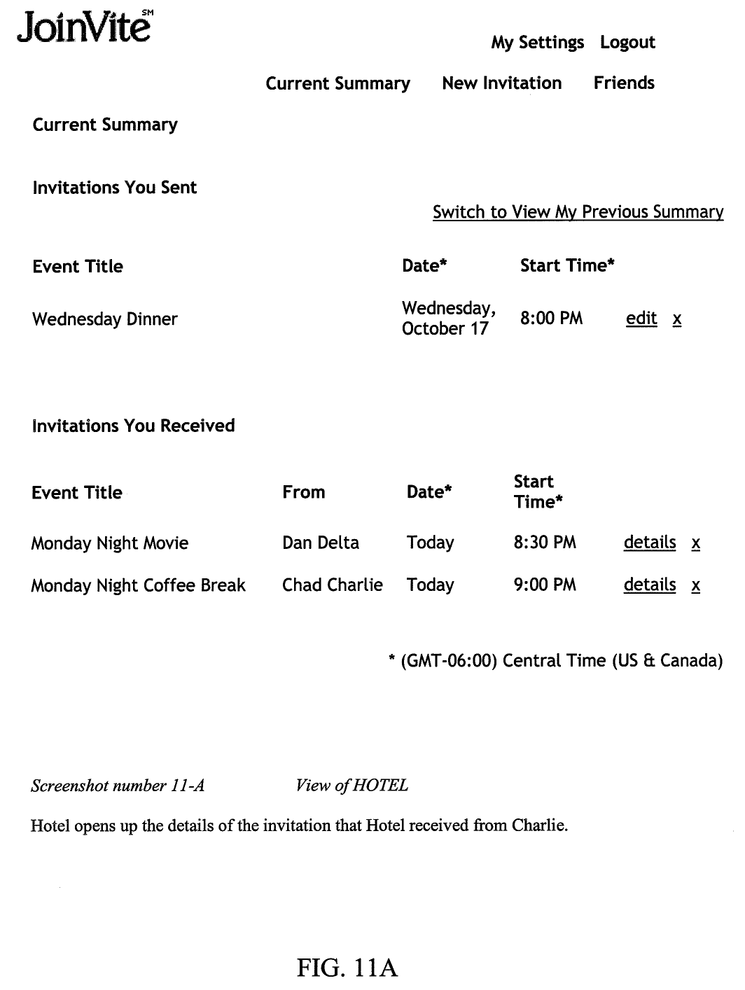

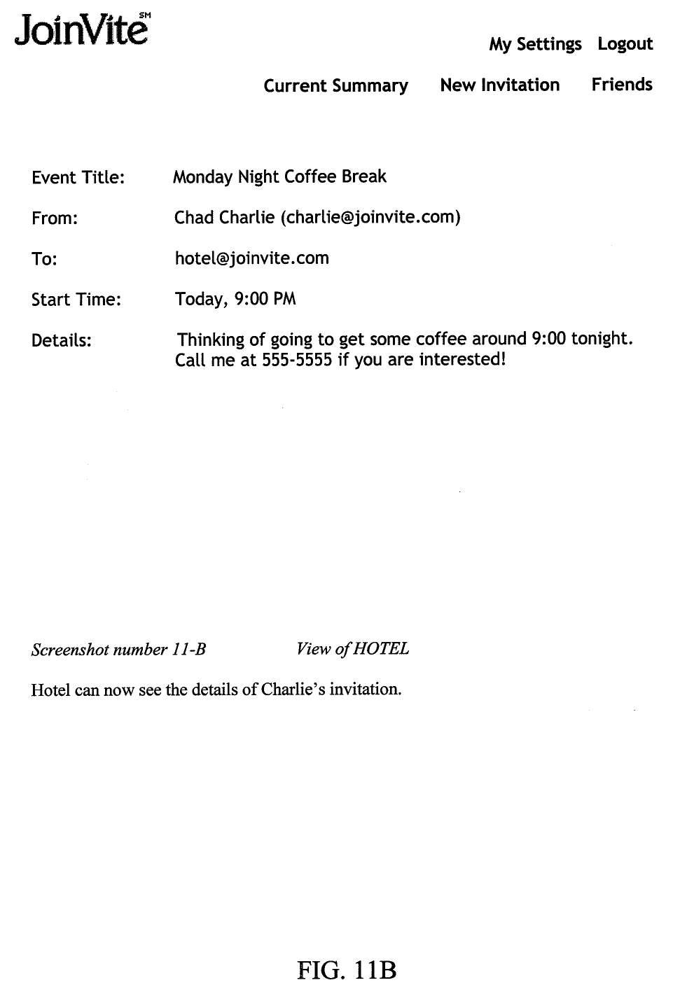

In FIG. 11A, it will be seen that Hotel can access the specifics of the invitational message that Hotel received from Charlie by “clicking” on the “details” button associated with that message. The details of that message are then viewable by Hotel. See FIG. 11B.

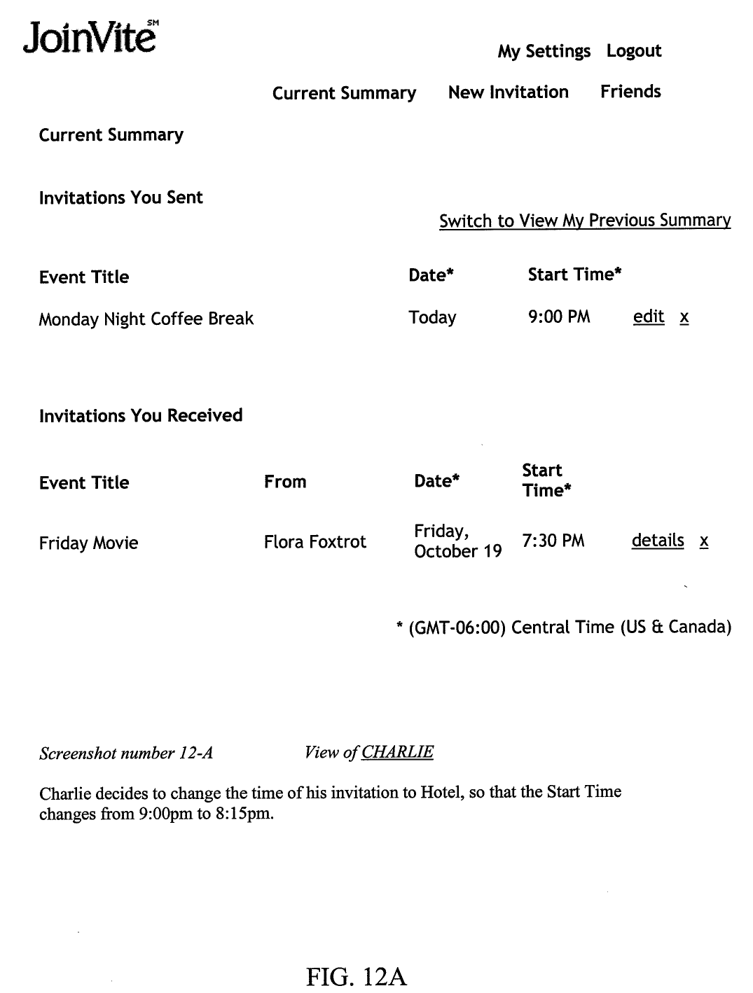

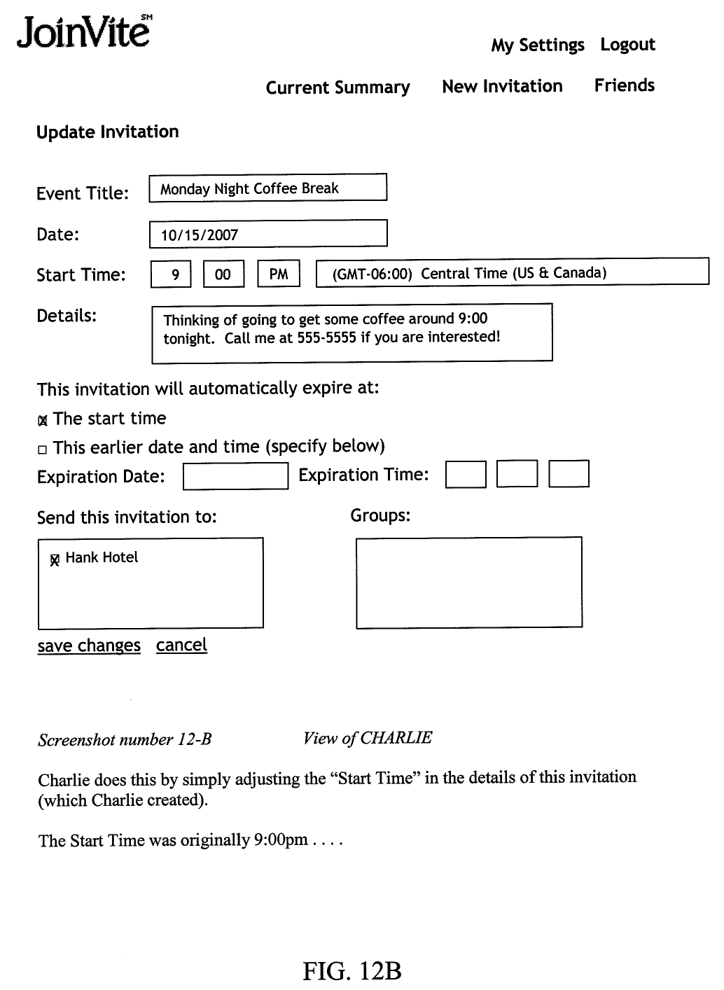

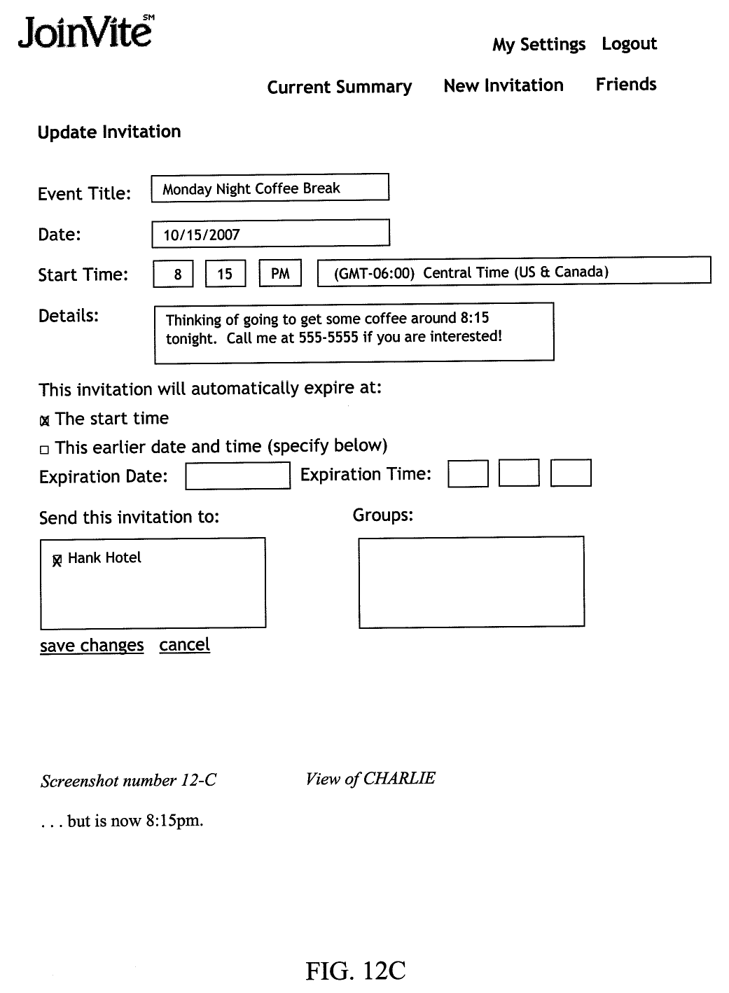

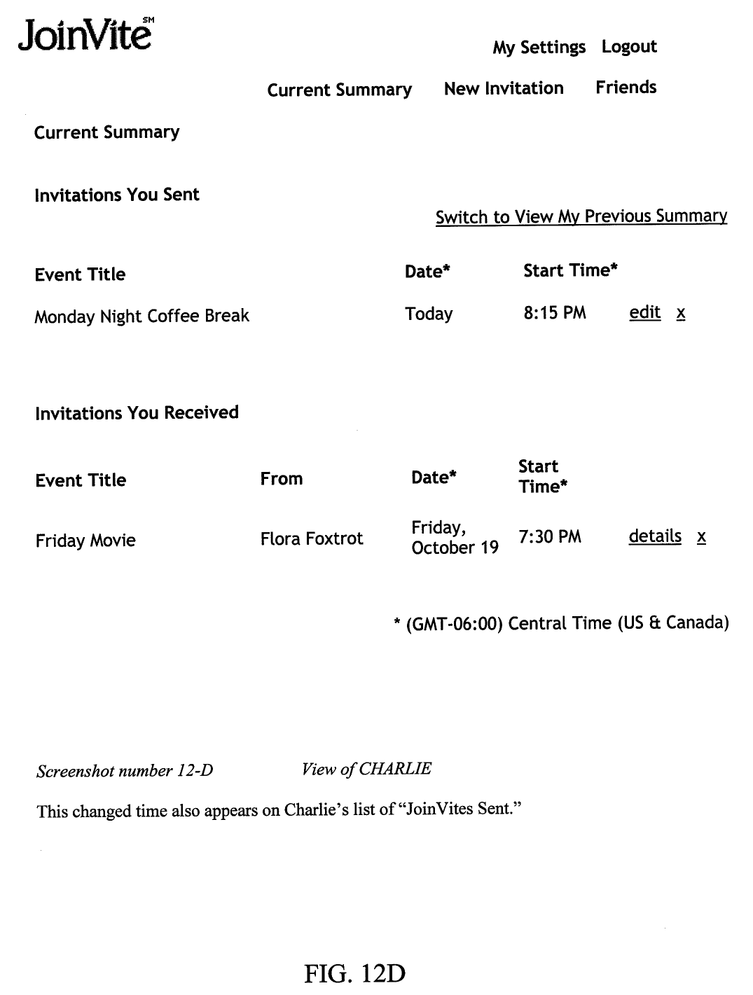

FIG. 12A illustrates a screen shot as viewed by Charlie. Charlie has decided that he wants to change the time of his invitation to Hotel, so that the “Start Time” is advanced to 8:15 pm. By clicking on the “edit” button associated with this display, Charlie can effect this change. See FIGS. 12B and 12C.

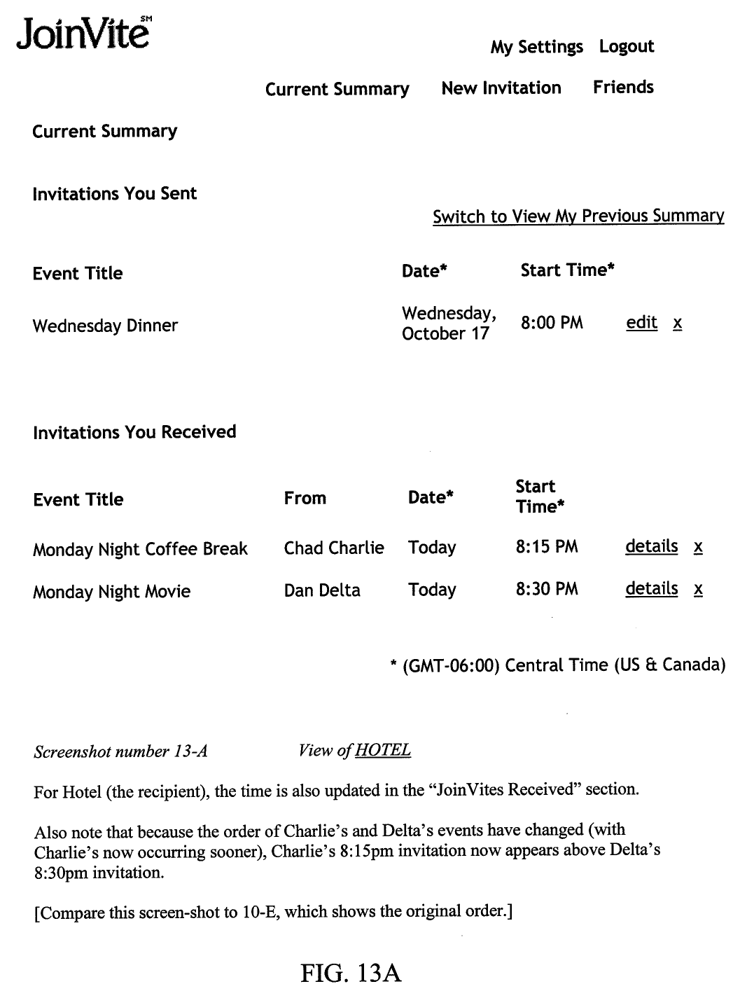

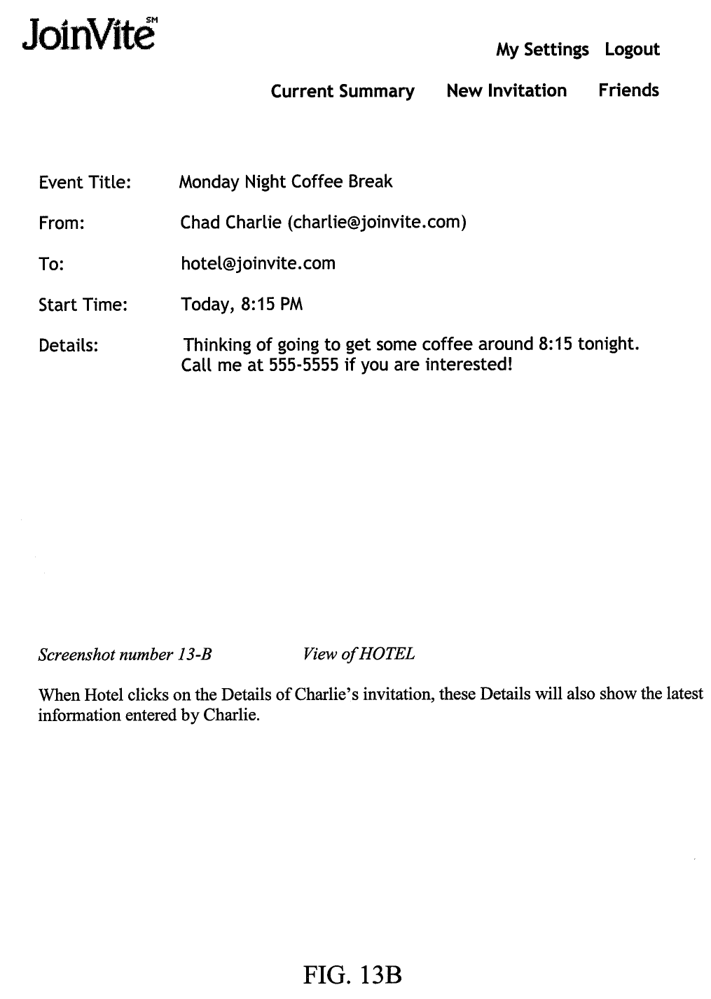

Returning to the active display as viewed by Hotel, as shown in FIG. 13A, it will be seen that the “Start Time,” as previously changed by Charlie, has also been changed in Hotel's “Current Summary” of received invitational messages. It in should also be noted that, in that display of received messages, that the order of the listed events has changed in view of the time change to the event made by Charlie. This should be compared to the display illustrated in FIG. 10E, which shows the original order of Delta's invitation ahead of or above Charlie's invitation. When Hotel clicks on the “details” button associated with Charlie's invitation, the then-current information entered by Charlie will be viewed by Hotel. See FIG. 13B.

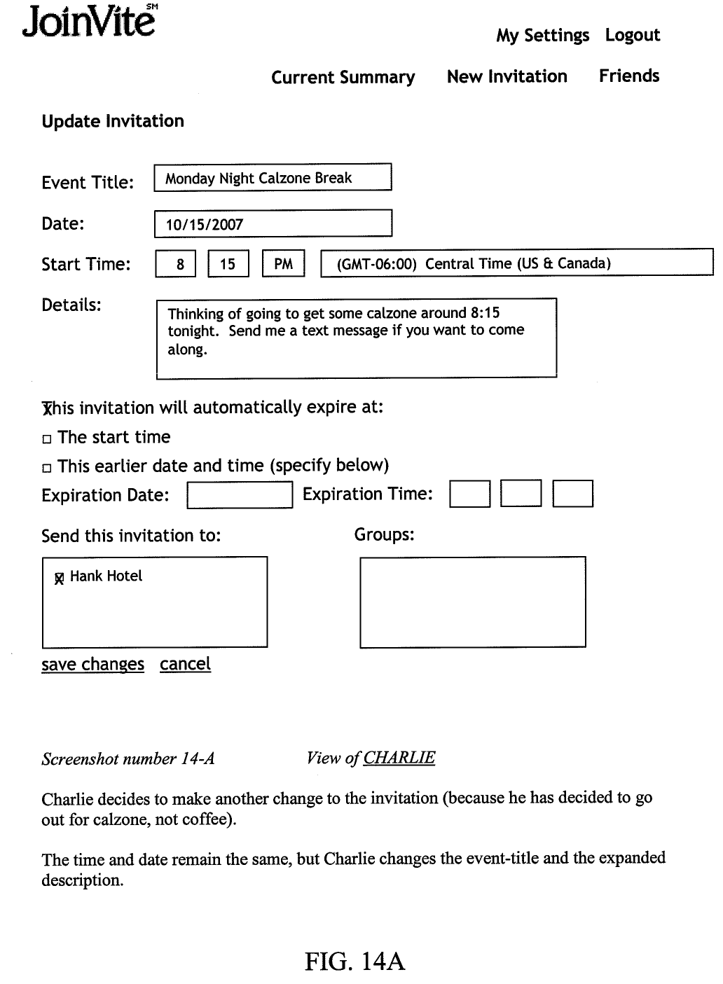

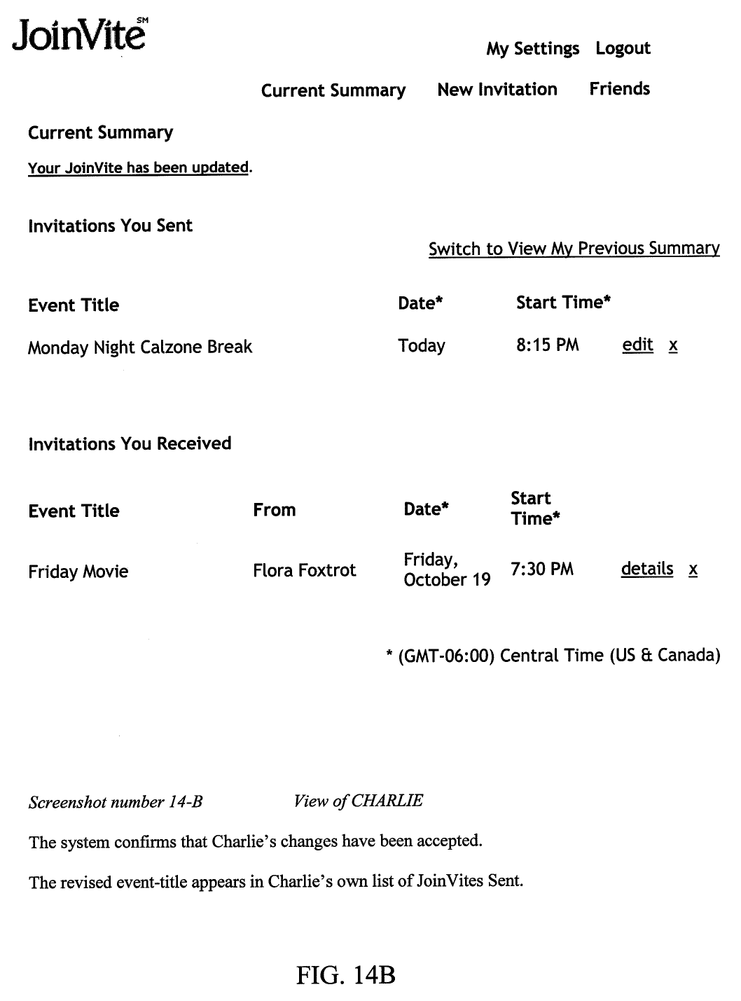

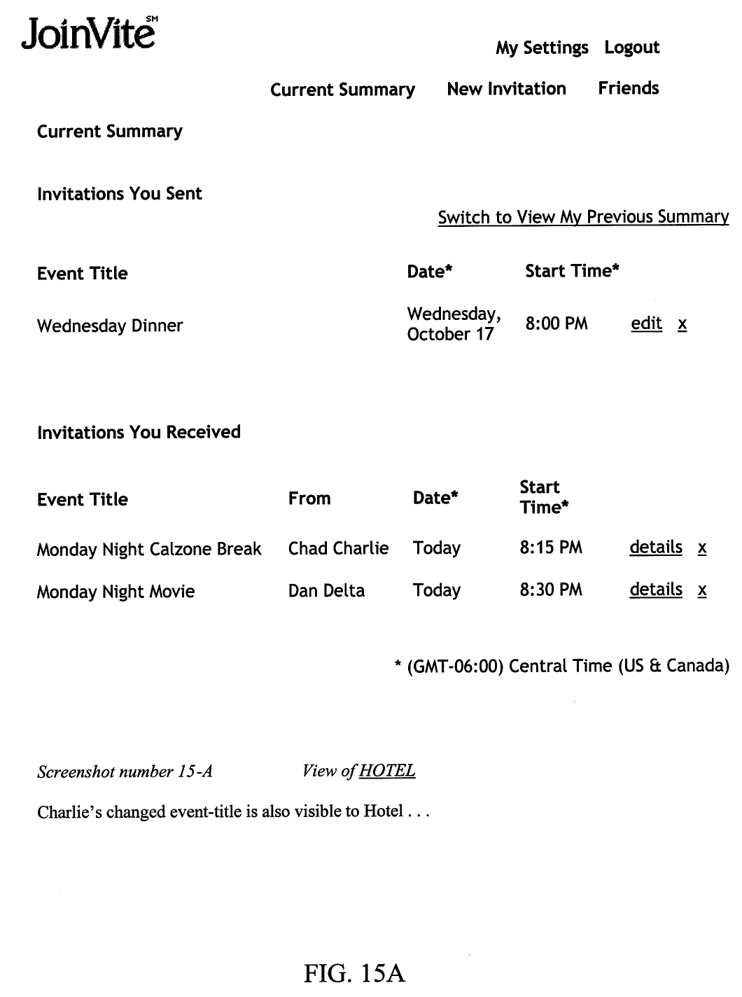

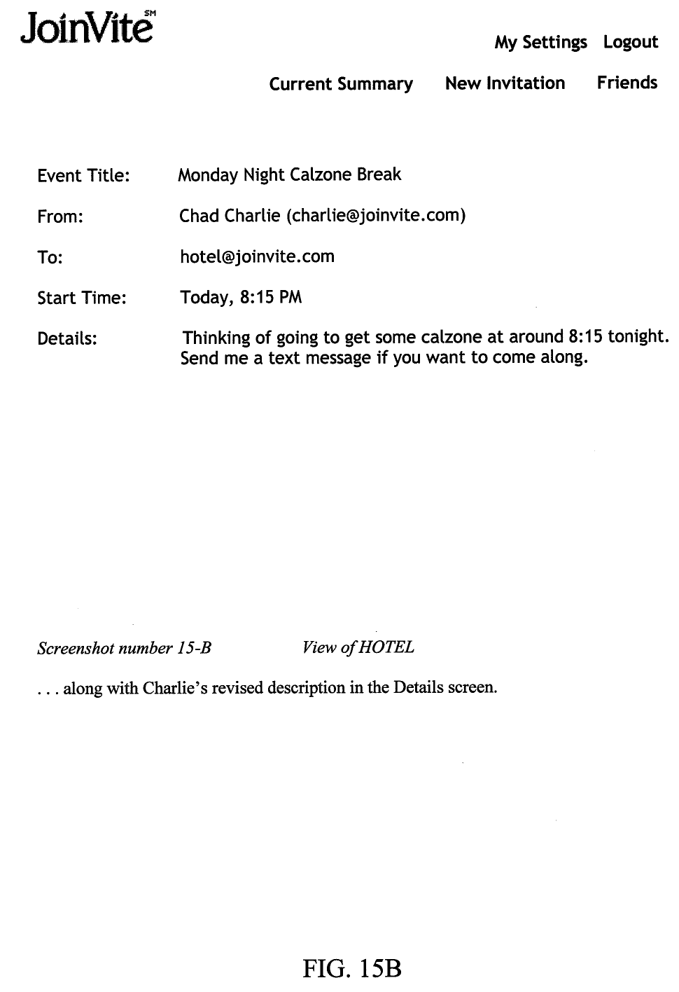

FIG. 14A is the screen display viewed by Charlie as he decides to make another change to his invitation for 8:15 pm. This time, Charlie has decided to go out for calzone instead of coffee. While the date and time remain the same, the “Events Title” and the description in the “Message” fields are changed. This change is shown to be accepted by the JOINVITE® system as is illustrated by Charlie's screen display shown in FIG. 14B. This change is also reflected in Hotel's display of received messages, as shown in FIGS. 15A and 15B.

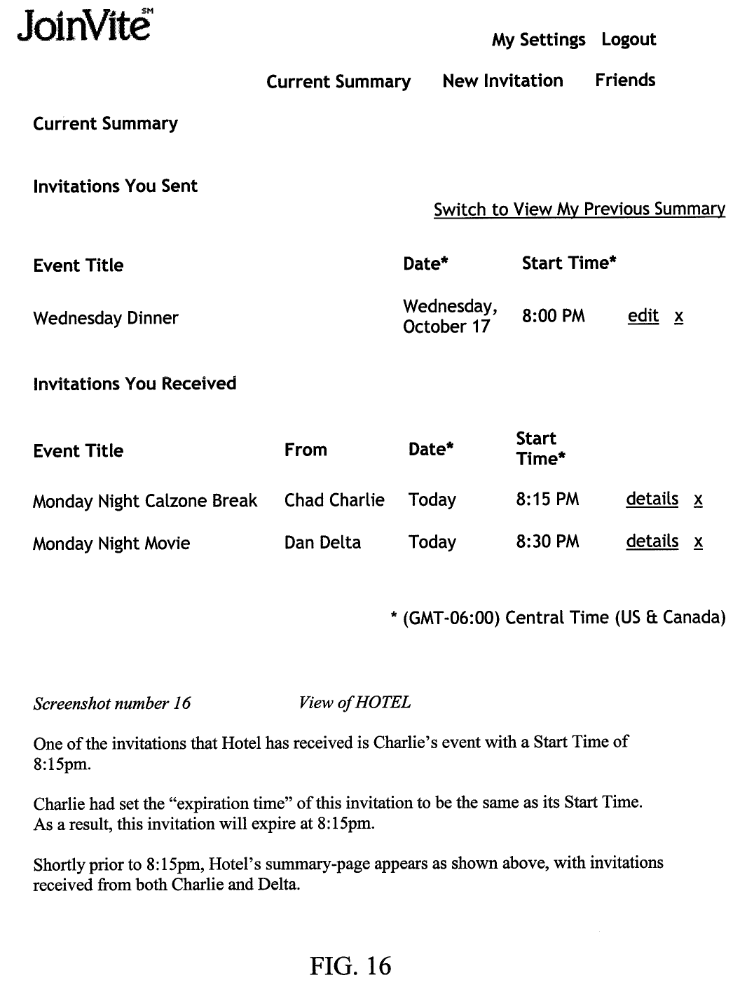

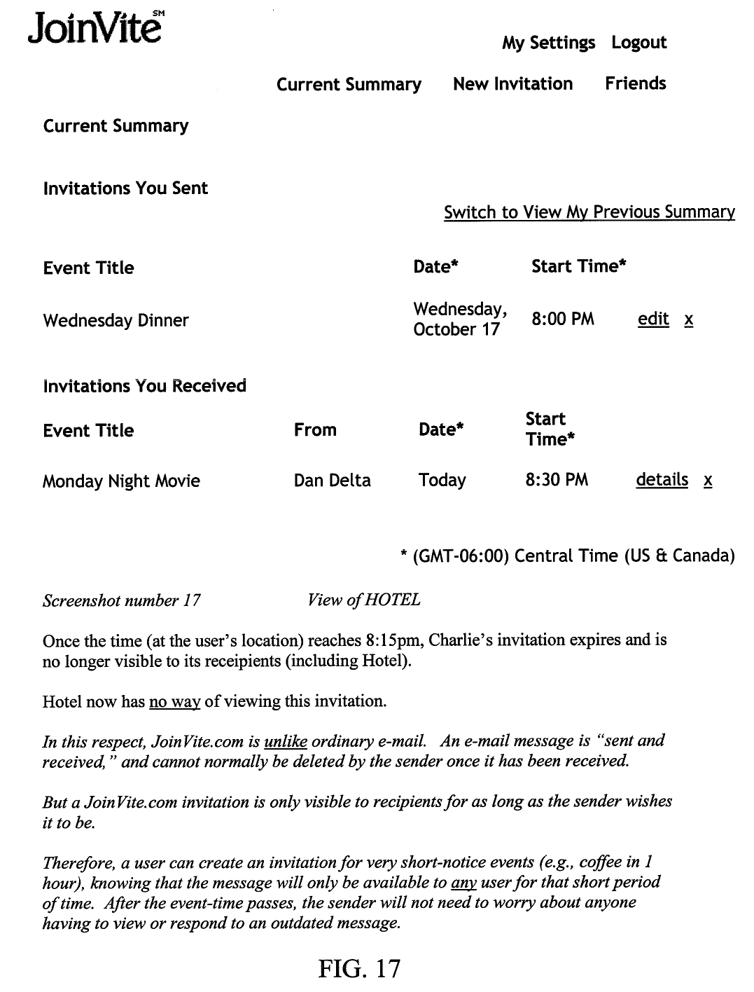

Referring now to FIG. 16, it will be seen that one of the invitations that Hotel has received is Charlie's event with a “Start Time” of 8:15 pm. Because Charlie has set the “expiration time” of this invitation to be the same as its “Start Time,” this invitation will expire at 8:15 pm. Shortly prior to 8:15 pm, Hotel's summary-page appears as shown in FIG. 16, with the invitations received from both Charlie and Delta. Once the time reaches 8:15 pm, Charlie's invitation expires and is no longer visible to its recipients, including Hotel, and no recipient has any way of viewing this now-expired invitation. See FIG. 17. The point to be made with respect to this set of screen displays is that it will be apparent to those skilled in the art that the JOINVITE® system is unlike ordinary e-mail. In ordinary e-mail, a message is sent and received. The message cannot normally be deleted by the sender after it is sent. A message sent using the method and system of the present invention is only visible to recipients for as long as the sender wants it to be. Accordingly, a user of the JOINVITE® system can create an invitational message for very short-notice events, knowing that the message will only be available to recipients for that short period of time. After the event-time passes, the sender will not need to worry about anyone having to view or respond to an outdated message.

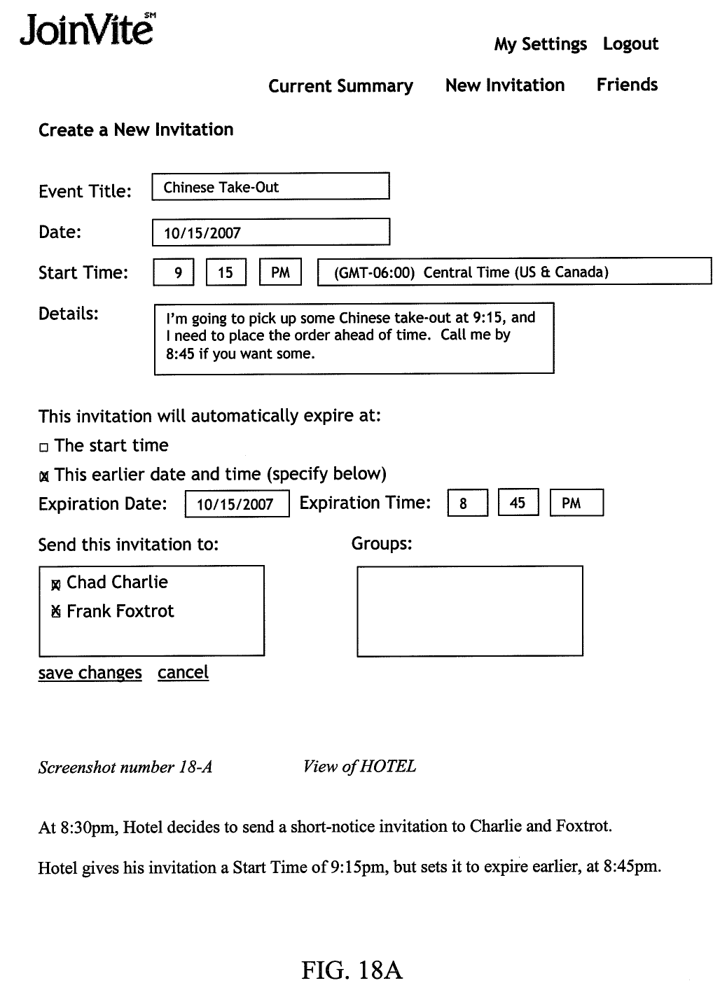

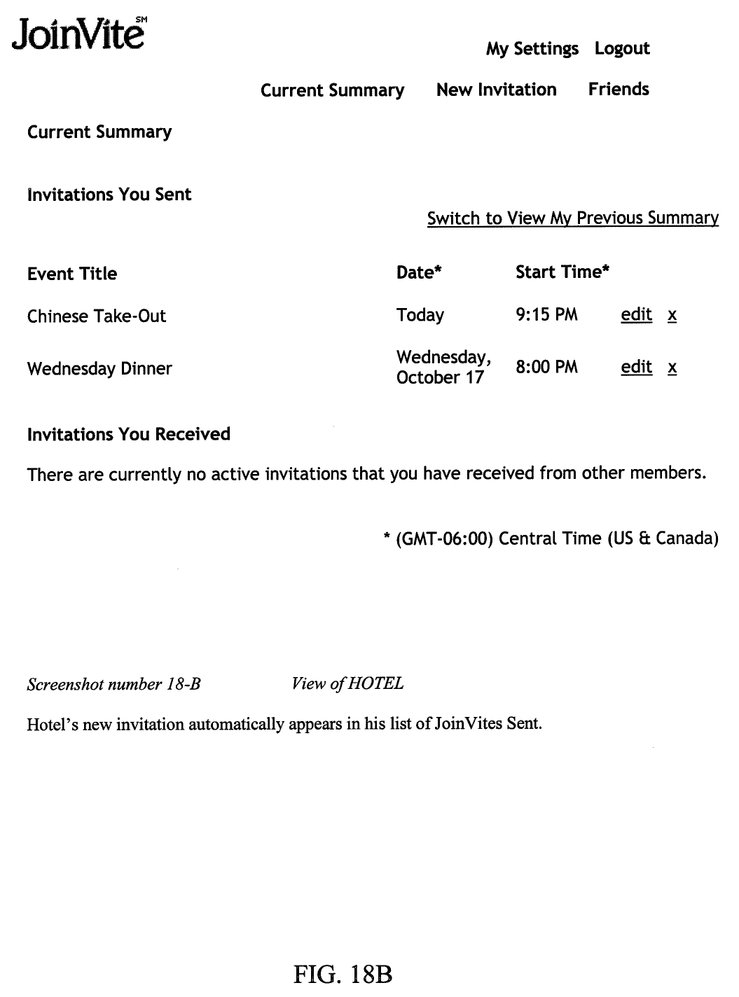

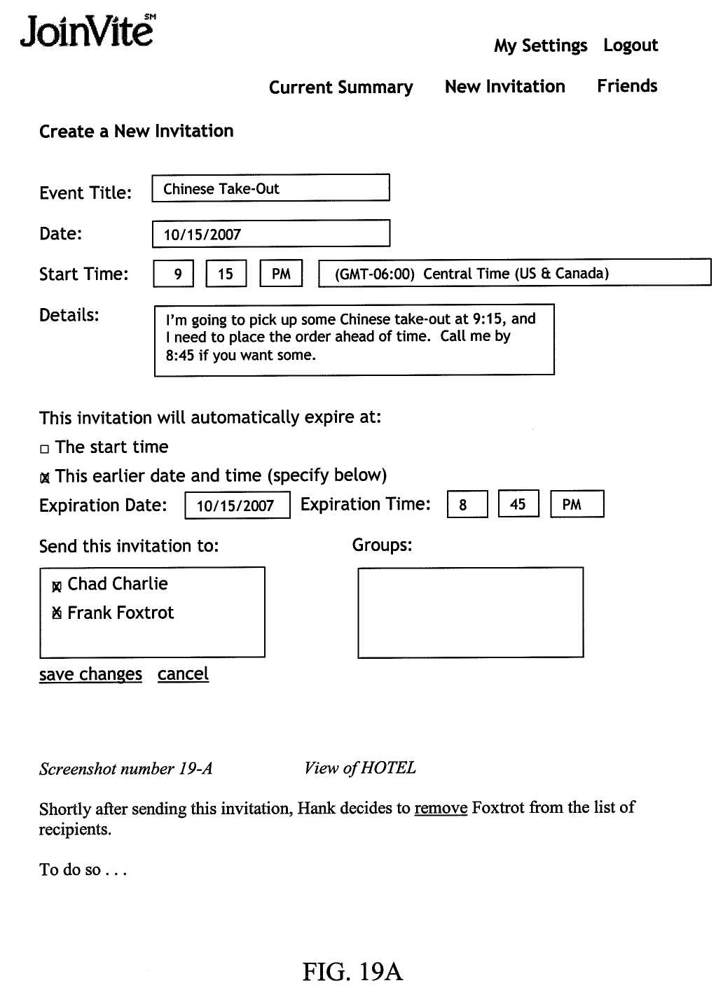

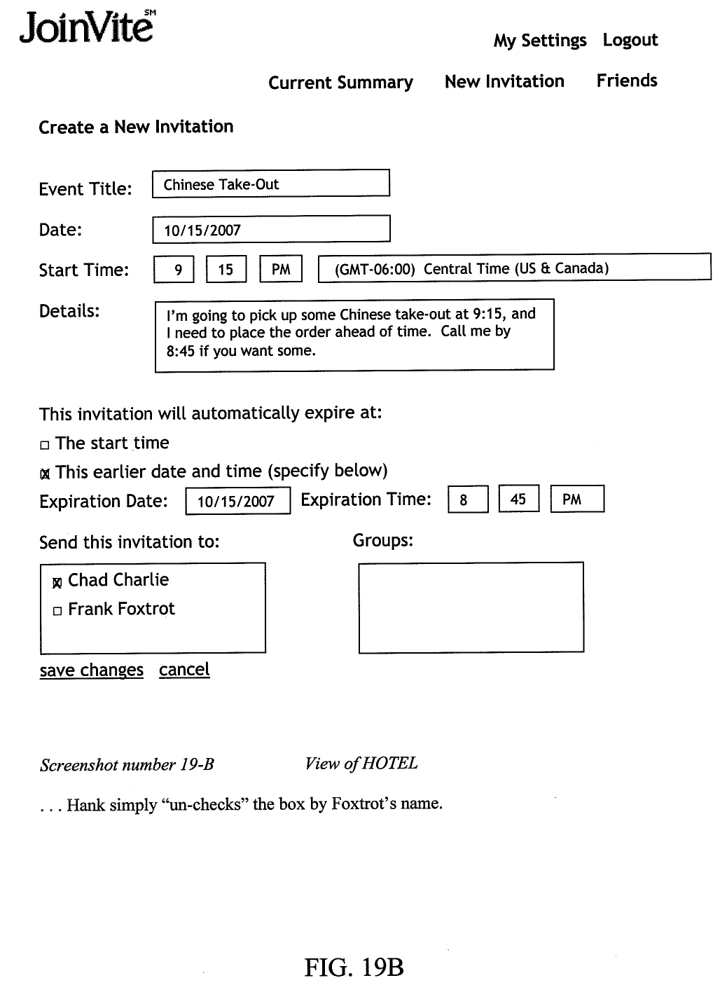

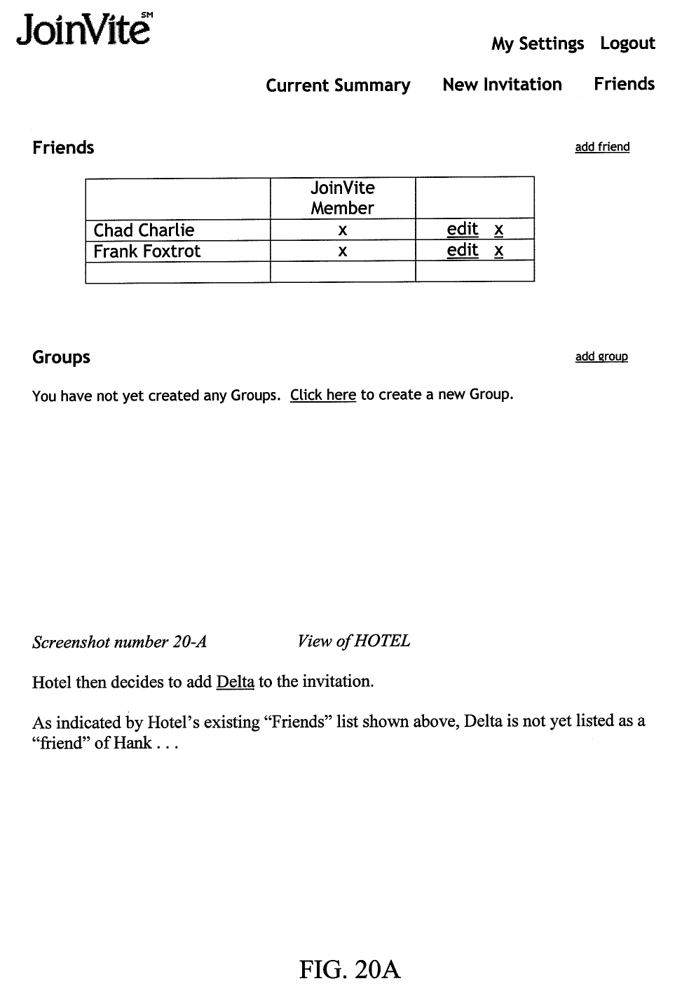

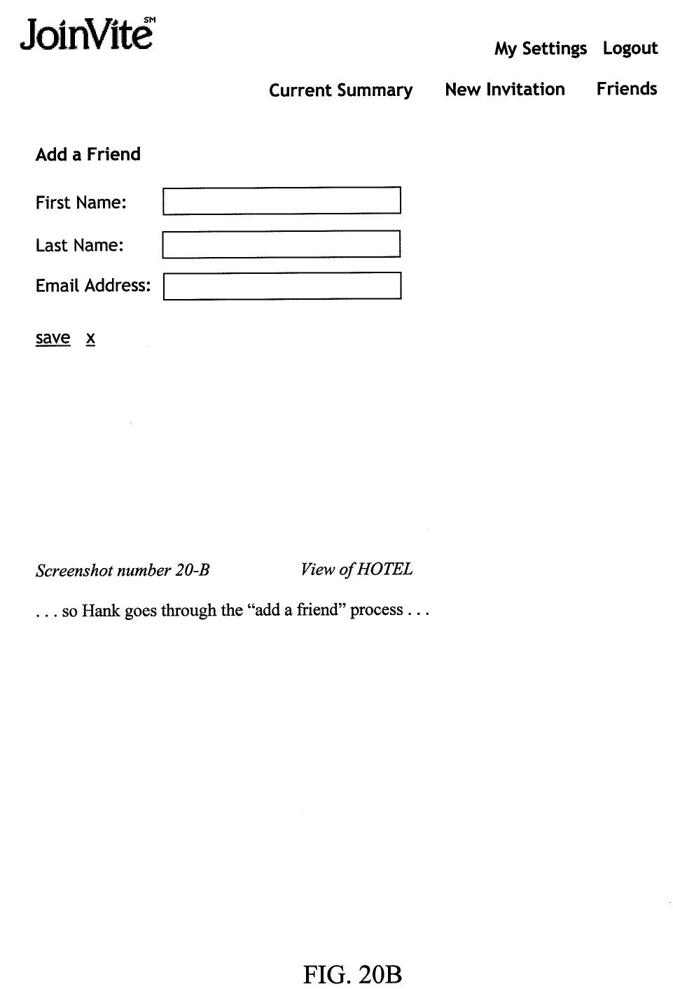

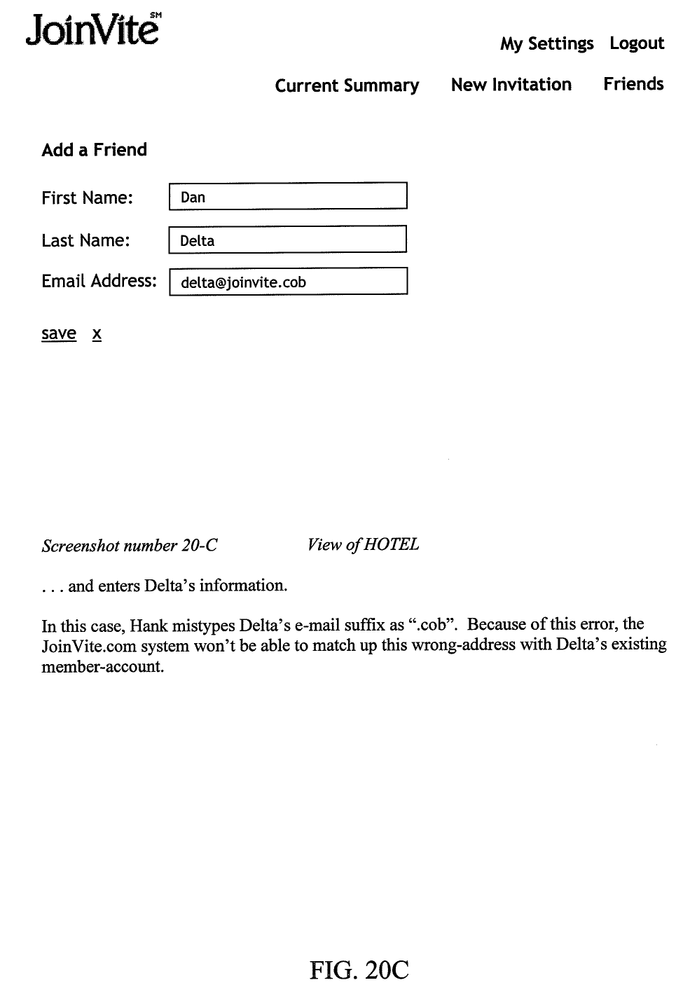

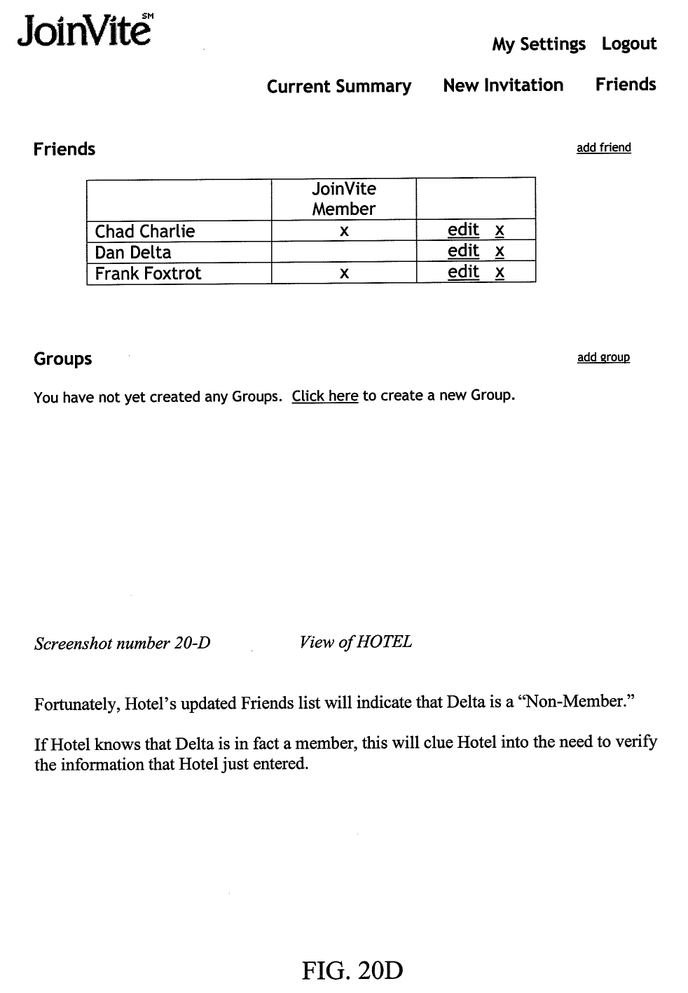

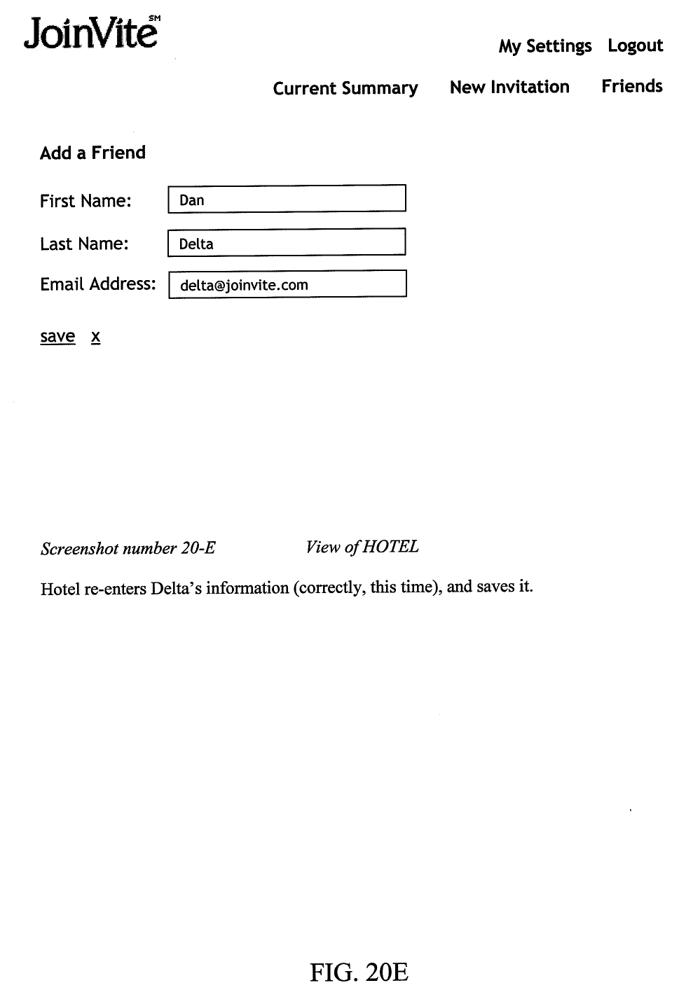

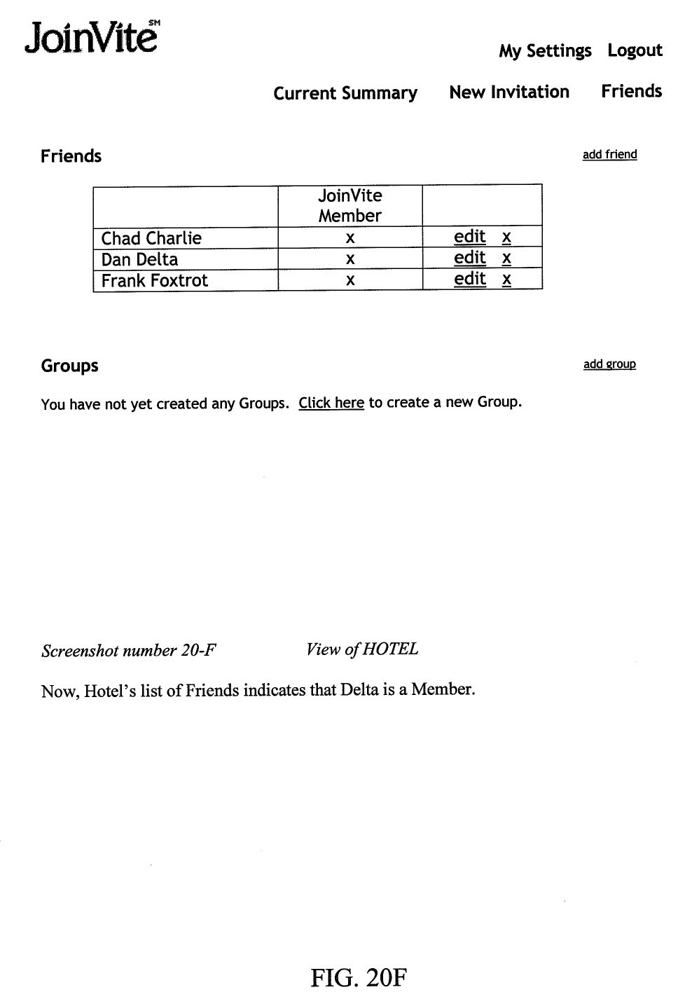

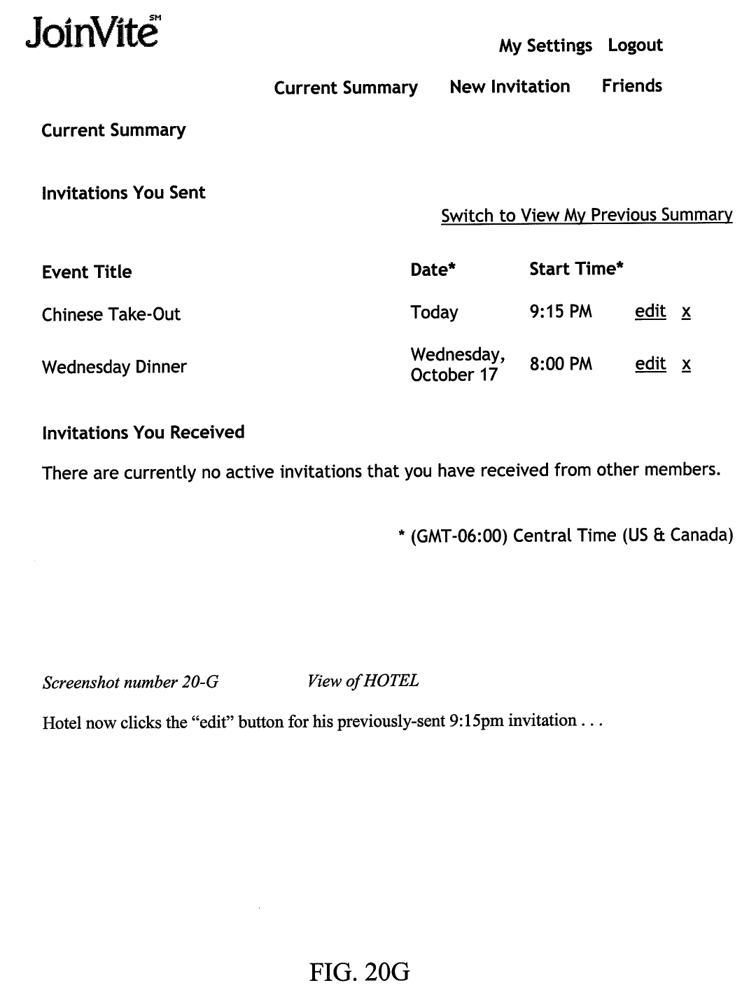

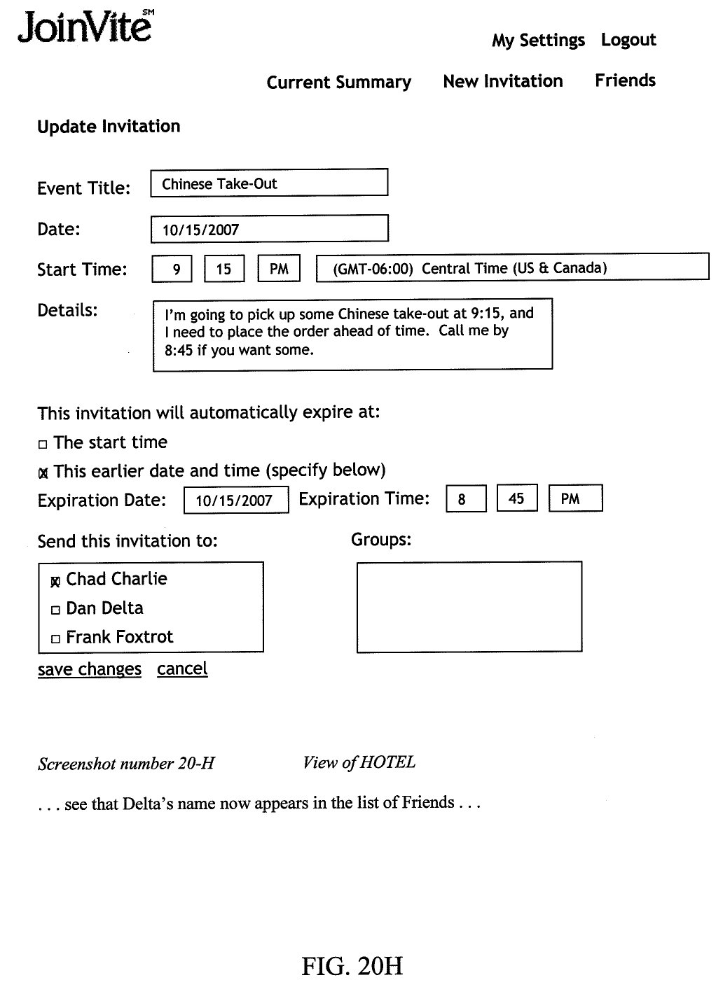

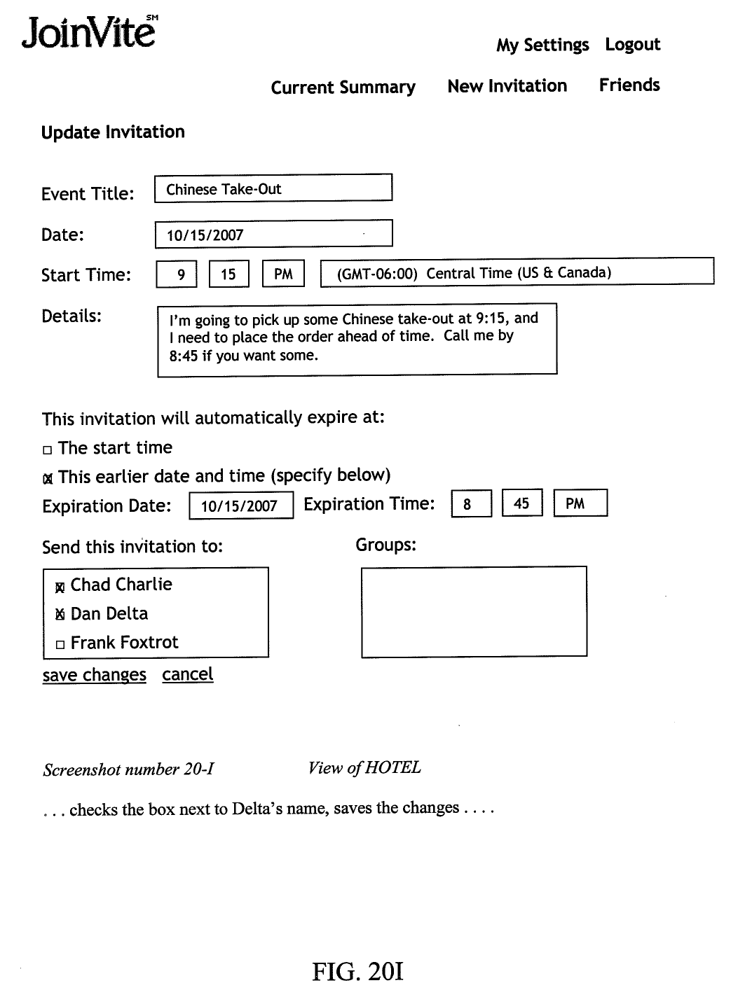

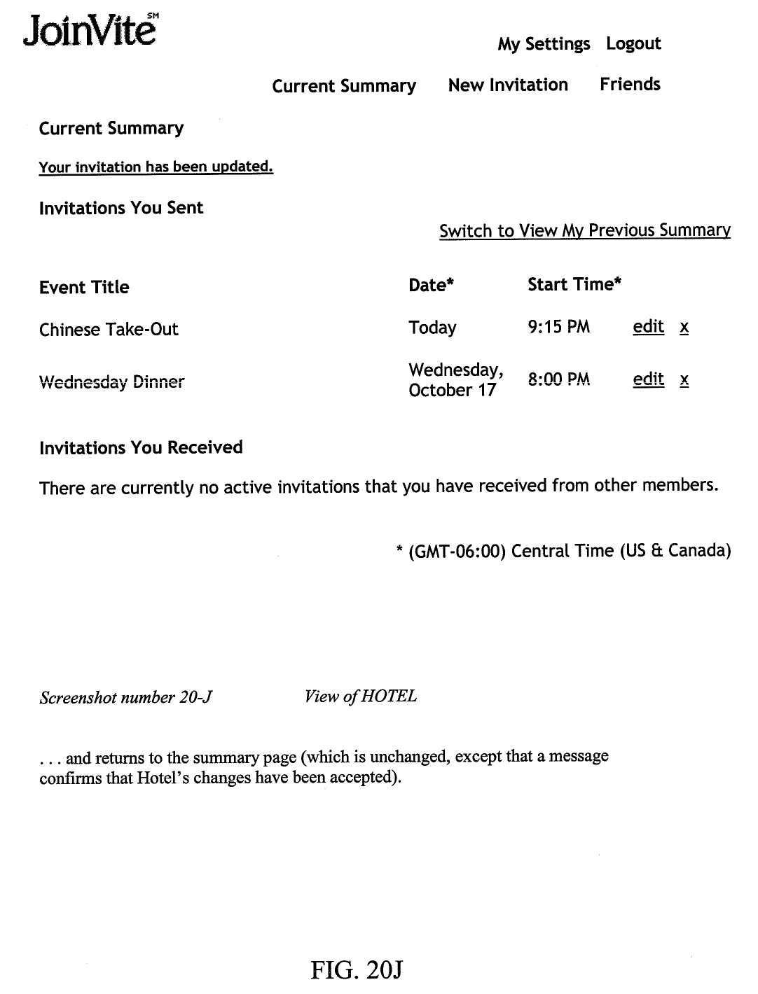

In a specific example of a short-notice invitational message, and referring now to FIGS. 18A and 18B, it will be seen that Hotel, as viewed from his screen display, decides to send his own short-notice invitation to Charlie and Foxtrot at 8:30 pm. Hotel gives his invitation a “Start Time” of 9:15 pm but sets it to expire earlier, at 8:45 pm. Shortly after sending his message, Hotel decides to remove Foxtrot from the list of recipients. See FIGS. 19A and 19B. Hotel then decides to add Delta to the invitation. In reviewing Hotel's “Friends” list, however, Delta is not yet listed as a “friend” of Hotel. See FIG. 20A.

In view of the fact that Delta is not yet listed as a “friend” of Hotel, Hotel initiates the “Add Friend” process. See FIG. 20B. As shown in FIG. 20C, it will be noticed that Hotel mistypes Delta's e-mail address. Because of this error, the JOINVITE® system will not be able to match this incorrect address with Delta's existing JOINVITE® system account information. However, and because of this matching error, Hotel's updated “Friends” list will indicate to Hotel that Delta is a “Non-Member.” See FIG. 20D. If Hotel knows that Delta is a member, this “Non-Member” indication will alert Hotel of the need to double-check the information that Hotel just entered. Hotel then re-enters Delta's information correctly and saves it. See FIG. 20E. Hotel's list of “Friends” now indicates that Delta is a “Member.” See FIG. 20F. Now that this correction has been made, Hotel can click the “edit” button for his previously sent 9:15 pm invitation as shown in FIG. 20G and sees, in FIG. 20H, that Delta's name now appears in the “Friends” list. FIG. 20I shows that Hotel can now check the box next to Delta's name and save the changes and now also return to the “Current Summary” page which confirms that Hotel's changes have been accepted. See FIG. 20J.

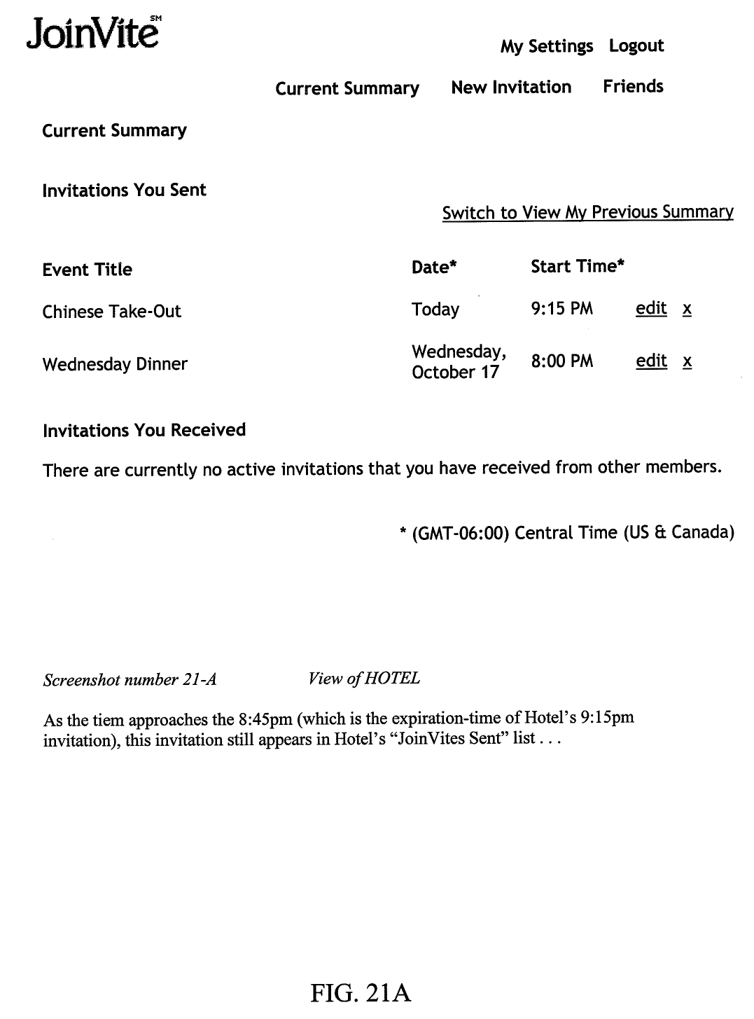

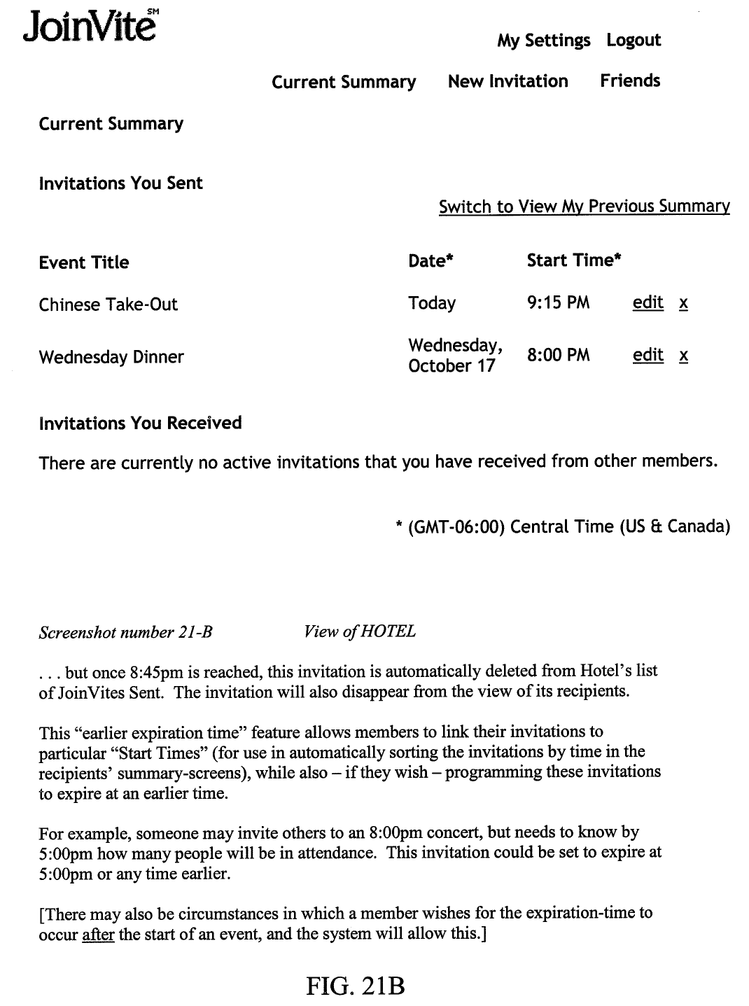

As this scenario continues to be followed, it will be seen in FIG. 21A that, as the time approaches 8:45 pm, which is the expiration time of Hotel's 9:15 pm invitation, that invitation still appears in Hotel's “Sent” list. Once 8:45 pm is reached, however, this invitation is automatically deleted from Hotel's list of sent messages. See FIG. 21B. This invitation will also disappear from the view of its recipients. It should also be noted here that this “earlier expiration time” feature allows members to link their JOINVITE® system invitational messages to particular “Start Times” for use in automatically sorting the invitations by time in the recipients' summary screens, while also—if they wish—programming these invitations to expire at an earlier time. For example, someone may invite others to an 8:00 pm concert, but needs to know by 5:00 pm how many people will be in attendance. This invitation could be set to expire at 5:00 pm or any time earlier. Similarly, there may be circumstances in which a member wishes for the expiration time to occur after the start of an event. The JOINVITE® system will allow this.

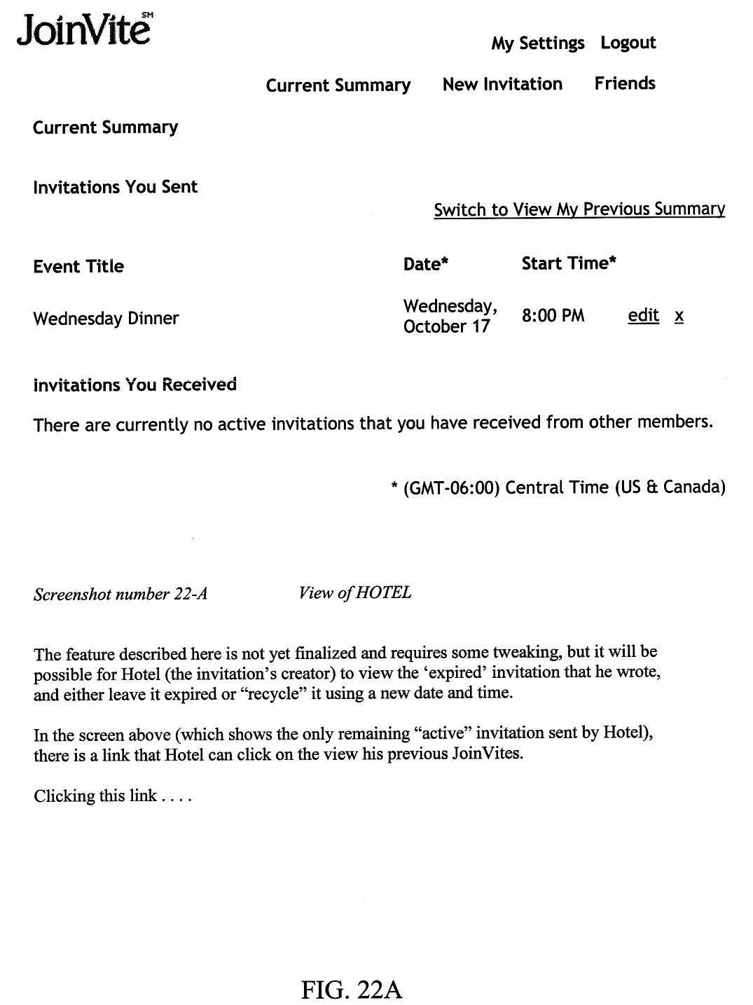

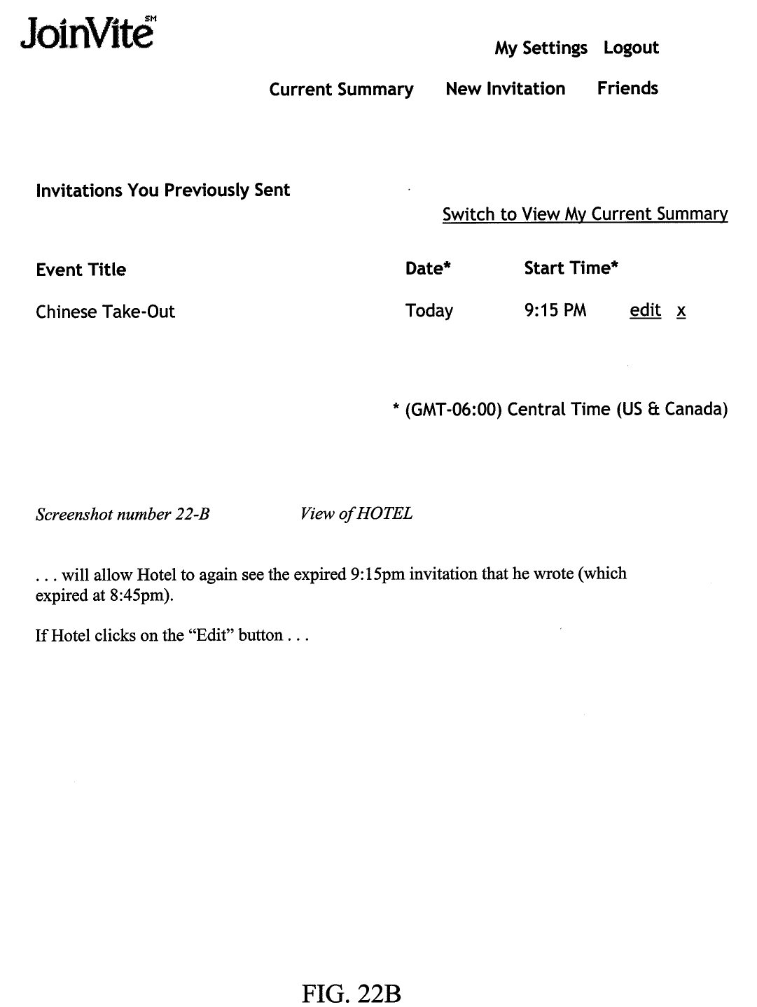

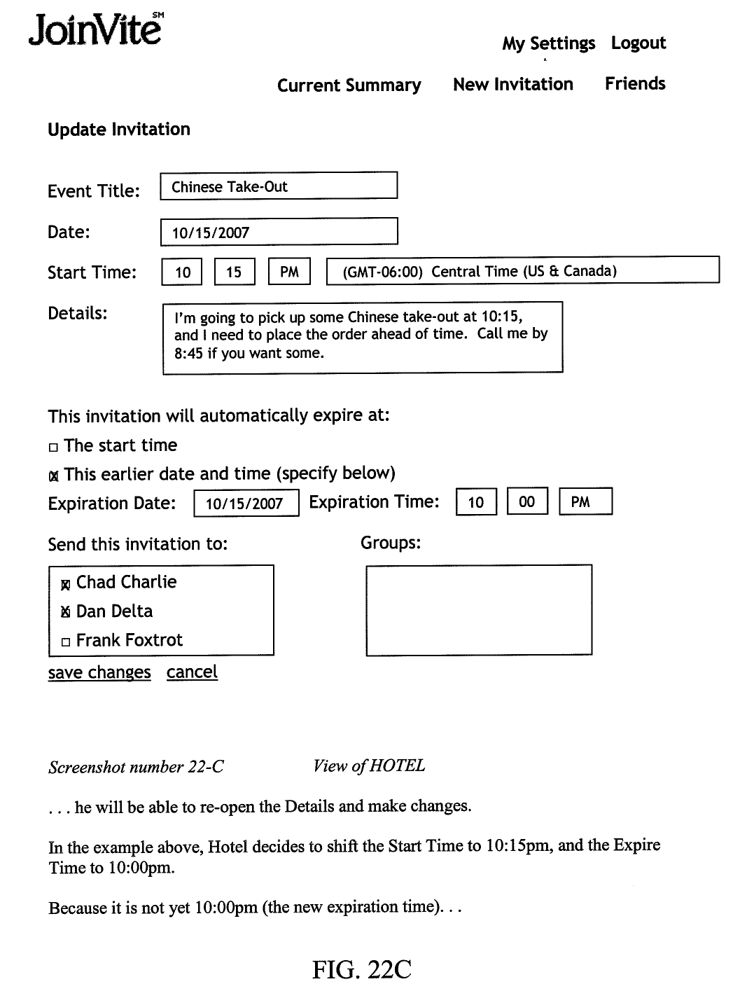

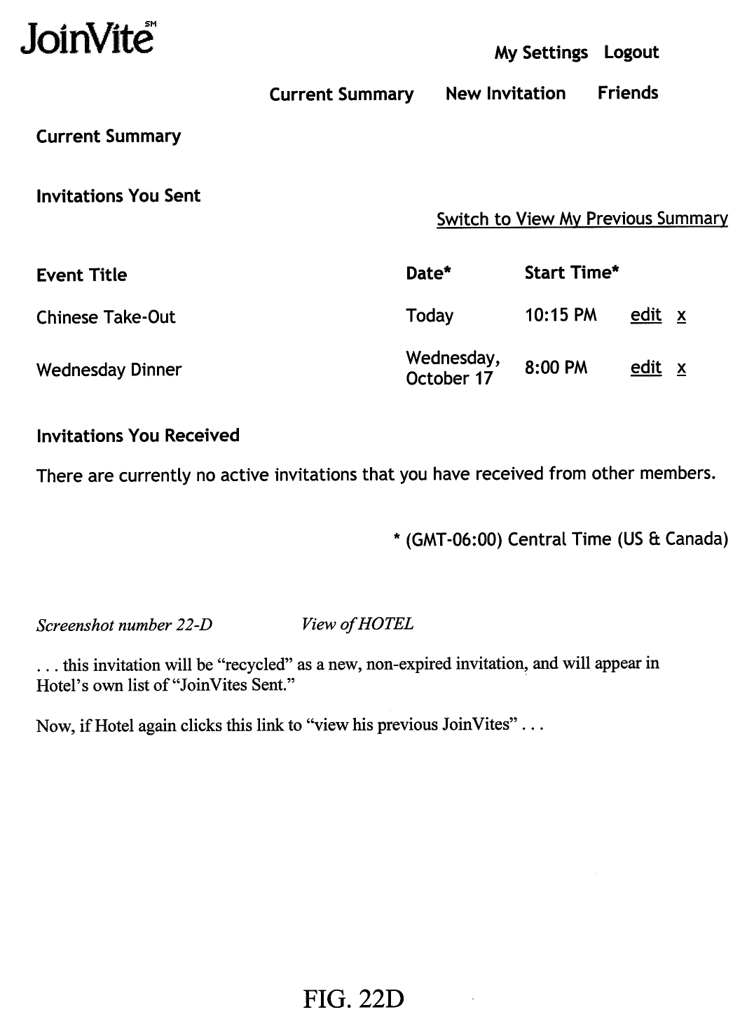

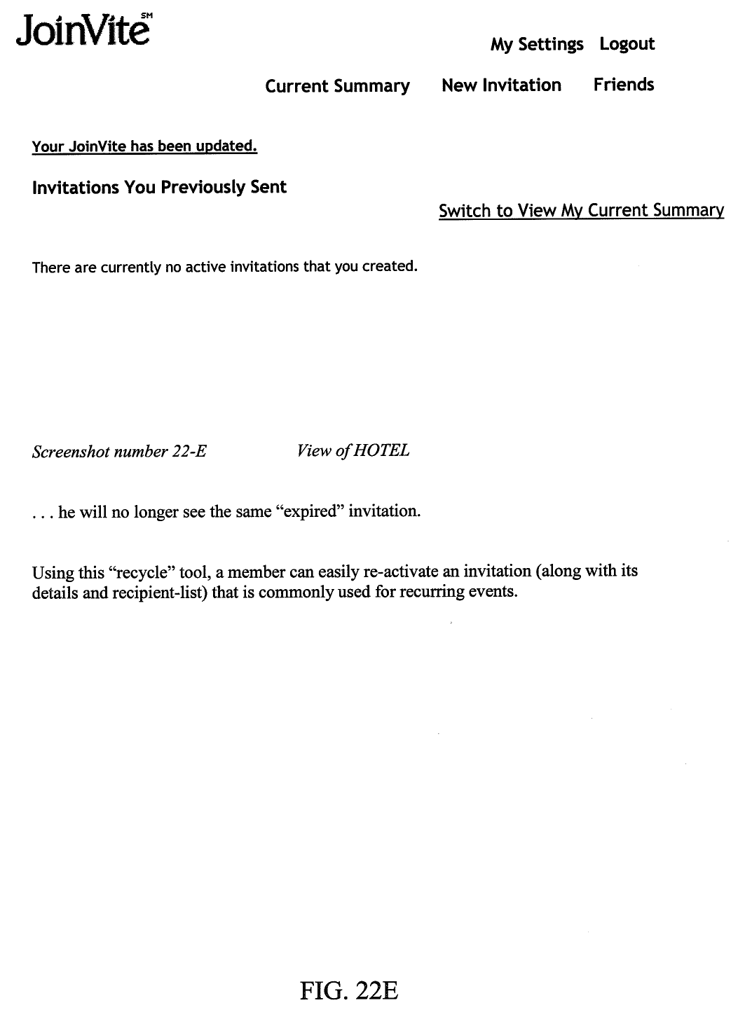

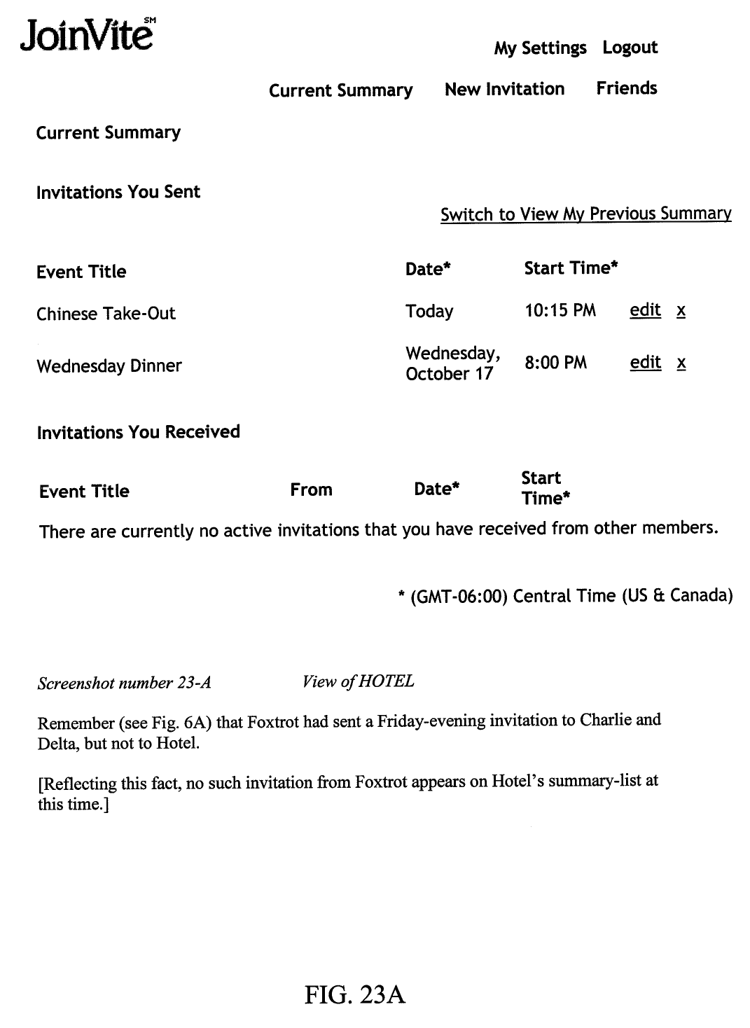

Referring now to FIG. 22A, it will be seen that it is possible for Hotel, or any other message creator, to view the expired invitation that he wrote and either leave it expired or “recycle” it using a new date and time. This functionality is provided by means of a link to view previous messages, which will allow Hotel, in this example, to again see the invitation that he wrote, but which already expired. See FIG. 22B. By clicking on the “edit” button, Hotel will be able to re-open the details and make changes. See FIG. 22C. In the example used here, suppose that Hotel's planned trip to the Chinese restaurant was postponed for some reason. He now decides to shift the “Start Time” to 10:15 pm and the “Expire Time” to 10:00 pm. Because it is not yet 10:15 pm, the new expiration time, this invitation will be re-cycled as a new, non-expired invitation and will appear in Hotel's own list of sent messages. See FIG. 22D. If Hotel again clicks this link to view his previous messages, he will no longer see the same “expired” invitation. See FIG. 22E. This is because the invitation is now “active” again. Using this “recycle” tool of the JOINVITE® system, a member can easily re-activate an invitation, along with its details and recipient list, which is commonly used for recurring events.

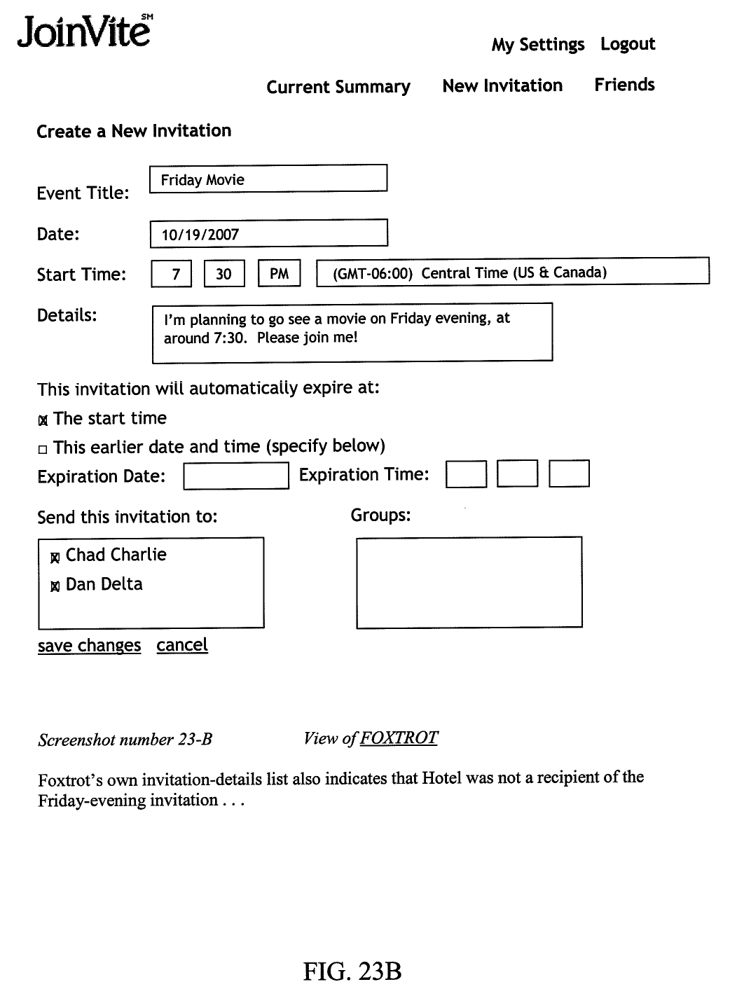

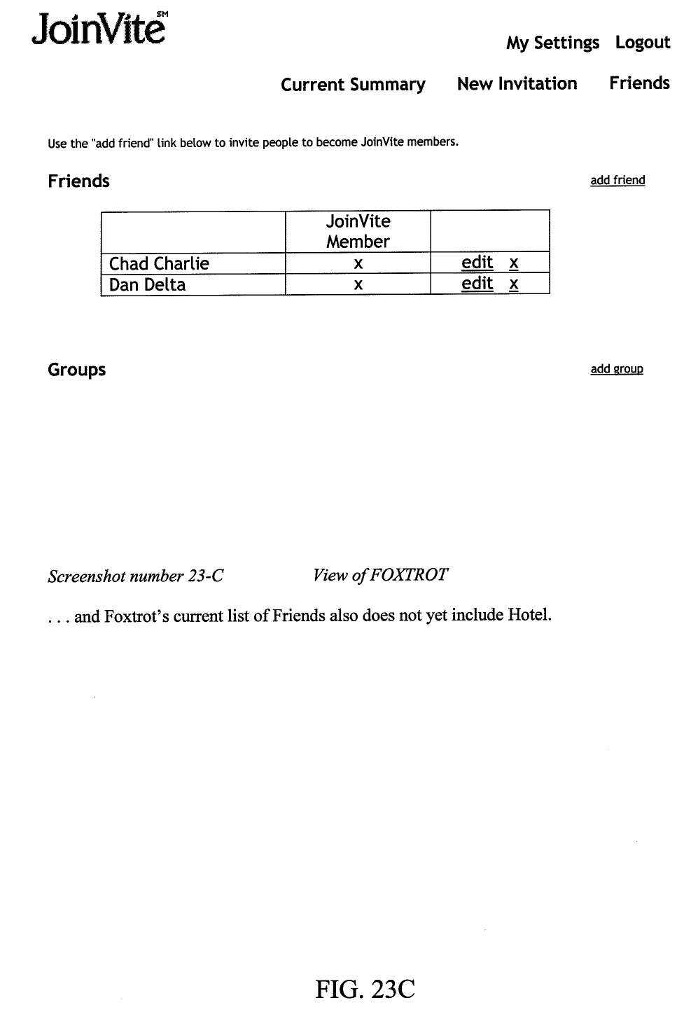

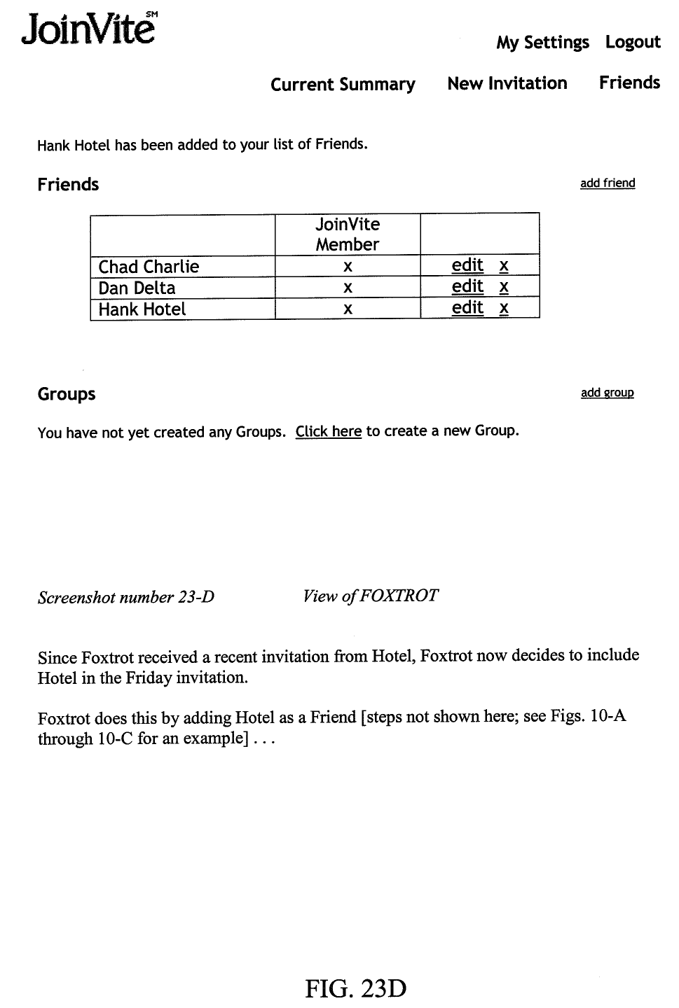

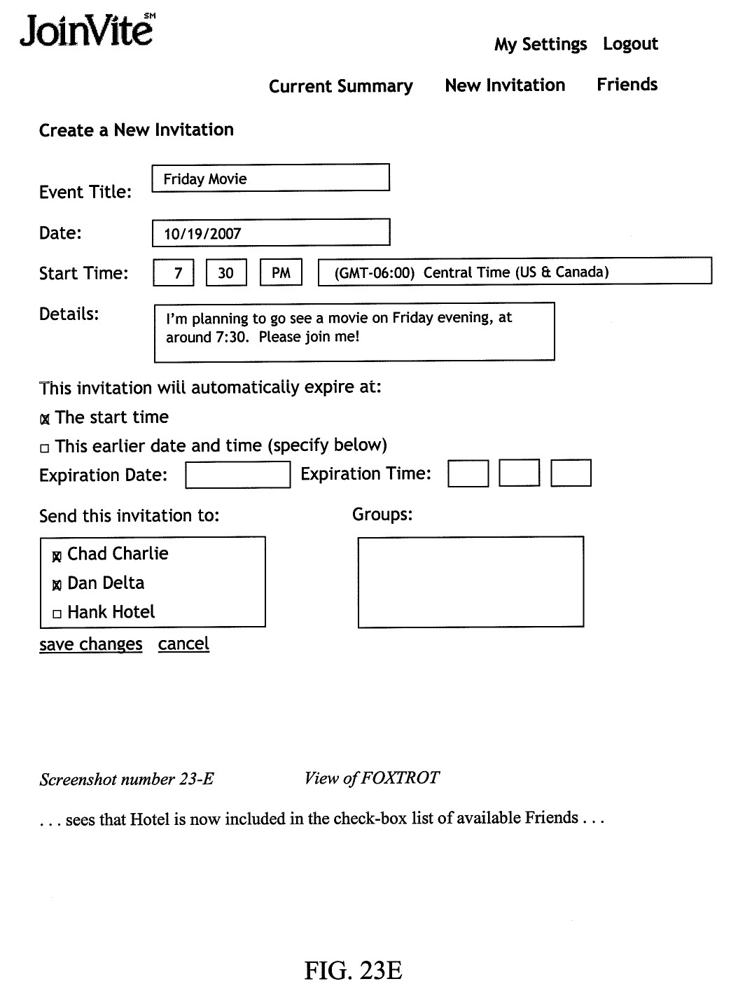

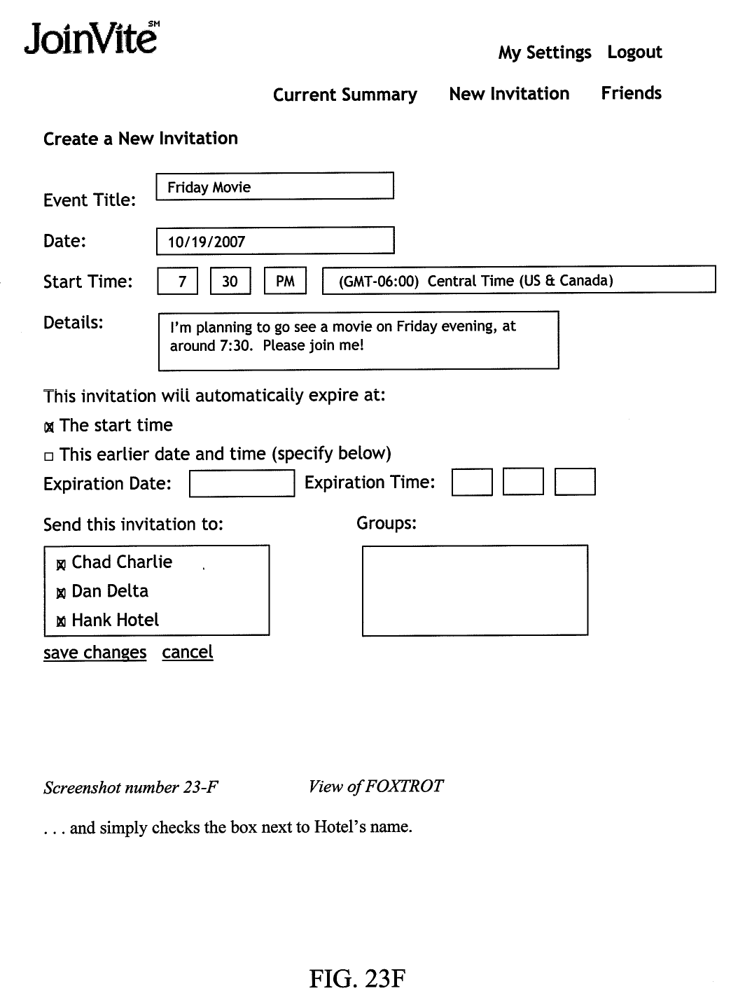

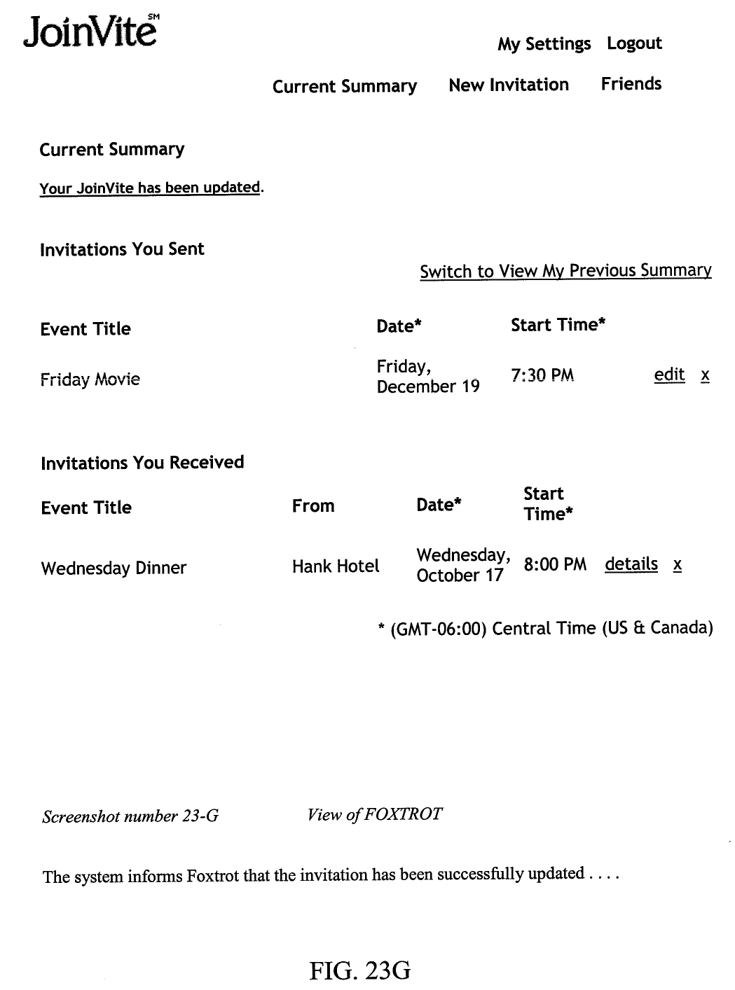

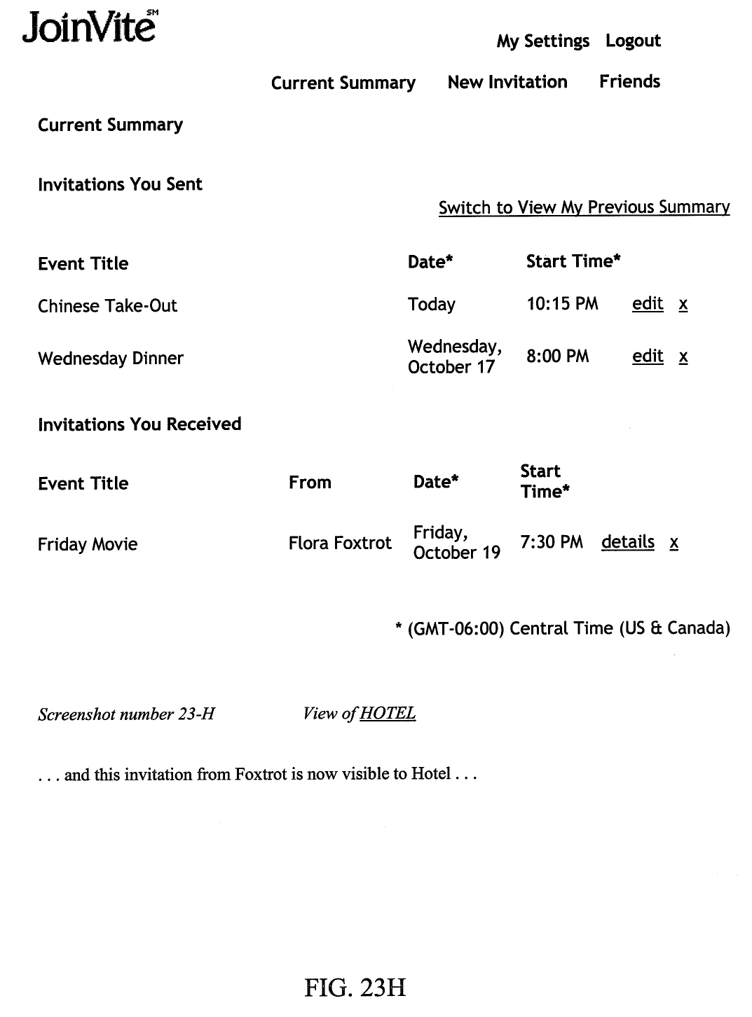

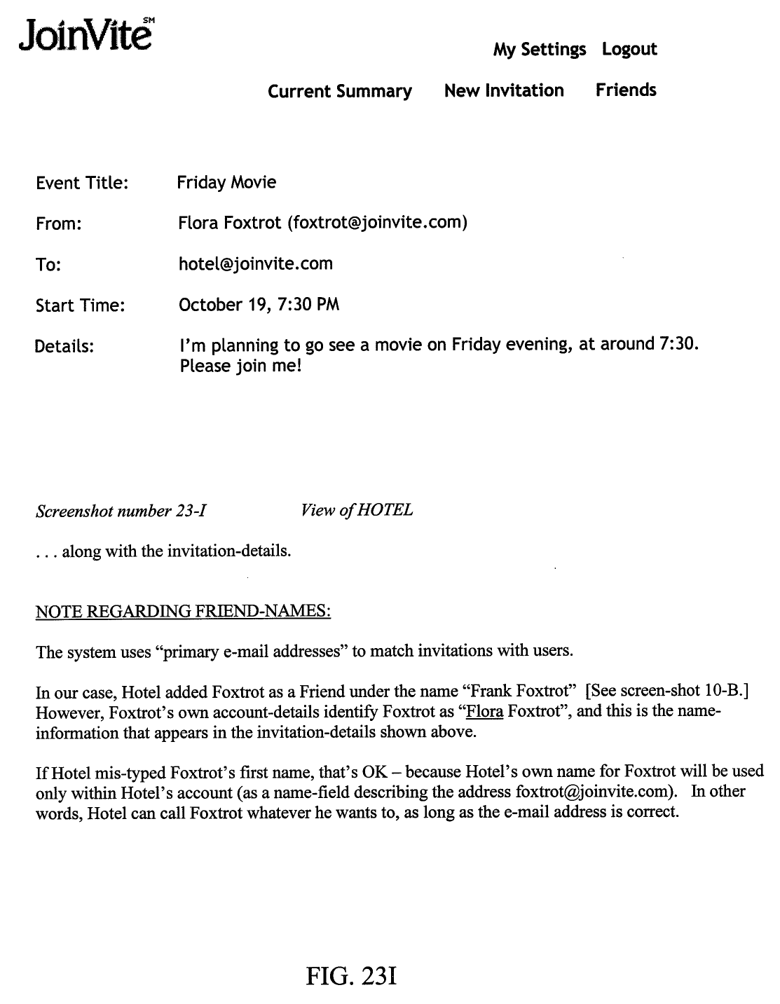

Returning to the Friday evening invitation that Foxtrot sent to Charlie and Delta, but not to Hotel, we see in FIG. 23A that no invitation exists in Hotel's screen display of “received” messages. Indeed, Foxtrot's own invitation details list, as shown in FIG. 23B, does not show Hotel to be a recipient and Foxtrot's current list of “Friends” does not include Hotel. See FIG. 23C. But since Foxtrot received a recent invitation from Hotel, Foxtrot now decides to include Hotel in the Friday invitation. See FIG. 23D. Foxtrot can add Hotel as a “Friend” in accordance with previously-discussed FIGS. 10A through 10C. Once added, Hotel will be shown as a “Friend” as illustrated in FIG. 23E. By Foxtrot's checking the box next to Hotel's name, as shown in FIG. 23F, the updated, as shown in FIG. 23G, and this invitation is now visible to Hotel along with its details. See FIGS. 23H and I.

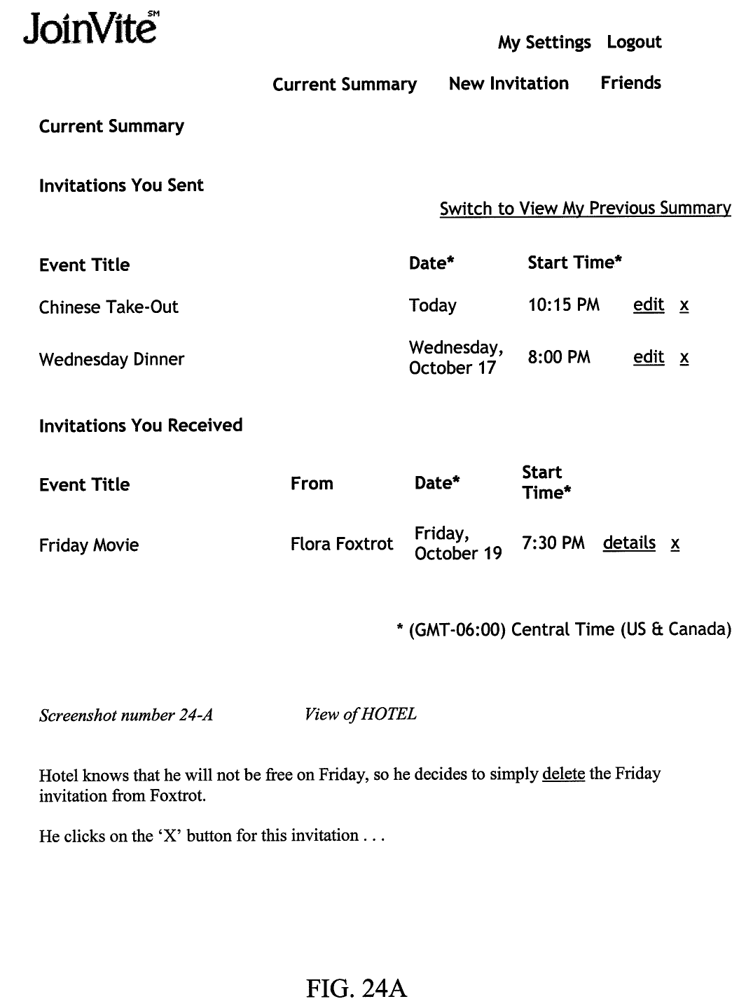

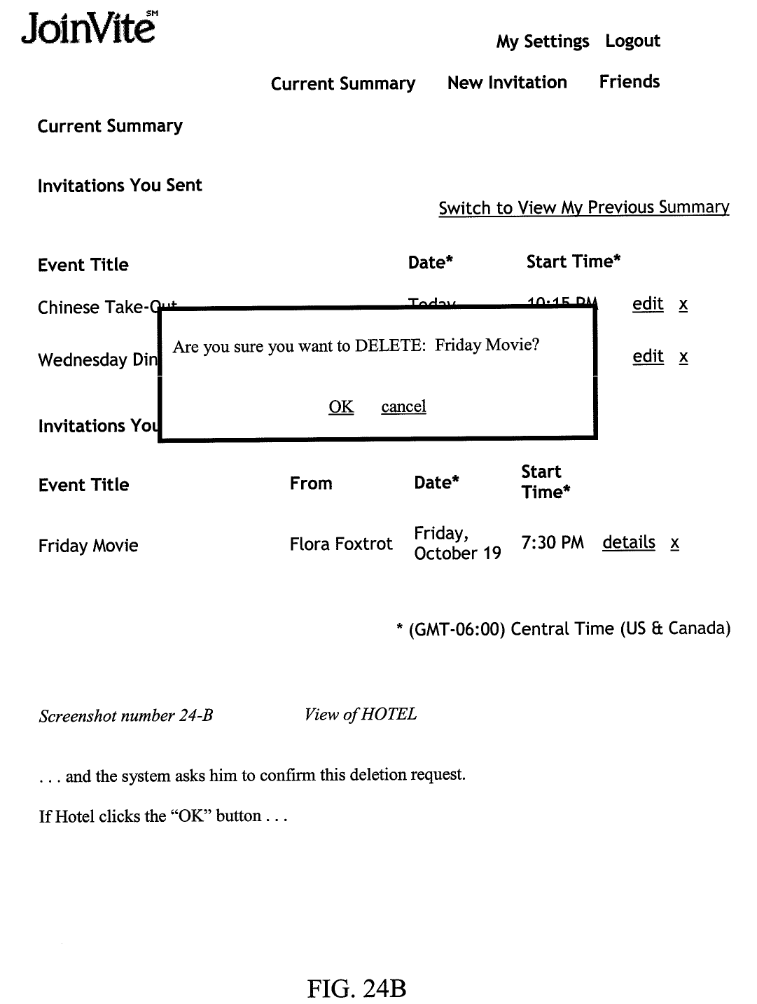

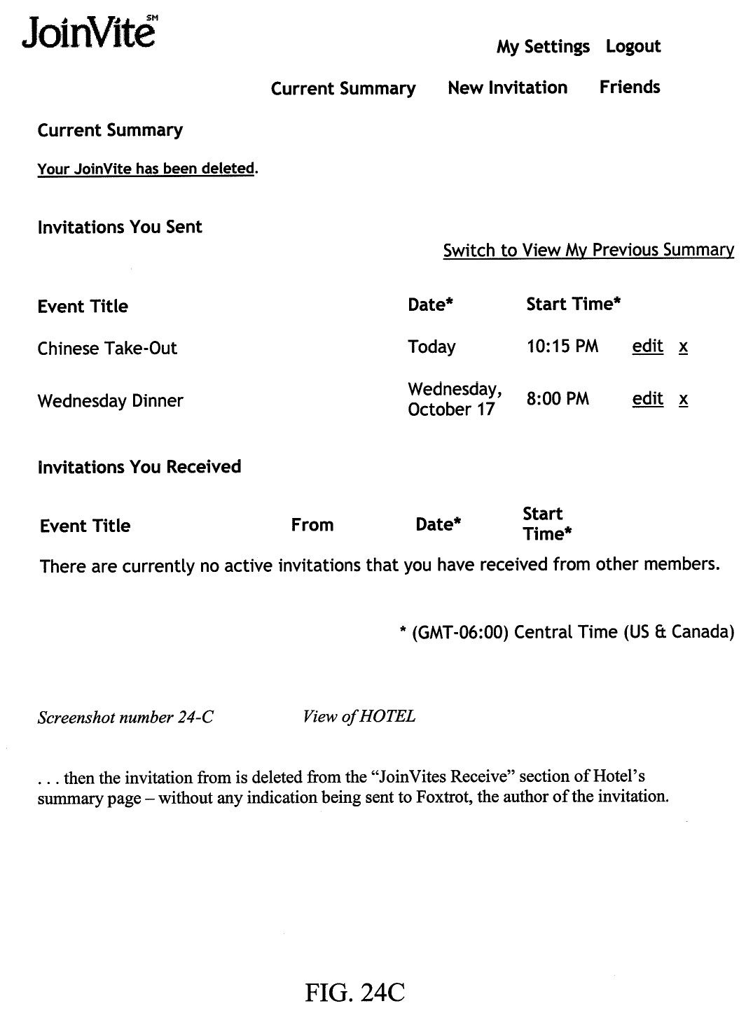

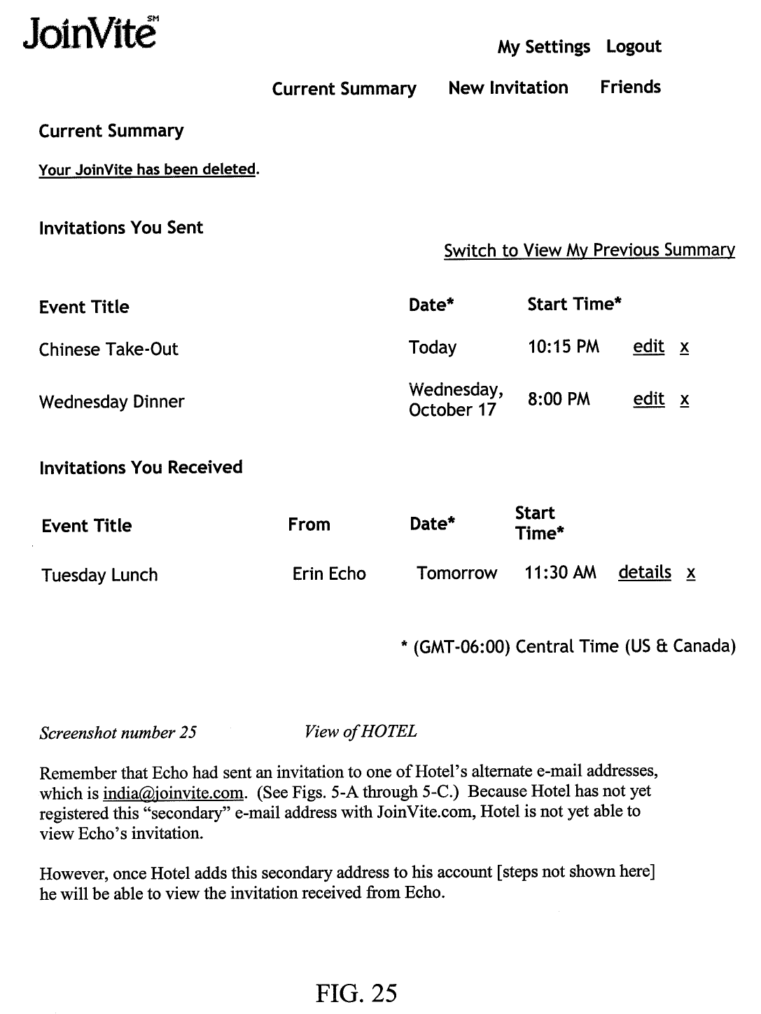

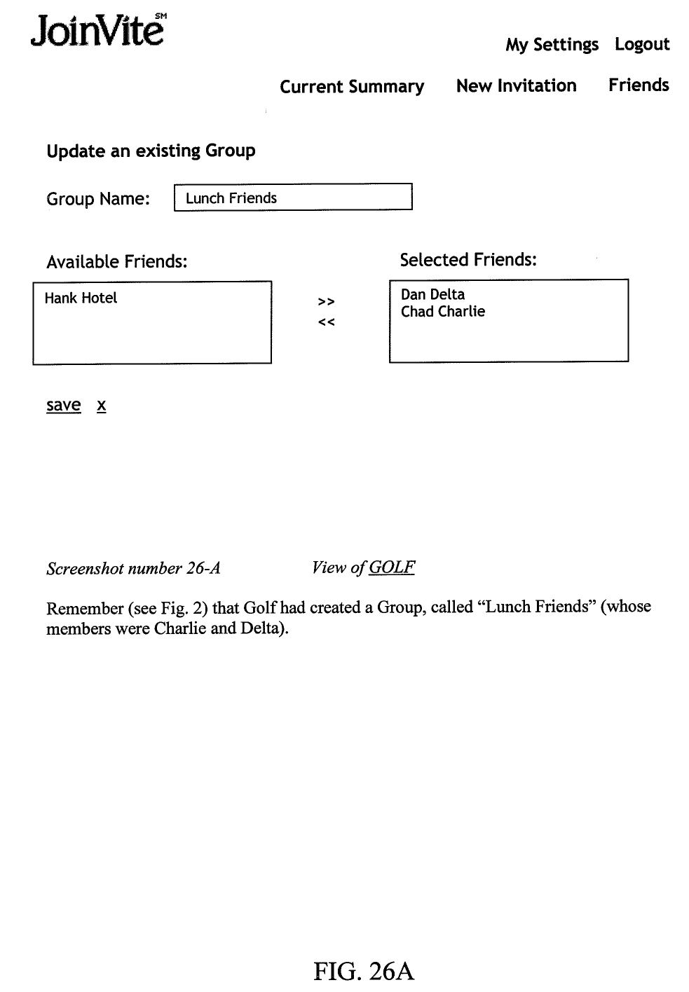

In this scenario, Hotel already knows that he will not be available on Friday. In order to “tidy up” his summary screen display, Hotel decides to delete the is Friday invitation from Foxtrot by “clicking” on the “X” button for this invitation as shown in FIG. 24A. The JOINVITE® system will ask Hotel to confirm his deletion request as shown in FIG. 24B. If Hotel clicks the “OK” button as shown in FIG. 24B, then the invitation is deleted from Hotel's summary page. See FIG. 24C. Foxtrot will not be aware of this deletion.

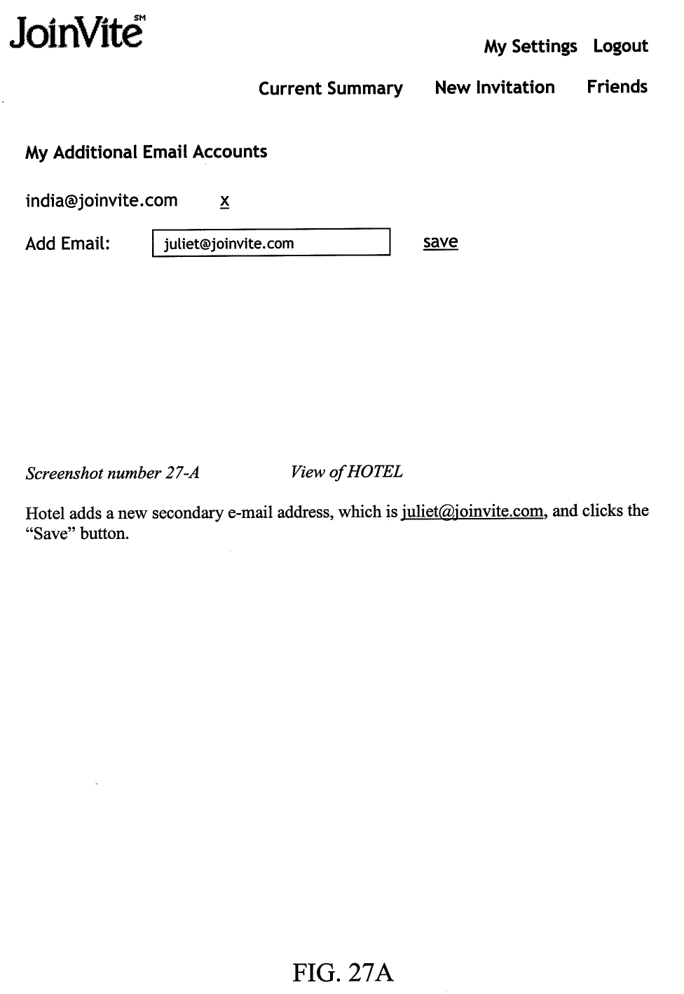

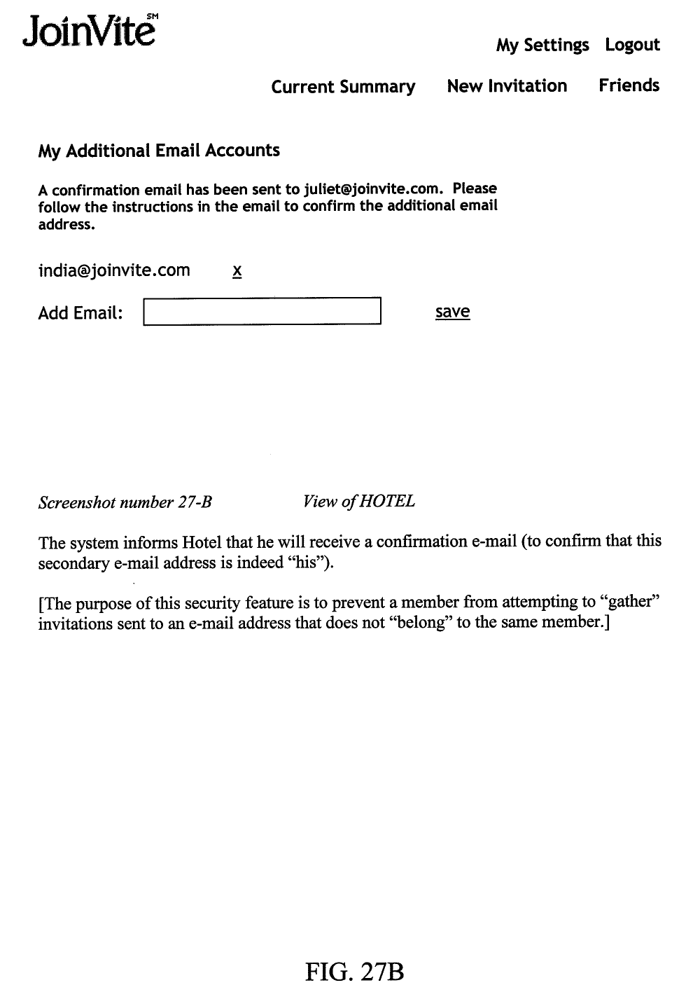

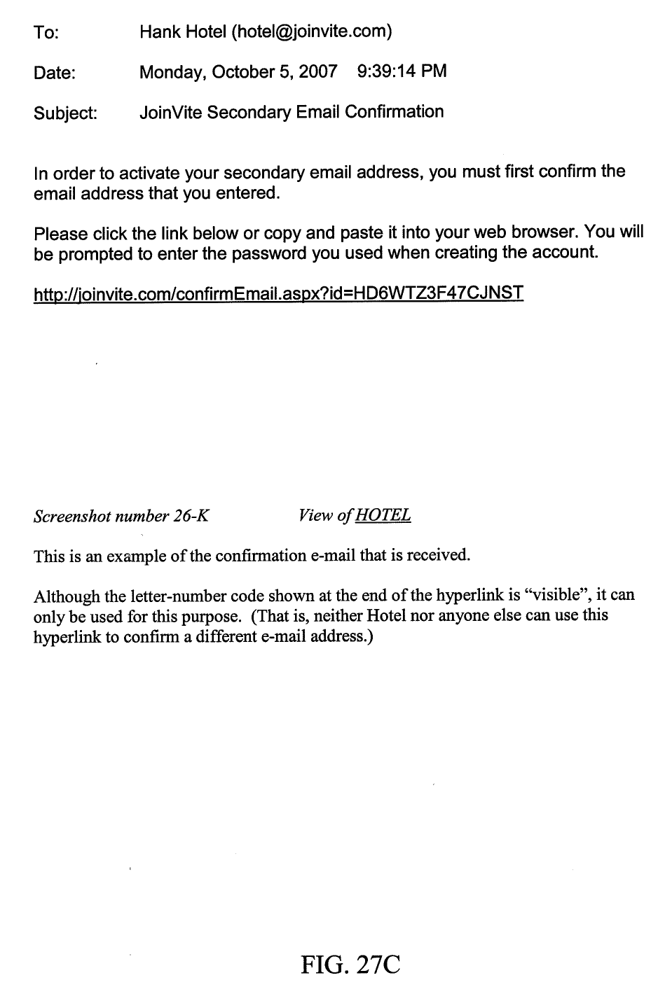

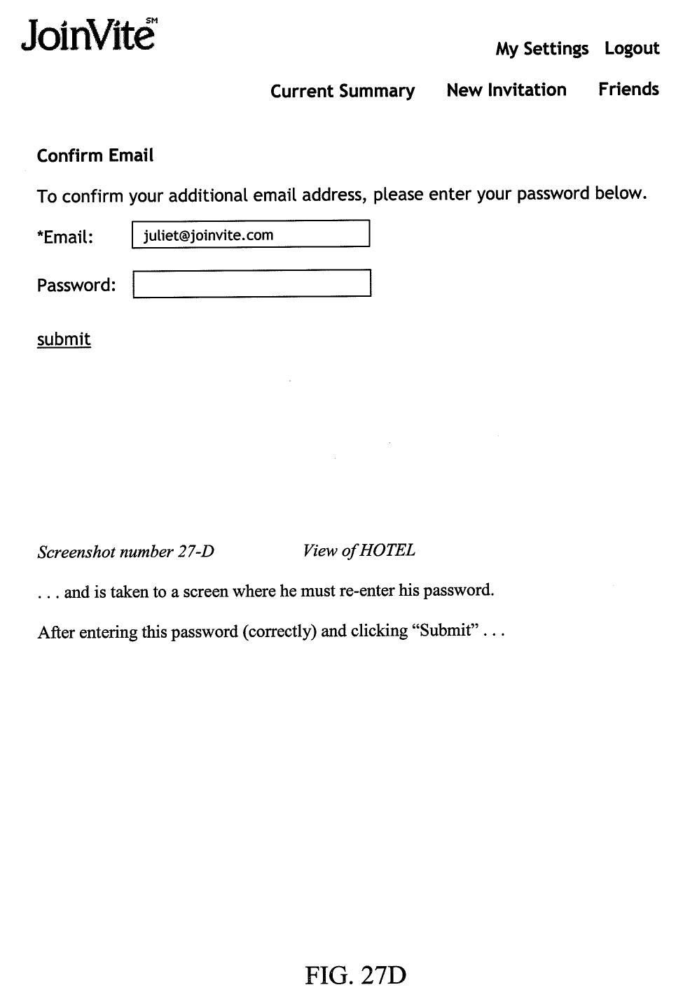

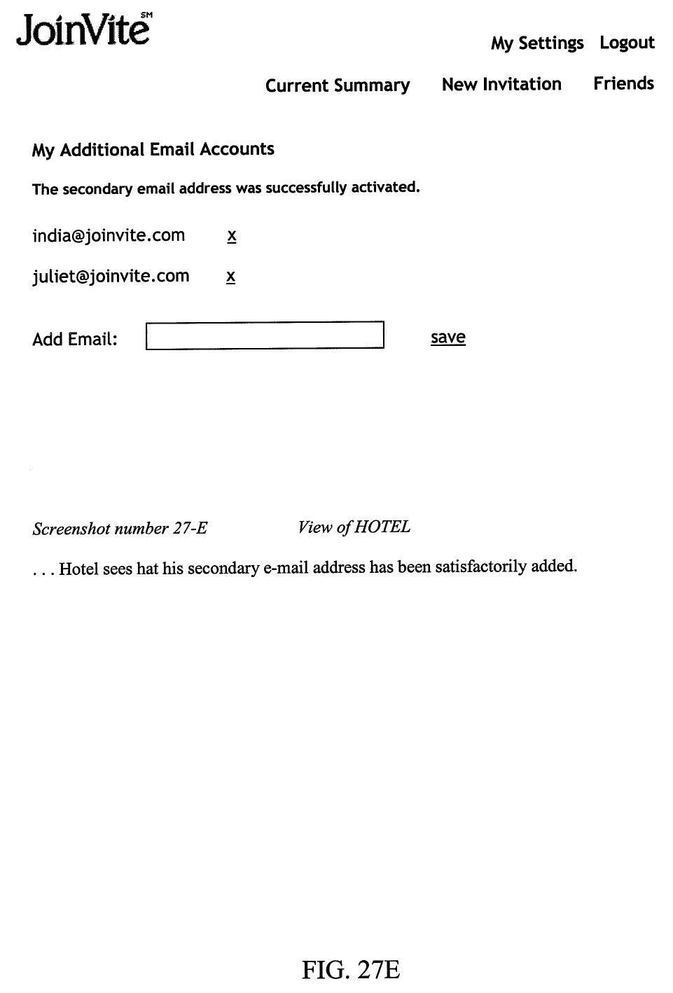

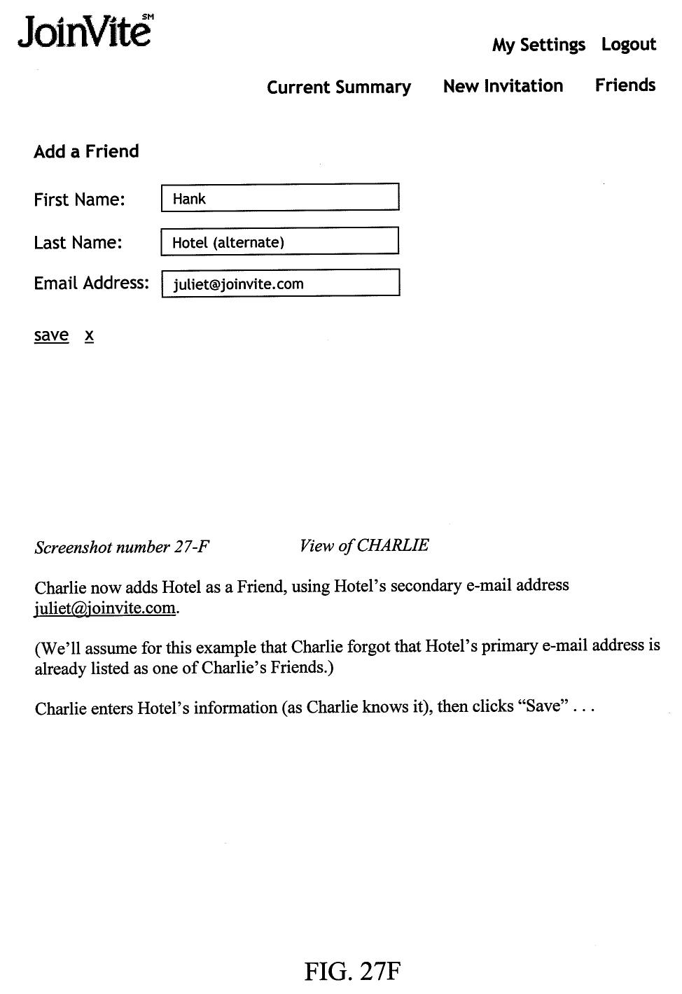

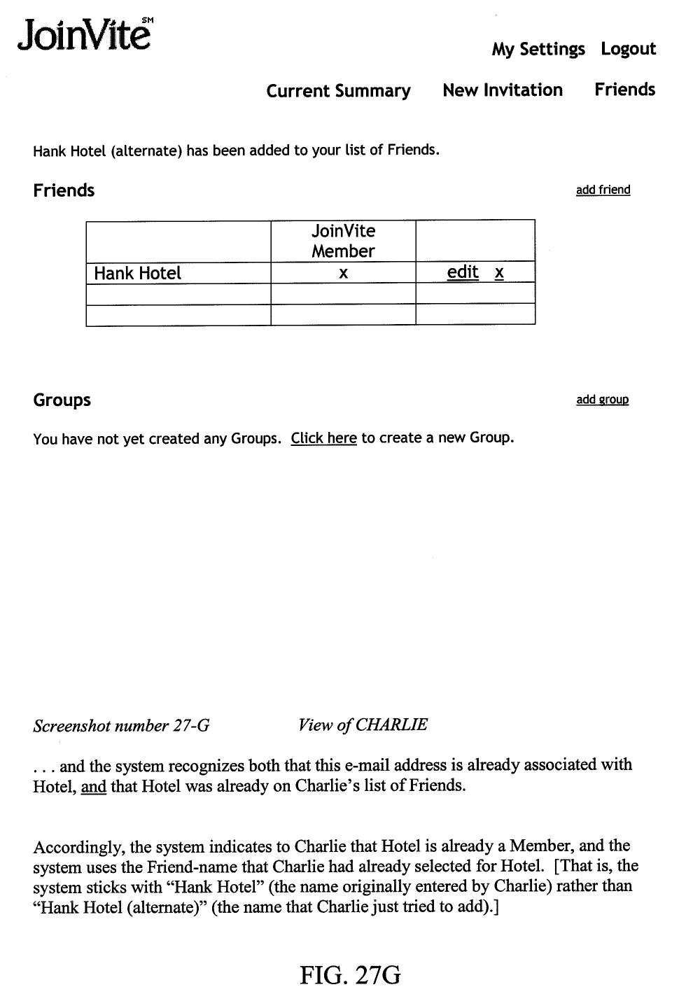

Recall that earlier, in FIGS. 5A through 5C, that Echo had sent an invitation to one of Hotel's alternate e-mail addresses. Because Hotel has not yet registered this “secondary” e-mail address in the JOINVITE® system, Hotel is not yet able to view Echo's invitation. However, once Hotel adds this secondary address to his account, he will be able to view the invitation received from Echo. This will become apparent during later discussion relative to FIGS. 27A-27E. See FIG. 25.

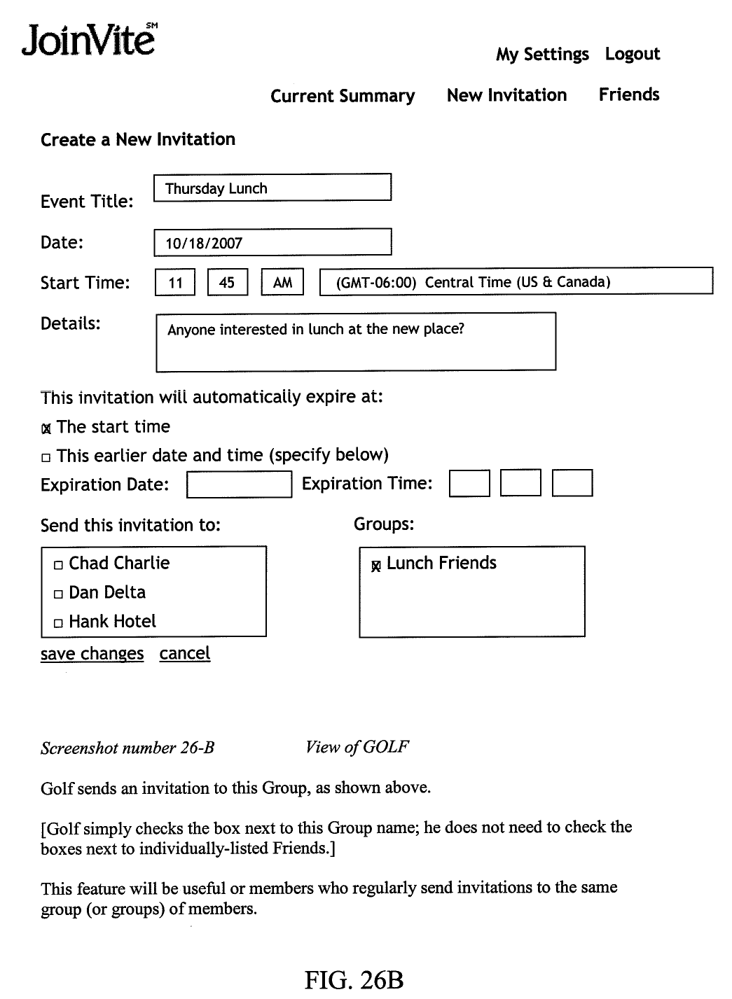

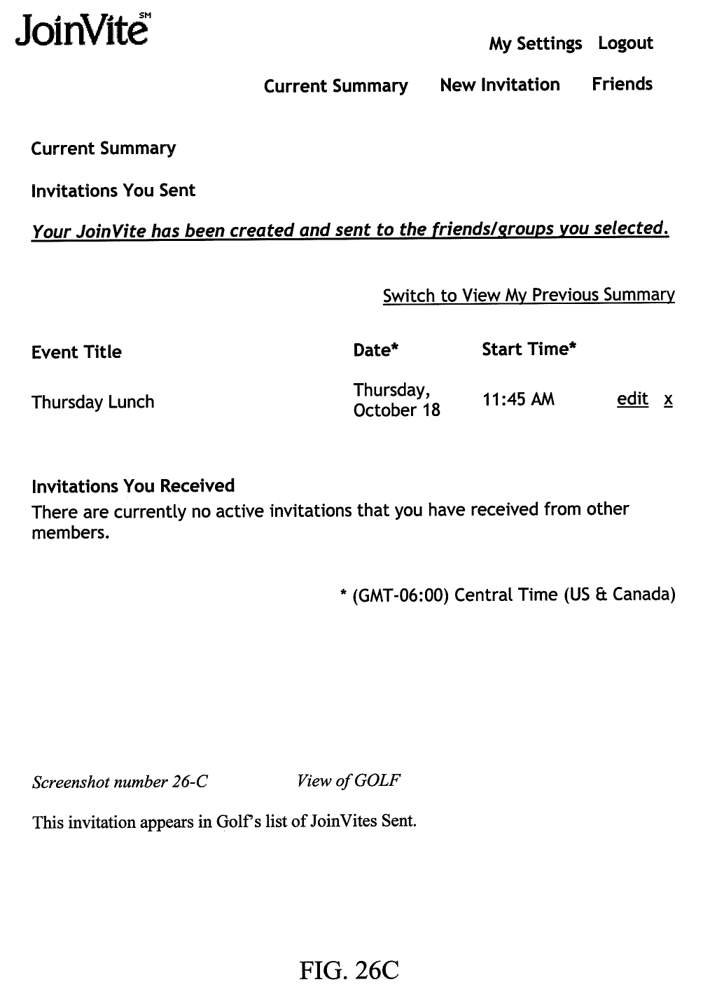

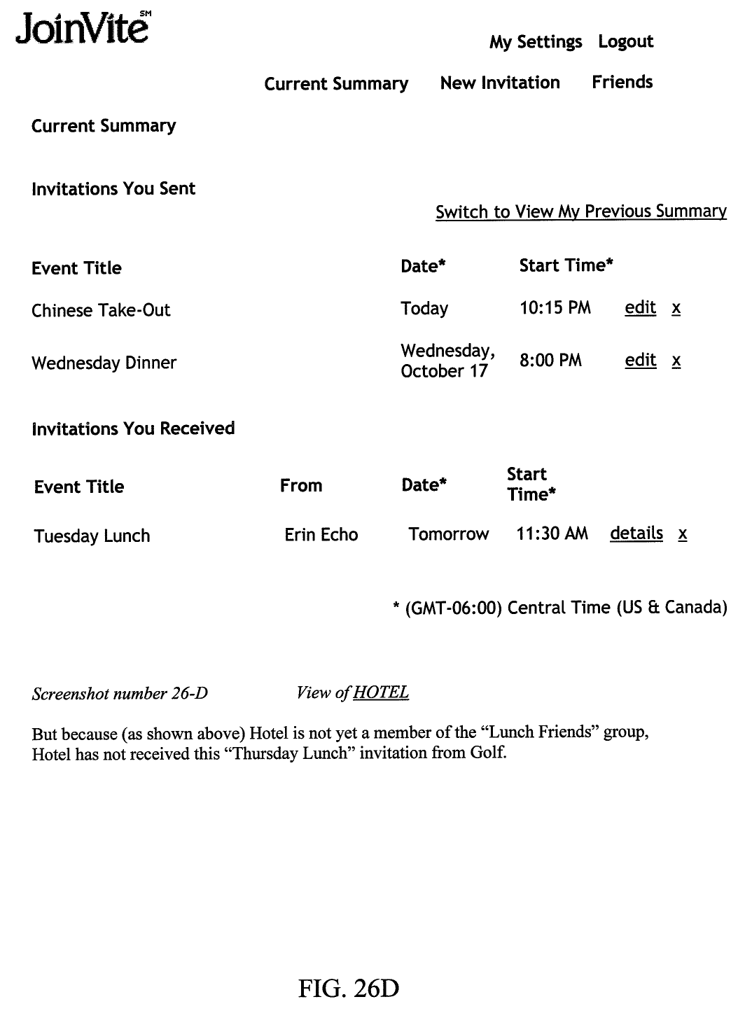

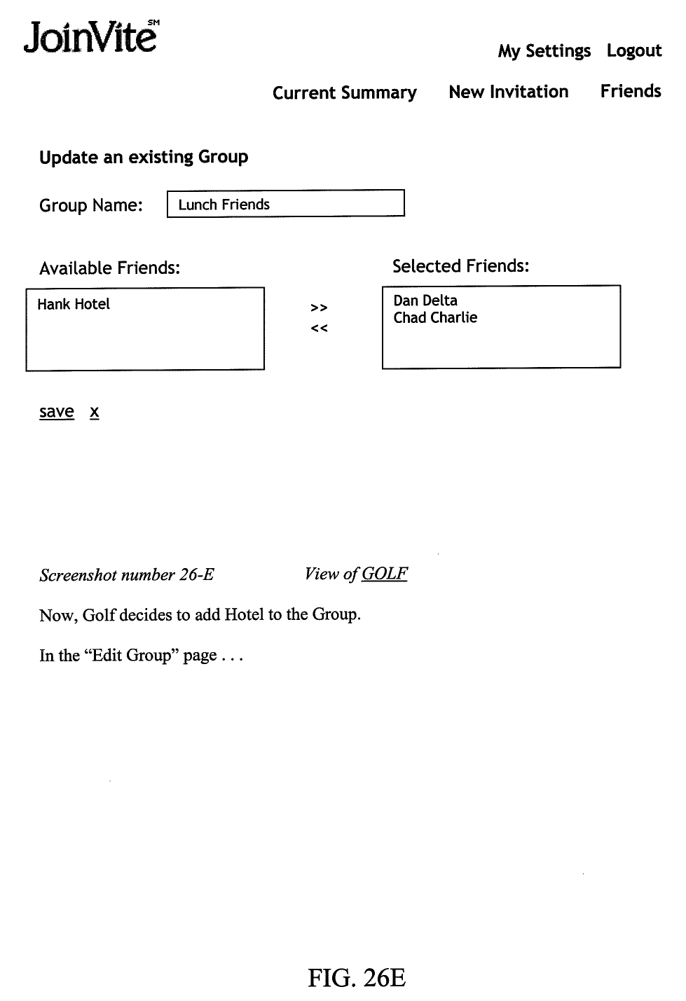

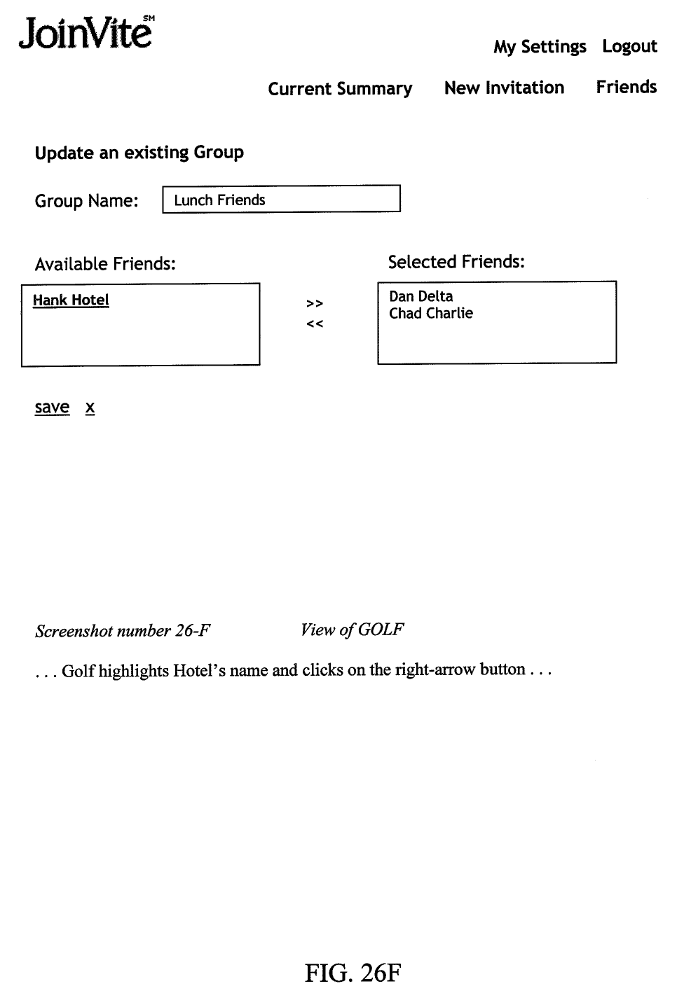

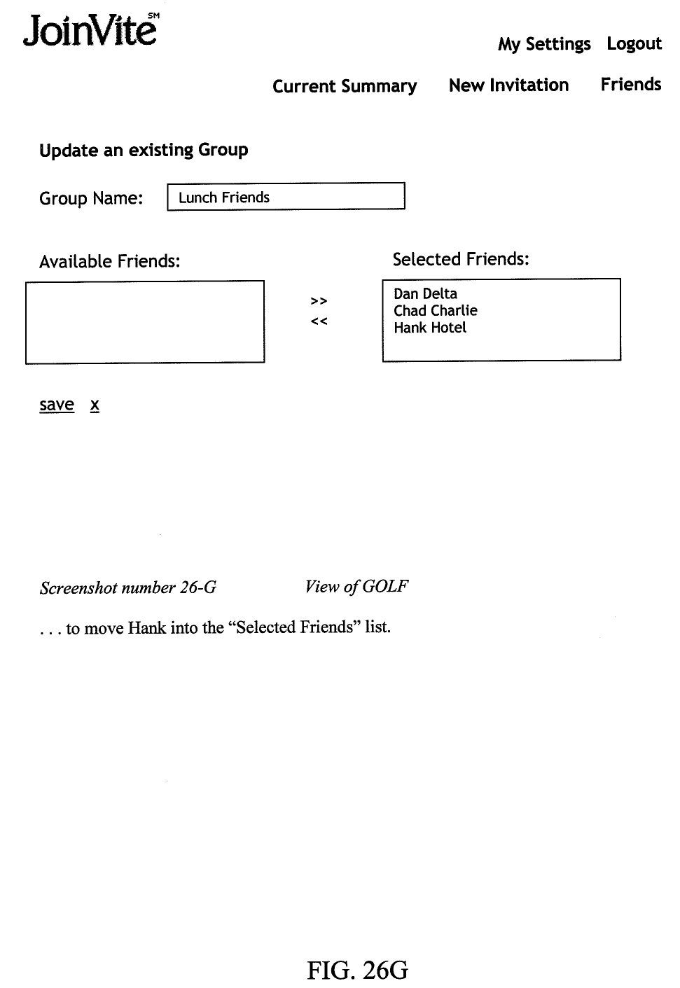

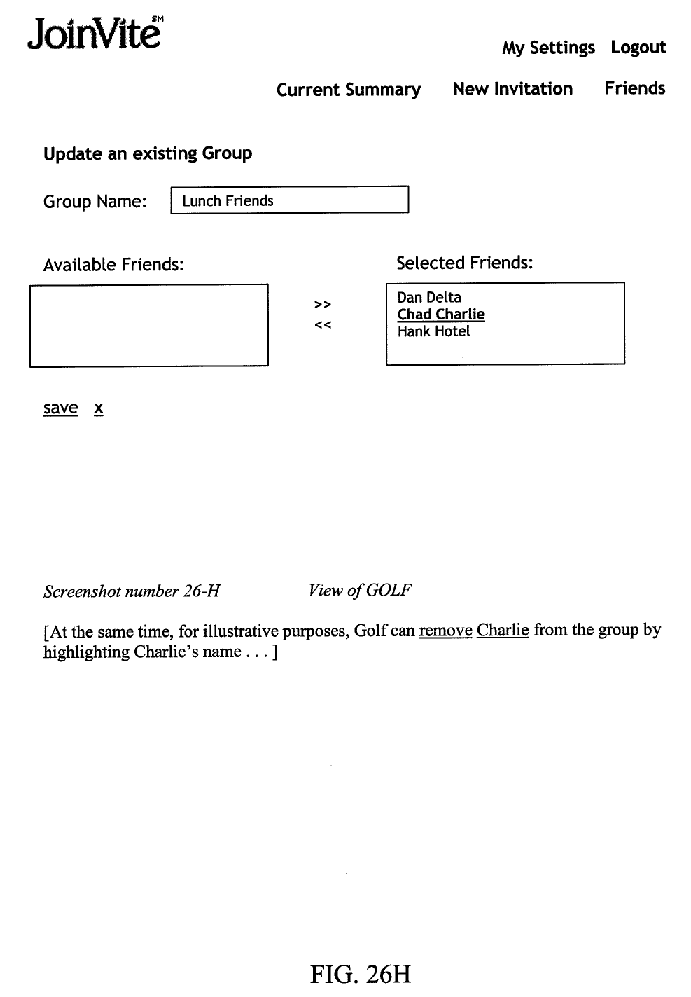

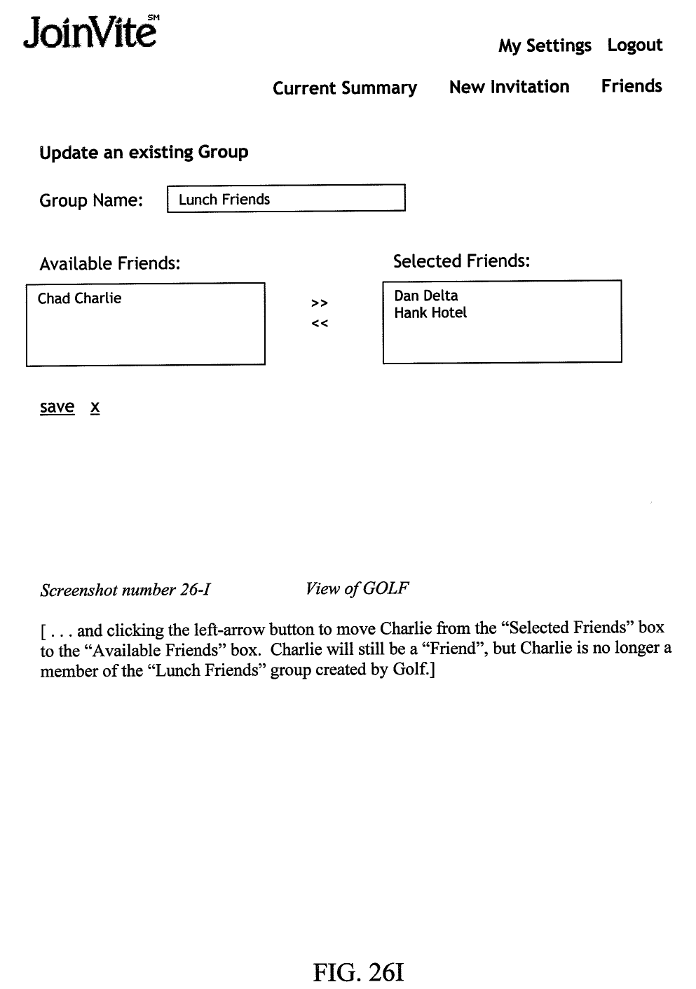

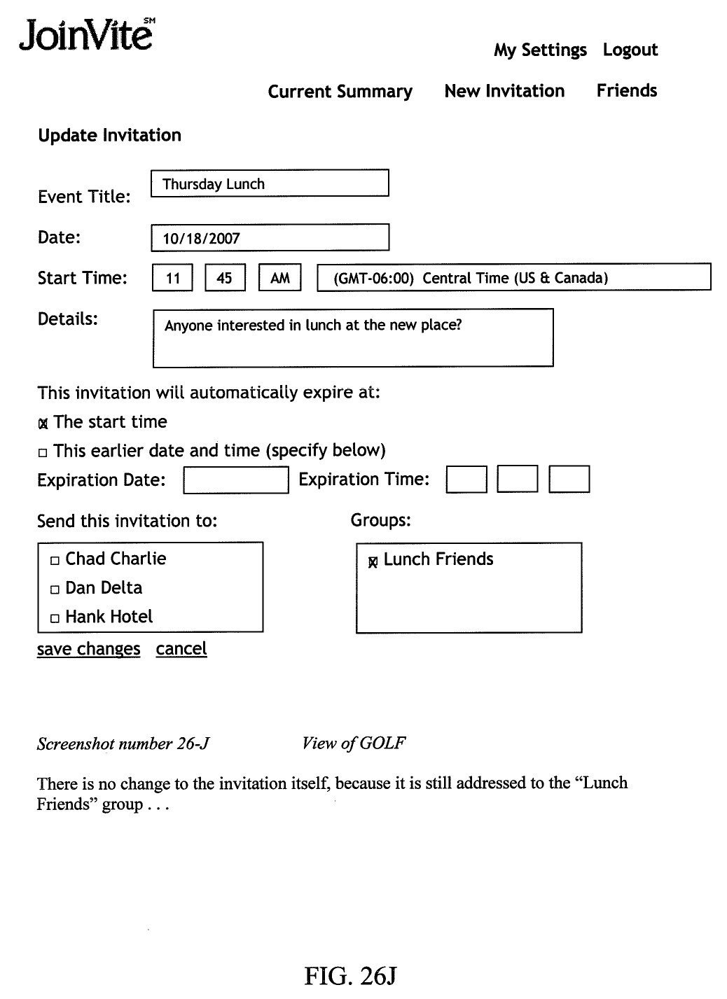

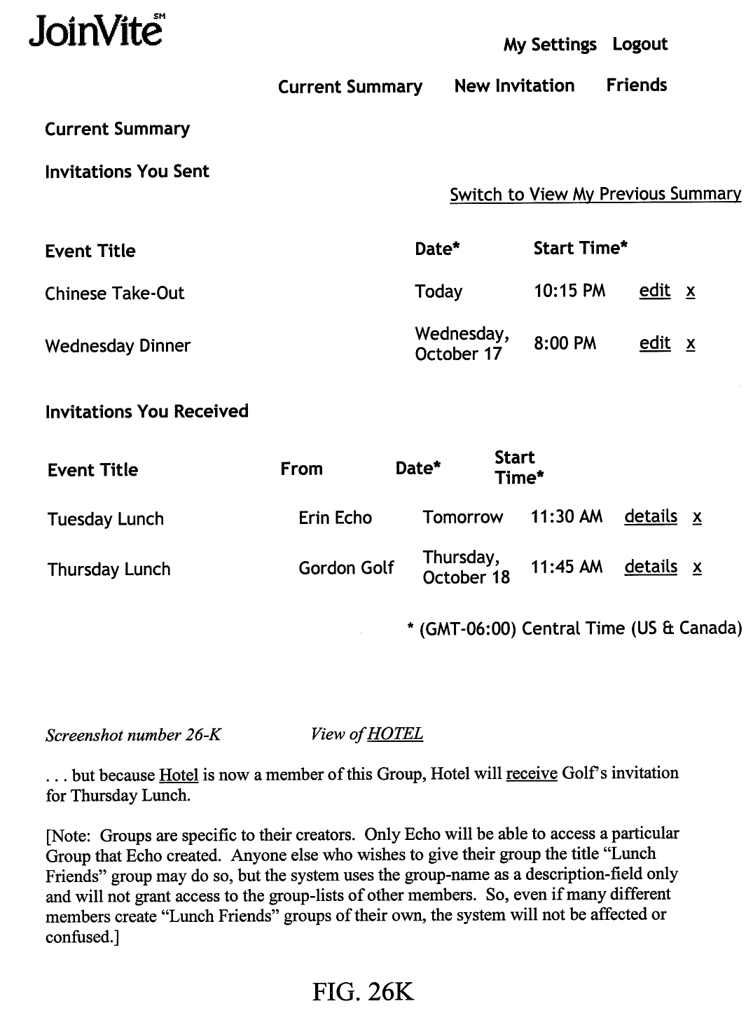

Also earlier in this scenario, recall that Golf had created a group called “Lunch Friends,” which includes Charlie and Delta. See FIG. 26A. Golf sends an invitational message to this group as shown in FIG. 26B. Golf accomplishes this by simply checking the box next to the group name. He does not need to check the boxes next to each of the individually-listed “Friends” that are in that group. This feature of the JOINVITE® system is useful for members who regularly send invitations to the same group or groups of members. Golf's message appears on his summary list as shown in FIG. 26C. Because Hotel is not yet a member of Golf's “Lunch Group” of “Friends,” Hotel has not received this invitation from Golf. See FIG. 26D. If Golf decides to add Hotel to Golf's “Lunch Group,” in the “Edit Group” page, Golf highlights Hotel's name and clicks on the right-arrows (i.e. “>>”) button to move Hotel to the “Selected Friends” list for this group. See FIGS. 26E through 26G.

In the same fashion, a member can remove a “Friend” from a group. As shown beginning at FIG. 26H, Golf can remove Charlie from Golf's selected group of “Lunch Friends” by clicking the left-arrows (i.e. “<<”) button to move Charlie from the “Selected Friends” box to the “Available Friends” box. See FIG. 26I. Although Charlie will still be one of Golf's “Friends,” he will no longer be a member of Golf's “Lunch Friends” group. Making this change will not affect any change to Golf's invitation, the details of which are shown in FIG. 26J. But because it is still addressed to Golf's “Lunch Friends” group, Hotel will now receive Golf's invitation since he is now a member of that group. See FIG. 26K.

It should be noted here that groups are specific to their creators. That is, only Echo will be able to access a particular group that Echo created, and so on. Any other member who wishes to give his or her group the title or name “Lunch Friends” may do so. The JOINVITE® system uses the group-name as a description-field only and will not grant access to the group-lists of other members. So, even if many different members create “Lunch Friends” groups of their own, the JOINVITE® system will not be affected or confused.

Referring now to FIG. 27A, it will be seen that Hotel is also able to add a new secondary e-mail address to his settings. He does this by adding the new e-mail address and clicking the “save” button. The JOINVITE® system informs Hotel that he will receive a confirmation e-mail to “confirm” that his secondary e-mail address is indeed his. See FIGS. 27B and 27C. The purpose of this security feature is to prevent a member from attempting to “gather” invitations sent to an e-mail that does not actually belong to the same member. The confirmation letter-number code that is shown at the end of the hyperlink is “visible” to its recipient, but this code can only be used for the purpose of registering this particular e-mail address. That is, neither Hotel nor anyone else can use this hyperlink to confirm a different e-mail address. As Hotel “clicks” on this hyperlink, his screen display asks him to re-enter his password. See FIG. 27D. After re-entering this password, assuming done so correctly, and clicking on the “submit” button, Hotel sees that his secondary e-mail address has been satisfactorily added. See FIG. 27E.

As shown in FIG. 27F, Charlie now adds Hotel as a “Friend,” using Hotel's new secondary e-mail address. Charlie enters Hotel's information, as he knows it, and then “clicks” on the “save” button. The JOINVITE® system then recognizes both that this e-mail address is already associated with Hotel and that Hotel was already on Charlie's list of “Friends.” See FIG. 27G. Accordingly, the JOINVITE® system indicates to Charlie that Hotel is already a “Member,” and the system uses the “Friend” name that Charlie had already selected for Hotel. That is, the JOINVITE® system uses the name originally entered by Charlie rather than the alternate name that Charlie has just tried to add.

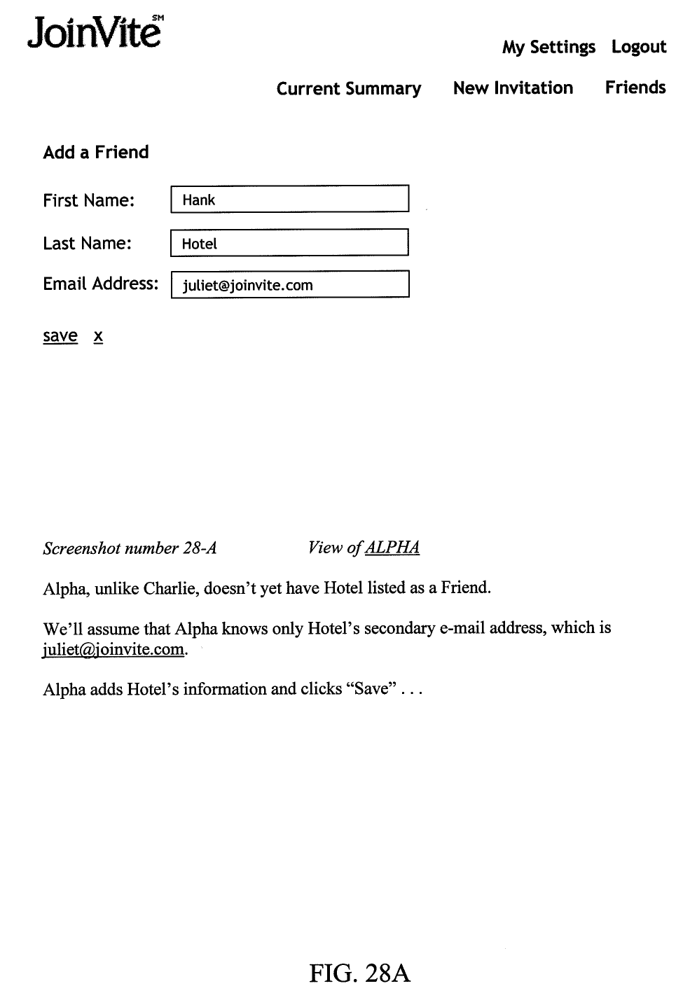

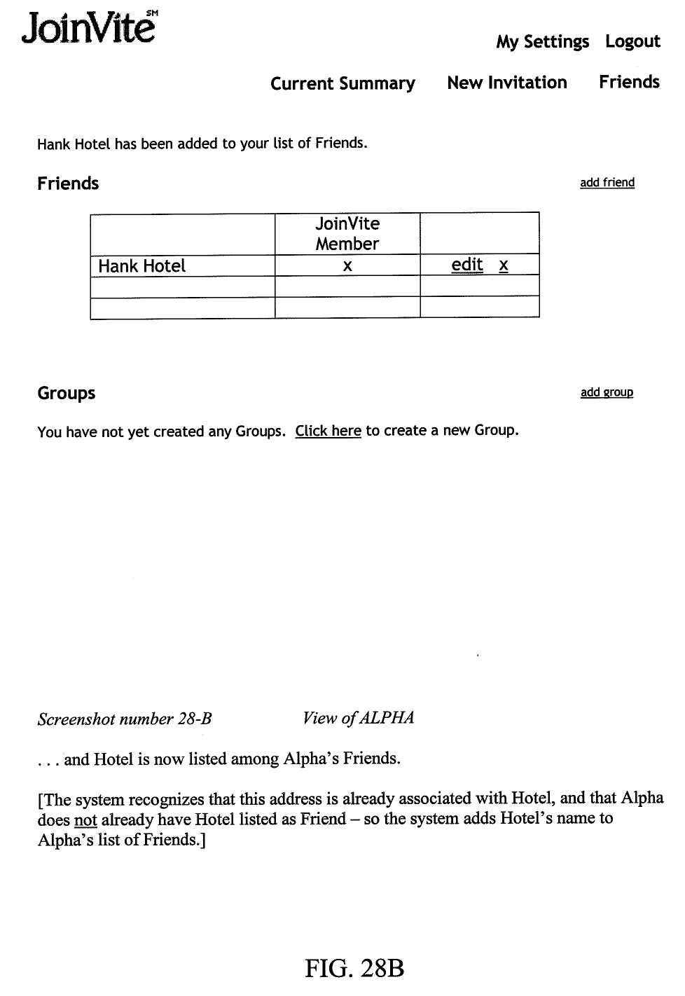

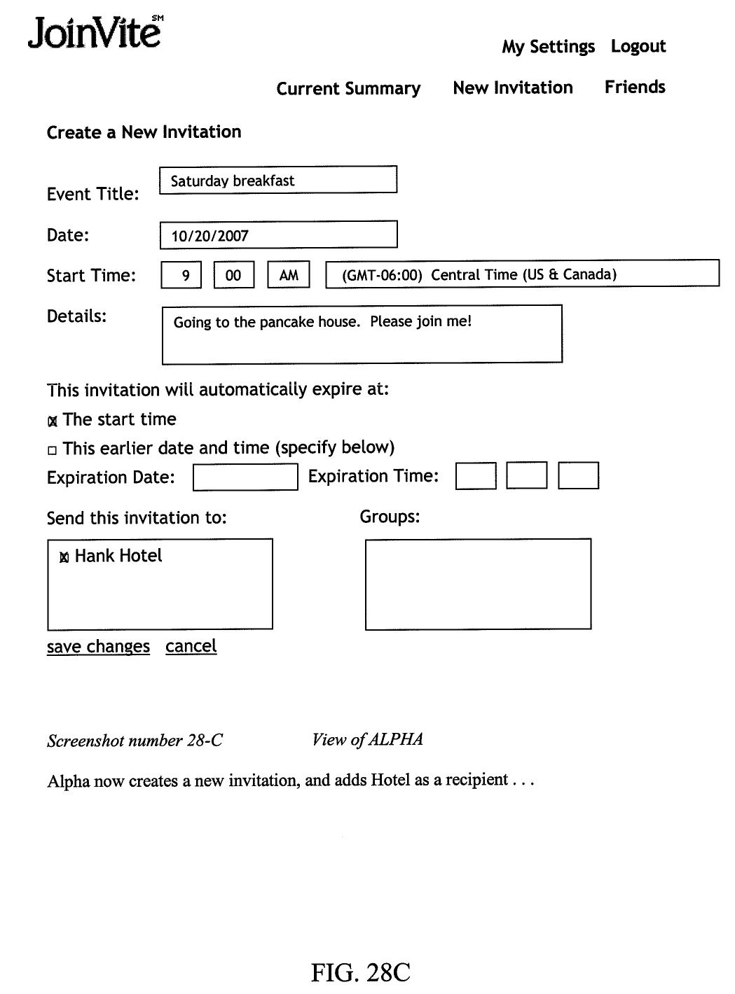

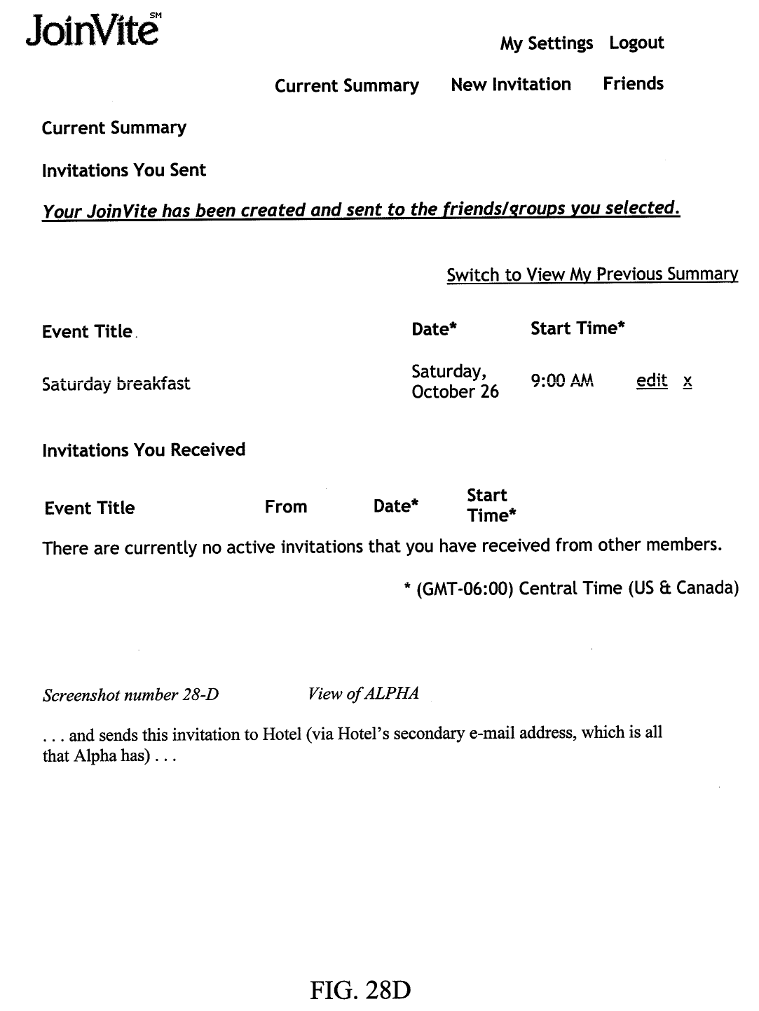

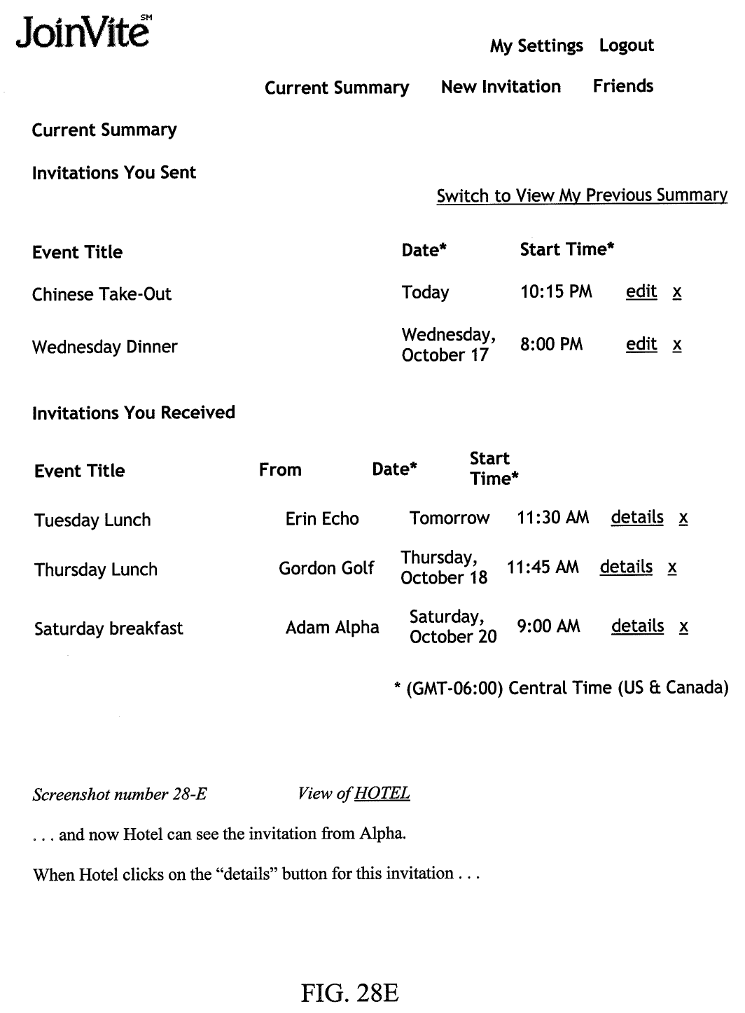

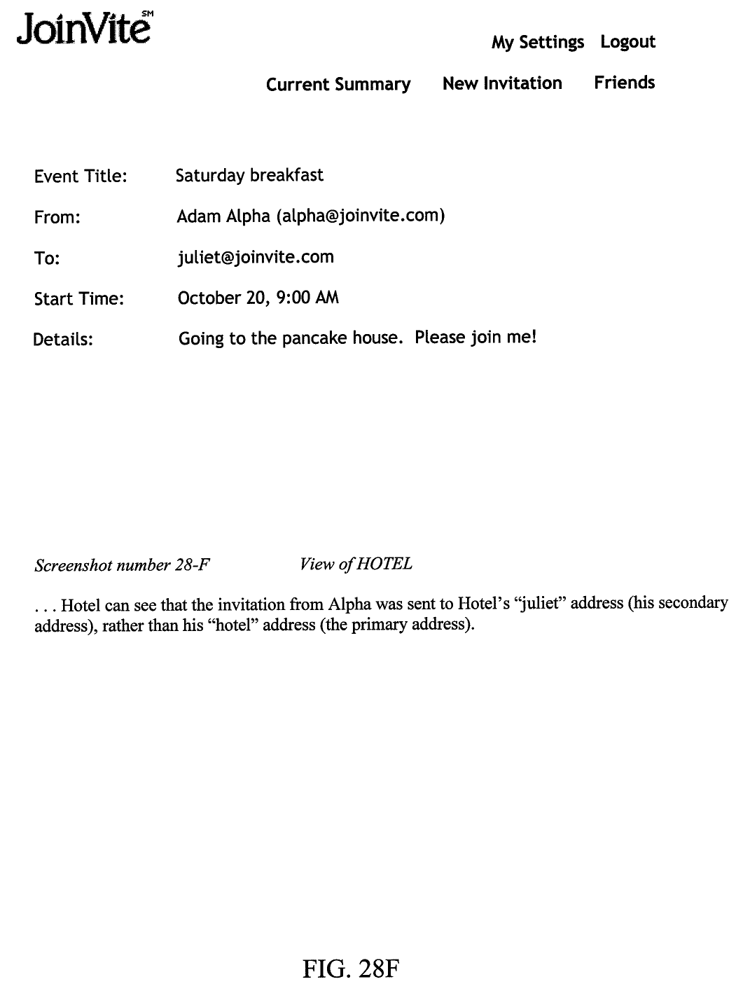

Referring now to FIG. 28A, it will be seen that Alpha, unlike Charlie, does not yet have Hotel listed as a “Friend.” Assuming that Alpha knows only about Hotel's secondary e-mail address, Alpha adds this information and clicks on the “save” button. Hotel is now listed as one of Alpha's “Friends.” See FIG. 28B. In this situation, the JOINVITE® system recognizes that this secondary e-mail address is already associated with Hotel and that Alpha does not already have Hotel listed as a “Friend.” Accordingly, the JOINVITE® system will add Hotel's name to Alpha's list of “Friends.” Alpha creates a new invitational message, and adds Hotel as a recipient. See FIG. 28C. Alpha sends this invitation to Hotel via Hotels secondary e-mail address. See FIG. 28D. Upon receipt of this invitation, Hotel can now see the invitation from Alpha as shown in FIG. 28E. When Hotel clicks on the “details” button for this invitation, Hotel can see that the invitation was sent to his secondary address rather than his primary address. See FIG. 28F.

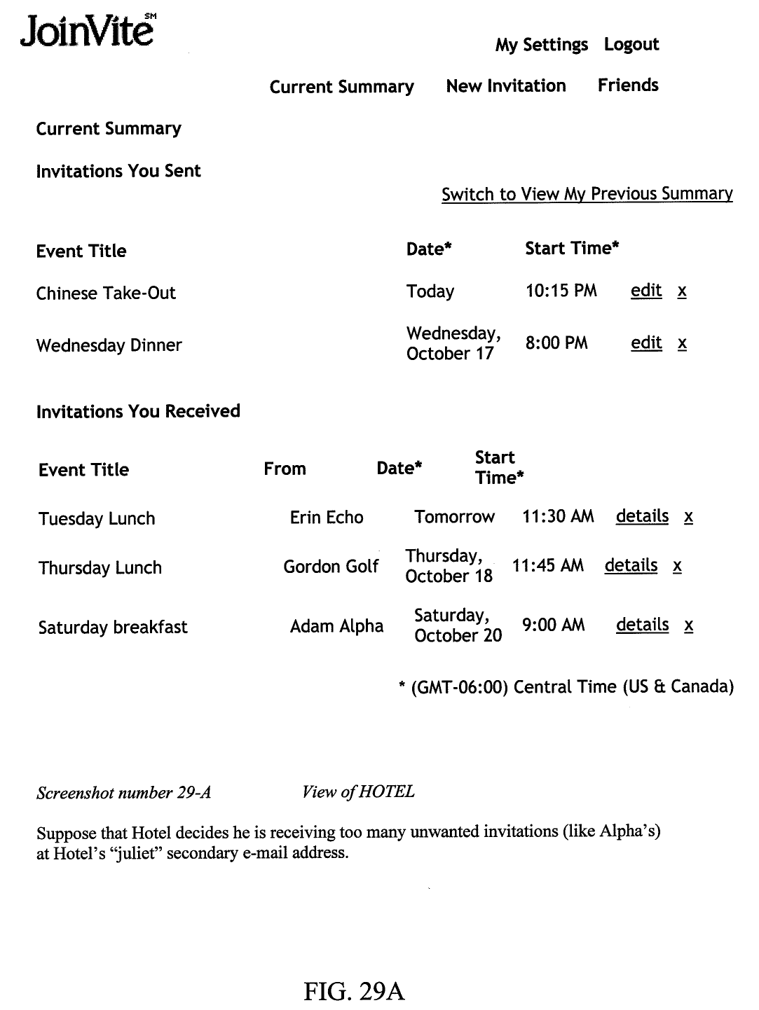

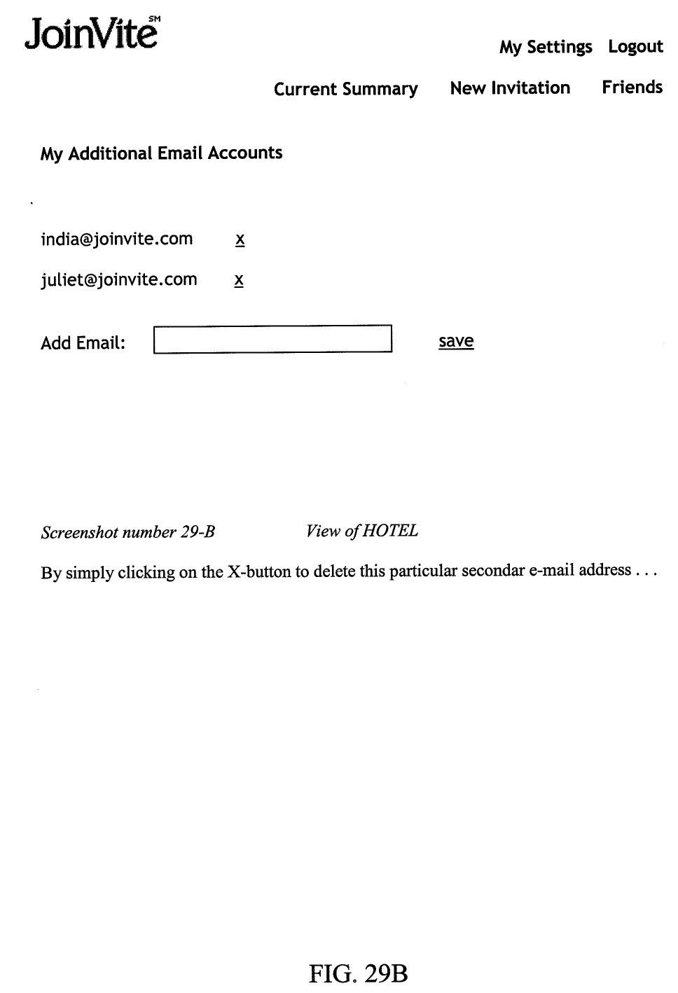

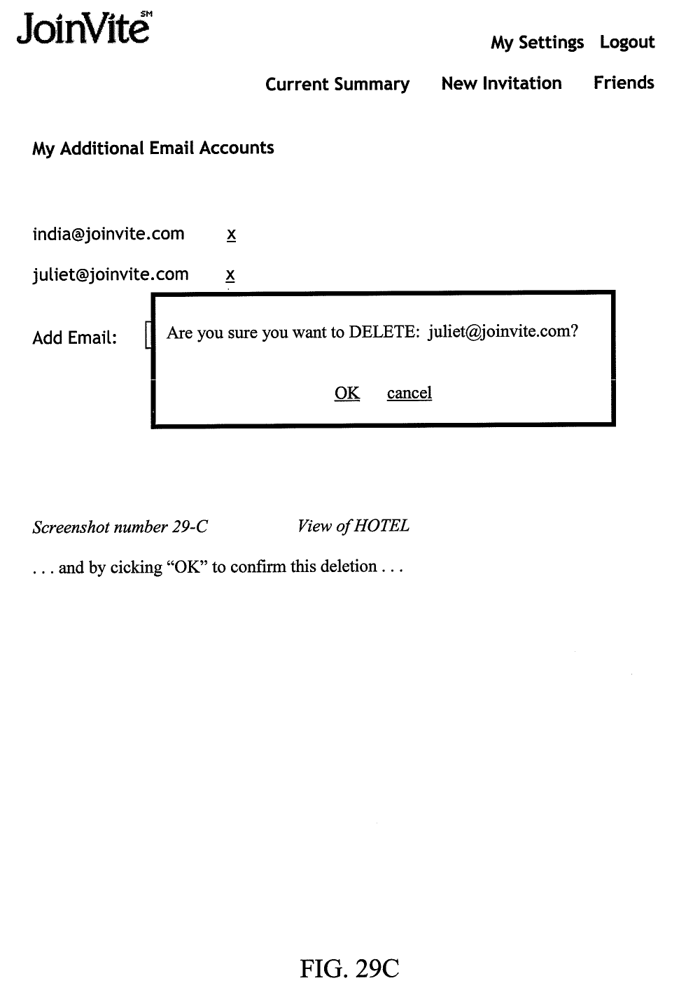

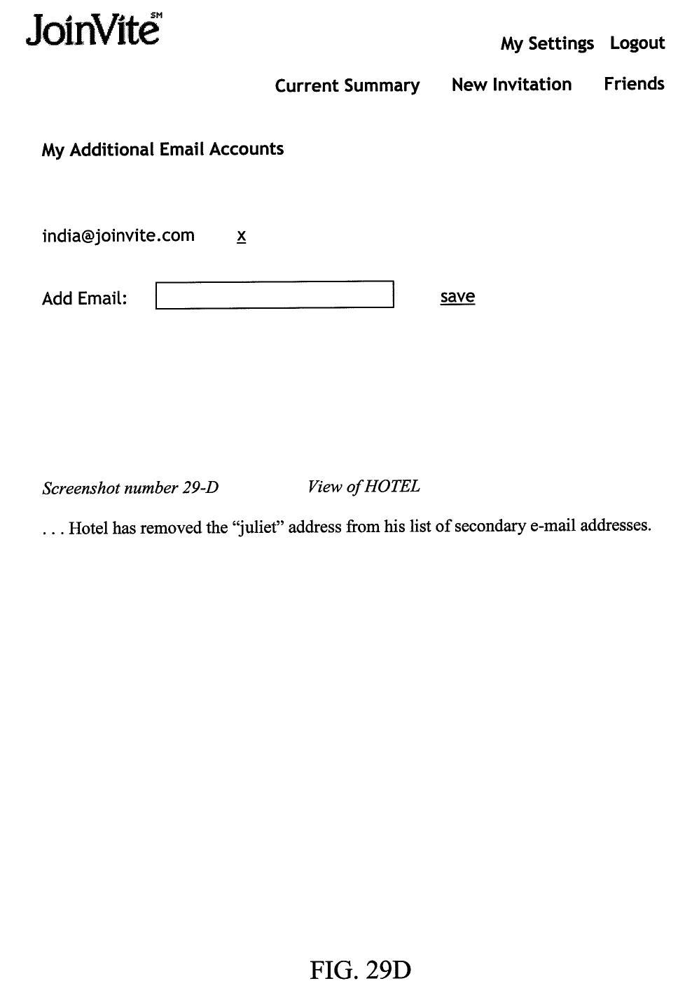

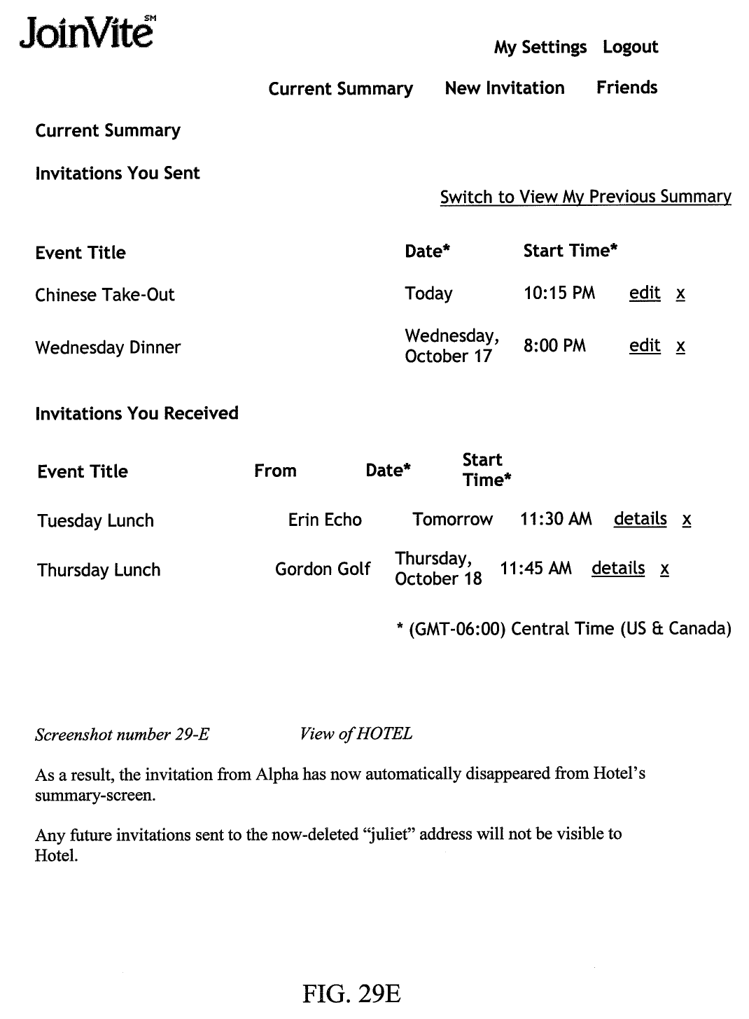

In the situation where Hotel decides that he is receiving too many “unwanted” invitations at his secondary e-mail address, such as the one he just received from Alpha, Hotel can delete this secondary e-mail address from his list of secondary e-mail addresses. See FIGS. 29A through 29D. As a result, however, the invitation from Alpha will now automatically disappear from Hotel's summary screen and any future invitations sent to the now-deleted secondary e-mail address will not be visible to Hotel. See FIG. 29E.

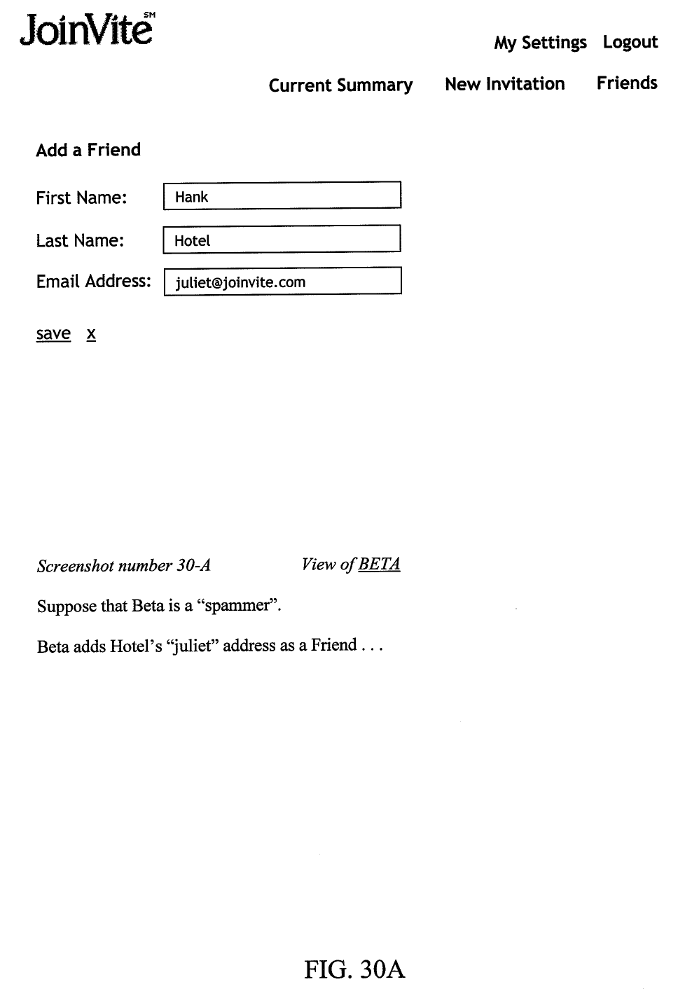

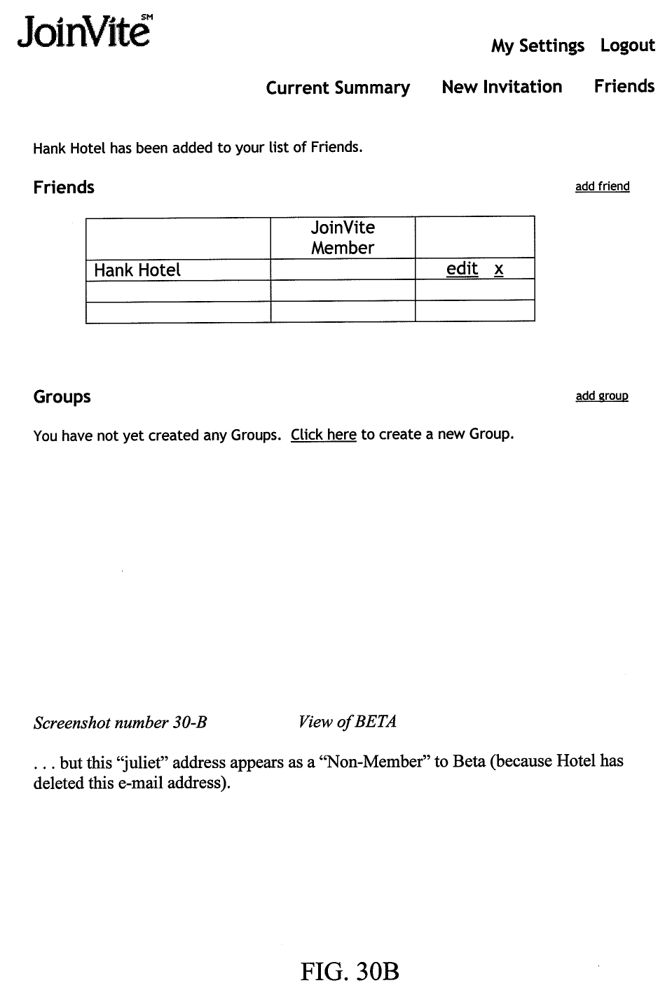

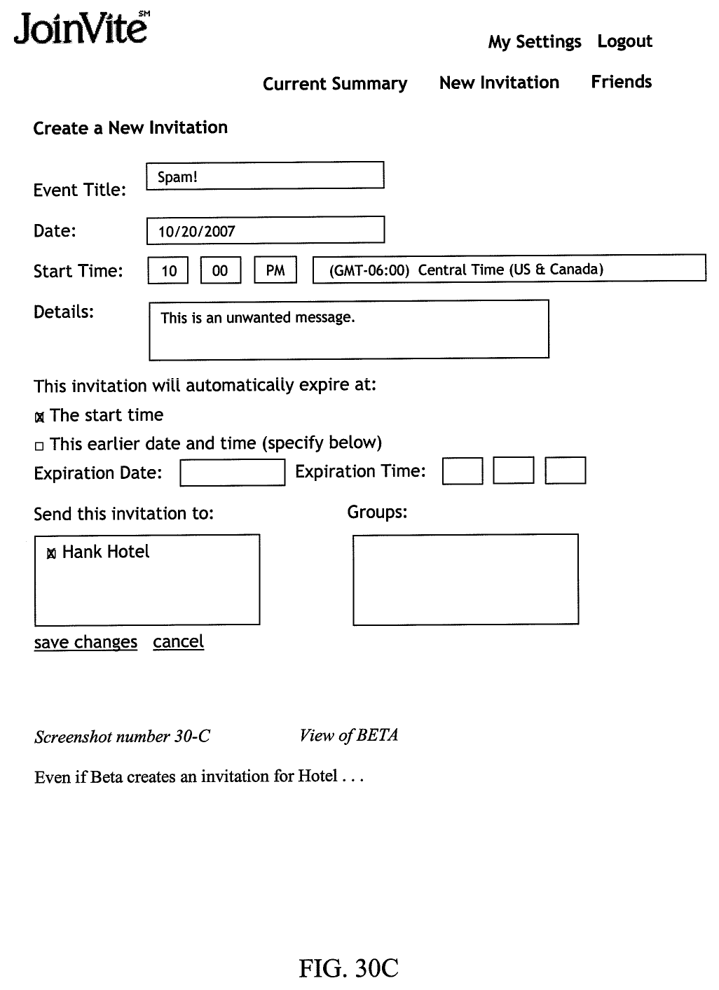

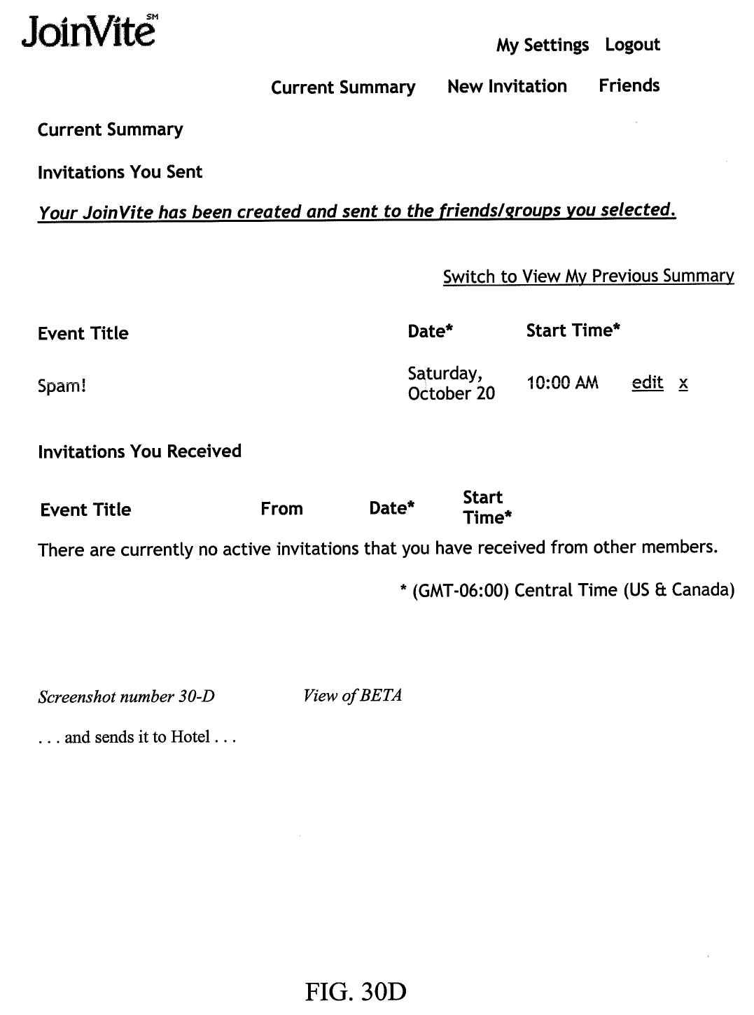

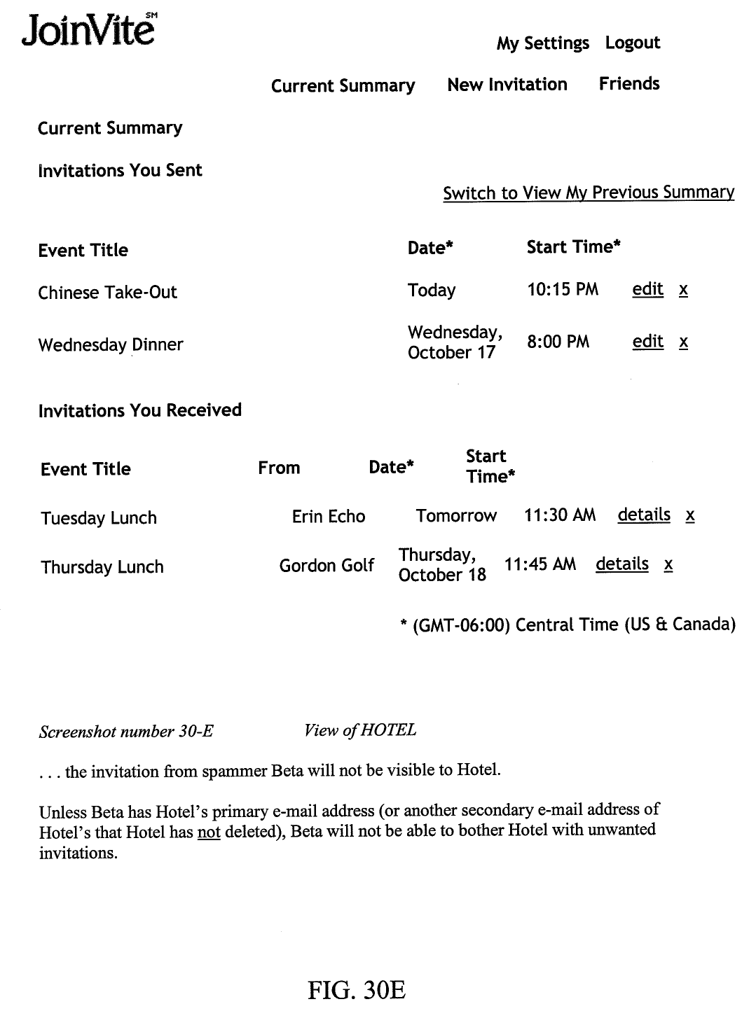

Referring now to FIG. 30A, it illustrates a screen display of Beta. Beta is a “spammer” who adds Hotel's secondary e-mail address as a “Friend.” This secondary e-mail address appears as a “Non-Member” to Beta (because of Hotel's prior deletion of this secondary e-mail address). See FIG. 30B. Even if Beta creates an invitation for Hotel and sends it to Hotel, as shown in FIGS. 30C and 30D, the invitation from “spammer” Beta will not be visible to Hotel. See FIG. 30E. In short, unless Beta has Hotel's primary e-mail address, or a secondary e-mail address that Hotel has not deleted, Beta will not be able to bother Hotel.

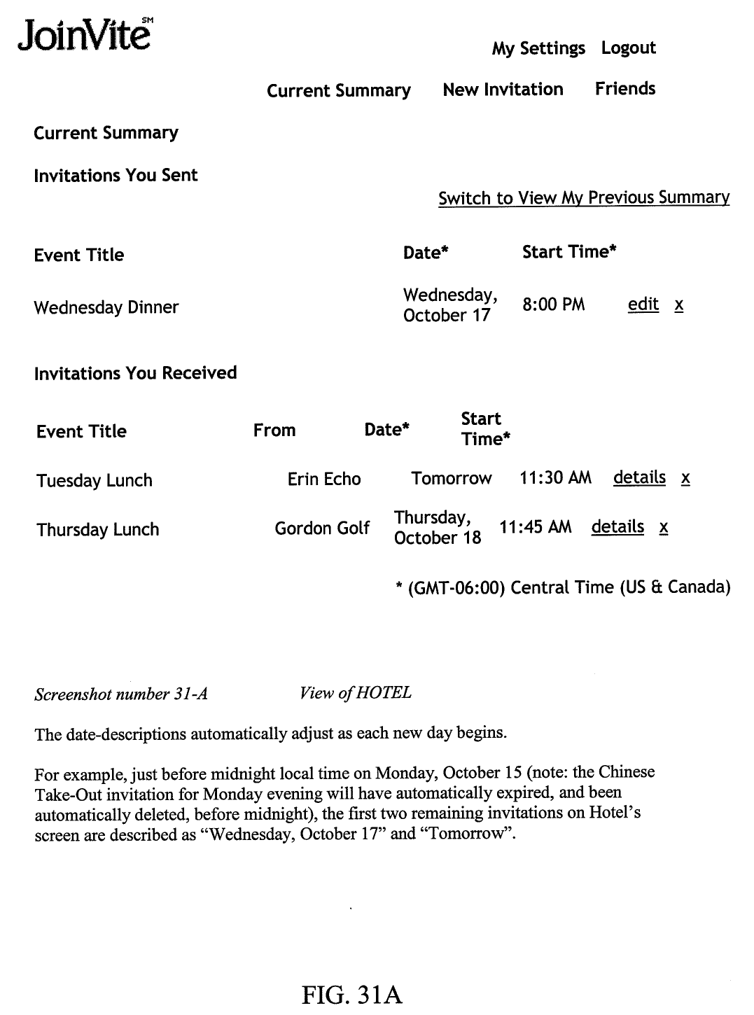

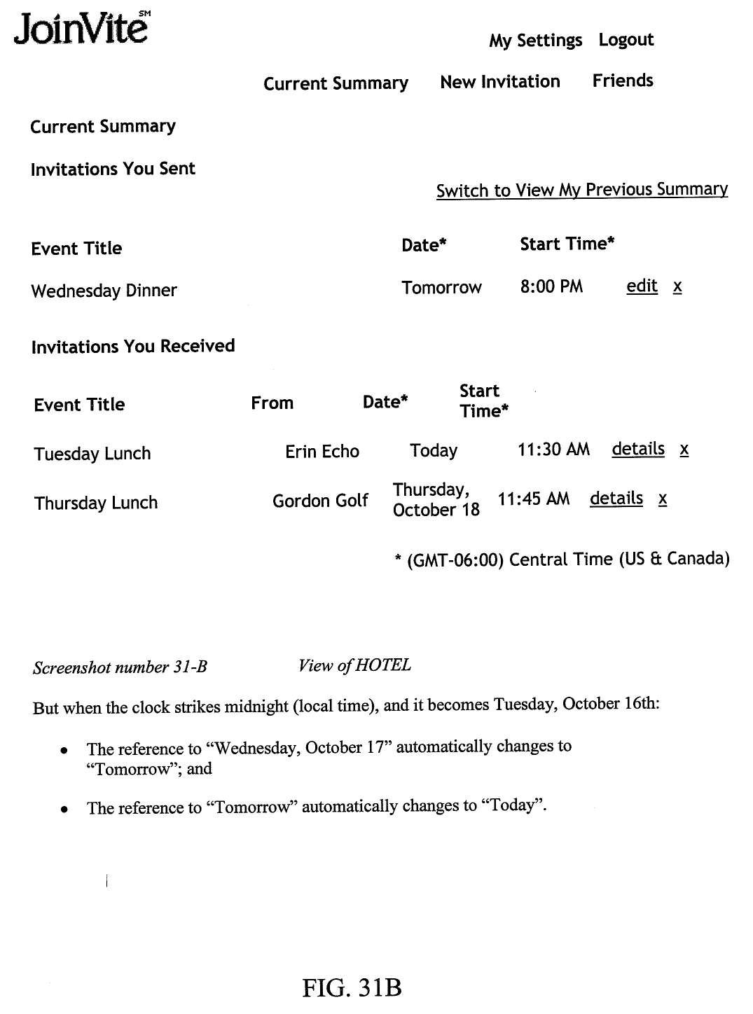

Finally, it is to be understood that the date-descriptions automatically adjust as each new day begins under the JOINVITE® system. For example, just before midnight local time on Monday, October 15, the first two invitations on Hotel's screen are described as “Wednesday, October 17” and “Tomorrow.” See FIG. 31A. When the clock strikes midnight, and it becomes Tuesday, October 16, the reference to “Wednesday, October 17” automatically changes to “Tomorrow” and the reference to “Tomorrow” automatically changes to “Today.” See FIG. 31B.

Based on the foregoing, it will be apparent that there has been provided a new, useful and non-obvious web-based method and system for processing invitational messages to individuals, which method and system comprises the following innovations (or their combination):
The ability to send a “tentative message” to a designated recipient (or set of recipients), by having the message post to a neutral website, where it can be (1) viewed by the recipient only when they visit the website, and (2) deleted by the sender either before or after the message has been viewed by the recipient.
The use of automatic “expiration times” to allow senders to determine when the messages should be deleted. (For example, if I am sending a lunch-invitation for noon, but I need to know by 11:00 am if anyone is interested, I can set an expiration-time of 11:00 am.)
The use of automatic date-and-time sorting (based on the time and date of the event itself rather than on the time-and-date of the sending of the Invitation) to make it easier for senders and recipients alike to manage their schedules.
Allowing users to create “secondary” e-mail accounts, for the purpose of “scooping up” in one location (that is, in their single JOINVITE® system account) all of the messages directed to any of their multiple e-mail accounts.
Allowing the creators of messages to make additions or deletions to the recipient-list of a “live” invitation, without resulting in any changes to the invitation that is viewed by those who were originally on the list but not deleted.
Allowing members to group combinations of Friends into Groups, to speed the invitation-sending process.

The details of the invention having been disclosed in accordance with the foregoing, I claim:

1. A web-based invitation method, comprising
requiring all users to register for use of the method,
allowing a registered user to create an invitation,
matching the invitation with one or more intended recipients, each intended recipient being a registered user of the method, and
sending the invitation to said one or more intended recipients.

2. The web-based invitation method of claim 1 further comprising allowing the registered user of the method to update the invitation.

3. The web-based invitation method of claim 1 further comprising allowing the registered user of the method to pre-set the invitation for expiration.

4. The web-based invitation method of claim 1 further comprising allowing the registered user of the method to recall the invitation.

5. The web-based invitation method of claim 1 further comprising allowing the one or more intended recipients to receive the said invitation.

6. The web-based invitation method of claim 5 further comprising displaying the said invitation to the one or more intended recipients and sorting the one or more intended recipients' display of received invitations, including the said invitation.

7. A method to be performed by at least two computers for providing at least two users with online, web-based invitations over the internet comprising the steps of
requiring the at least two users to register for use of the method,
prompting a registered first user to create an invitation,
creating the invitation,
matching the invitation with one or more intended recipients, each intended recipient also being a registered user of the method,
prompting the registered first user to send the invitation, and
sending the invitation to said one or more intended recipients, wherein said one or more intended recipients comprises at least one registered second user.

8. The web-based invitation method of claim 7 further comprising the step of prompting the registered first user of the method to update the invitation.

9. The web-based invitation method of claim 7 further comprising the step of prompting the registered first user of the method to pre-set the invitation for expiration.

10. The web-based invitation method of claim 7 further comprising the step of allowing the registered first user of the method to recall the invitation.

11. The web-based invitation method of claim 7 further comprising the step of allowing the at least one registered second user of the method to receive the said invitation.

12. The web-based invitation method of claim 11 further comprising the steps of displaying the said invitation to the at least one registered second user of the method and sorting the at least one registered second user's display of received invitations, including the said invitation.

13. A computer-based system for creating web-based invitations comprising
means for requiring all users to register for use of the system,
means for allowing a registered user to create a web-based invitation,
means for matching the web-based invitation with one or more intended recipients, each intended recipient being a registered user of the system, and
means for sending the web-based invitation to said one or more intended recipients.

14. The computer-based system of claim 13 further comprising means for allowing the registered user to update the web-based invitation.

15. The computer-based system of claim 13 further comprising means for allowing the registered user to pre-set the web-based invitation for expiration.

16. The computer-based system of claim 13 further comprising means for allowing the registered user to recall the web-based invitation.

17. The computer-based system of claim 13 further comprising means for allowing the one or more intended recipients to receive the said web-based invitation.

18. The computer-based system of claim 17 further comprising means for displaying the said web-based invitation to the one or more intended recipients and means for sorting the one or more intended recipients' display of received web-based invitations, including the said web-based invitation.

19. A computerized online, web-based system accessible over the internet comprising
a first user computer coupled to the internet,
a user interface for prompting the first user for an input,
means for requiring the first user to register for use of the system,
means for prompting the first user to create an invitation,
means for allowing the first user to create an invitation,
matching the invitation with one or more intended recipients, each intended recipient also being a registered user of the system, and
means for allowing the first user to send the invitation, to said one or more intended recipients, wherein said one or more intended recipients comprises at least one registered second user.

20. The web-based invitation system of claim 19 further comprising means for allowing the registered first user of the system to update the invitation.

21. The web-based invitation system of claim 19 further comprising means for allowing the registered first user of the system to pre-set the invitation for expiration.

22. The web-based invitation system of claim 19 further comprising means for allowing the registered first user of the system to recall the invitation.

23. The web-based invitation system of claim 19 further comprising
a second user computer system coupled to the internet, and
means for allowing the at least one registered second user to receive the invitation.

24. The web-based invitation system of claim 23 further comprising
means for displaying the said invitation to the at least one registered second user, and
means for sorting the at least one registered second user's display of received invitations, including the said invitation.
